(19) United States
(12) Patent Application Publication
(10) Pub. No.: US 2024/0156669 A1
(43) Pub. Date: May 16, 2024

(54) THERAPEUTIC PRESSURE, THERMAL, AND/OR OTHER TREATMENT MODALITY SYSTEMS AND METHODS

(71) Applicant: Aquilo Sports LLC, Louisville, KY (US)

(72) Inventors: John-Paul SPENCE, Louisville, KY (US); Christian BUCKLEY, Louisville, KY (US); Paul A. SPENCE, Aventura, FL (US)

(73) Assignee: Aquilo Sports LLC, Louisville, KY (US)

(21) Appl. No.: 18/394,432

(22) Filed: Dec. 22, 2023

Related U.S. Application Data
(63) Continuation-in-part of application No. PCT/US2022/034911, filed on Jun. 24, 2022.
(60) Provisional application No. 63/519,758, filed on Aug. 15, 2023.
(60) Provisional application No. 63/215,129, filed on Jun. 25, 2021.

(51) Int. Cl. A61H 9/00

(52) U.S. Cl. CPC A61H 9/0092; A61H 2201/0103; A61H 2201/0107; A61H 2201/0207; A61H 2201/0242; A61H 2201/50; A61H 2205/04; A61H 2205/062; A61H 2205/084; A61H 2205/106; A61H 2205/12

(57) ABSTRACT

Systems and methods described herein include a pressure delivery component that has a pressure applicator configured to selectively apply therapeutic pressure to a treatment portion of a user body, and also includes a thermal delivery component that has a thermal applicator that is a configured to apply thermal treatment to the treatment portion. The thermal applicator may be removably disposable in operative relationship with the pressure delivery component in a use configuration of the treatment delivery component Treatment delivery component is reconfigurable between a first configuration in which the treatment portion is a first treatment portion that includes a lower leg and foot of the user's body, and a second configuration in which the treatment portion is a second treatment portion that includes an upper arm and deltoid of the user's body.

### CROSS-REFERENCE TO RELATED APPLICATIONS

The present application is a continuation-in-part of PCT Application No. PCT/US2022/034911, filed Jun. 24, 2022, which claims priority to and benefit of U.S. Provisional Application No. 63/215,129, filed Jun. 25, 2021, the entire disclosures of which are incorporated herein by reference. The present application also claims priority to and benefit of U.S. Provisional Application No. 63/519,758, filed Aug. 15, 2023, the entire disclosure of which is incorporated herein by reference.

### BACKGROUND

Embodiments described herein relate to systems in which pressure treatment, thermal treatment (cooling and/or heating), and/or other treatment (non-pressure, and non-thermal) may be applied to a treatment portion of a user's body, concurrently and/or sequentially, for therapeutic purposes including recovery from athletic activity (including muscle soreness after exercise), muscle ischemia, muscle trauma, phantom limb pain, muscle cramps, night leg cramps and spasms, and/or promotion of tissue healing.

Cooling and pressure therapy are particularly desirable treatment regiments utilized by athletes and users to reduce inflammation and swelling that athletes may experience in different parts of their bodies after athletic activity, or muscular pain or muscular discomfort users may be experiencing. Athletes or other users may also seek non-pressure and non-thermal treatments such as electrostimulation, targeted drug delivery, vibrational massage, etc. Systems and devices that can be mounted on different parts of a user's body to provide such therapies are desirable. However, there can be significant difference in size between different parts of a user's body, for example, a torso of user can have a significantly larger cross-section than a leg of user, which in turn may have a larger cross-section than an arm of a user. This makes it difficult for single therapy delivery system or device to be used on different portions of a user's body. Similarly, athletes and users can vary significantly in their size and weight. For example, linebackers in football teams are generally heavier than wide receivers or kickers. Moreover, female athletes tend to be much smaller than their male counterparts even in the same sports. Conventional systems and devices for delivering therapy are generally sized for use by a user having a particular size or weight, or on a particular portion of the body of the user. Thus, different user's such as various athletes within a team would have to purchase and maintain multiple such conventional systems or devices to be able to provide therapeutic treatment to each of its members. Moreover, conventional systems generally integrate pressure and thermal treatment components in treatment devices, decreasing flexibility in usage of such systems.

Accordingly, a need exists for systems and devices for delivering treatments and therapies that have adjustable sizes for fitting users of different sizes, and that are capable of delivering various treatments such as pressure treatment, thermal treatment, and/or other treatments in any suitable combination and configuration.

### SUMMARY

Disclosed systems include an apparatus including a treatment delivery component configured to be releasably secured around a treatment portion of a user's body. The treatment delivery component includes a pressure delivery component including a pressure applicator having a plurality of pressure elements, each pressure element being in fluid communication with a respective fluid passage in a pressure conduit releasably coupleable to a source of pressurized fluid. Each pressure element is changeable, in response to receiving the pressurized fluid, from a collapsed configuration to an expanded configuration having a greater volume than the collapsed configuration. The treatment delivery component also includes a thermal delivery component having a thermal applicator removably disposed proximate to the pressure applicator. The thermal applicator is in fluid communication with a thermal conduit releasably coupleable to a thermal source and configured to conduct therethrough a liquid from the thermal source and to exchange thermal energy between the treatment portion and the liquid. The treatment delivery component includes a first portion and a second portion extending from the first portion. The treatment delivery component is reconfigurable between: (a) a first configuration in which the treatment portion is a first treatment portion that includes a lower leg of the user's body, the first portion can be disposed on a calf and shin of the user's body, and the second portion can be disposed on a foot of the user's body; and (b) a second configuration in which the treatment portion is a second treatment portion that includes an upper arm and deltoid of the user's body, the first portion can be disposed on an upper arm of the user's body, and the second portion can be disposed on a deltoid of the user's body.

Embodiments described herein also relate to an apparatus including a treatment delivery component configured to be releasably secured around a treatment portion of a user's body. The treatment delivery component includes: a first portion forming a first tubular segment, a first fastener portion being coupled to a first side of the first portion and configured to close the first side of the first portion edge to edge; and a second portion forming a second tubular segment extending at a non-zero angle from the first tubular segment, the second portion including a second fastener portion disposed on a first side of the second portion and configured to couple the first side of the second tubular segment edge to edge, and a third fastener portion disposed on a second side of the second portion opposite the first side of the second portion, the third fastener portion configured to at least partially close the second side of the second portion edge to edge; and the treatment delivery component being reconfigurable between: (a) a first configuration in which the treatment portion is a first treatment portion that includes a lower leg of the user's body, the first portion can be disposed on a calf and shin of the user's body, and the second portion can be disposed on a foot of the user's body; and (b) a second configuration in which the treatment portion is a second treatment portion that includes an upper arm and deltoid of the user's body, the first portion can be disposed on an upper arm of the user's body, and the second portion can be disposed on a deltoid of the user's body.

Embodiments described herein also relate to a method that includes configuring a treatment delivery component for delivery of a first pressure treatment modality by a pressure delivery component having a pressure applicator and a first thermal treatment modality by a thermal delivery component having a thermal applicator to a first treatment portion of a user's body that includes a lower leg of the user's body, the treatment delivery component including an outer shell coupled to the pressure applicator; disposing the treatment delivery component in operative relationship with the first treatment portion with the thermal applicator adjacent to a surface of the first treatment portion; coupling the treatment delivery component to a control unit, the control unit having a pressure source and a thermal source, the coupling including coupling to the pressure source a pressure conduit coupled to the pressure applicator and coupling to the thermal source a thermal conduit coupled to the thermal applicator; delivering the first pressure treatment modality to the first treatment portion by the pressure delivery component; delivering the first thermal treatment modality to the first treatment portion by the thermal delivery component; removing the treatment delivery component from the first treatment portion; configuring the treatment delivery component for delivery of a second pressure treatment modality by the pressure delivery component and a second thermal treatment modality by the thermal delivery component to a second treatment portion of the user's body that includes an upper arm and deltoid of the user's body, the configuring including releasably coupling the thermal applicator to one or more of the outer shell and the pressure applicator; disposing the treatment delivery component in operative relationship with the second treatment portion with the thermal applicator adjacent to a surface of the second treatment portion; coupling the treatment delivery component to the control unit; delivering the second pressure treatment modality to the second treatment portion by the pressure delivery component; delivering the second thermal treatment modality to the second treatment portion by the thermal delivery component; and removing the treatment delivery component from the second treatment portion.

### BRIEF DESCRIPTION OF THE DRAWINGS

FIG. 1 is a schematic illustration of a treatment system, according to an embodiment.

FIGS. 2A and 2B are schematic illustrations of the outer shell of the treatment system of FIG. 1.

FIGS. 3A to 3O are schematic illustrations of the pressure delivery component of the treatment system of FIG. 1.

FIGS. 4A to 4C are schematic illustrations of the thermal delivery component of the treatment system of FIG. 1.

FIGS. 5A to 5C are schematic illustrations of the other thermal delivery component of the treatment system of FIG. 1.

FIG. 6 is a schematic illustration of the controller of the treatment system of FIG. 1.

FIG. 7 is a schematic illustration of the user interface of the treatment system of FIG. 1.

FIG. 8 is a flow chart of a method of treatment of a user with the treatment system of FIG. 1, accordingly to an embodiment.

FIGS. 9A to 9G are schematic illustrations of a treatment delivery component, according to an embodiment.

FIGS. 10A to 10F are schematic illustrations of a treatment delivery component, according to another embodiment.

FIGS. 11A to 11T are illustrations of a treatment system, according to an embodiment.

FIGS. 12A and 12B are illustrations of a treatment delivery component, according to an embodiment.

FIGS. 13A and 13B are cross-sectional views of treatment delivery components, according to embodiments.

FIG. 14A is a plan view of a thermal applicator, and FIG. 14B is a cross-sectional view of a treatment delivery component including the thermal applicator of FIG. 14A, according to an embodiment.

FIG. 15 is a cross-sectional view of a treatment delivery component, according to an embodiment.

FIG. 16 is a cross-sectional view of a treatment delivery component, according to an embodiment.

FIGS. 17A and 17B are illustrations of a treatment delivery component support, according to an embodiment.

FIG. 18 is a cross-sectional view of a treatment delivery component, according to an embodiment.

FIGS. 19A to 19G are illustrations of a treatment delivery component configured for use with an ankle of a user, according to an embodiment.

FIGS. 20A to 20D are illustrations of a treatment delivery component configured for use with a shoulder of a user, according to an embodiment.

FIGS. 21A to 21C are illustrations of a treatment delivery component configured for use with an arm of a user, according to an embodiment.

FIGS. 22A to 22D are illustrations of a treatment delivery component configured for use with a knee of a user, according to an embodiment.

FIGS. 23A to 23D are illustrations of a treatment delivery component configured for use with an arm of a user, according to an embodiment.

FIGS. 24A to 24D are illustrations of a treatment delivery component configured for use with a torso of a user, according to an embodiment.

FIG. 25A is an illustration of a thermal delivery component that includes first thermal applicator configured for use with an upper leg of a user, and a second thermal applicator configured for use with a lower leg and foot of the user, each of which may be included in one or more treatment delivery components, according to an embodiment.

FIG. 25B is an illustration of a pressure delivery component including a first pressure applicator with the first thermal applicator of FIG. 25A disposed thereon, and a second pressure applicator with the second thermal applicator of FIG. 25A disposed thereon, according to an embodiment.

FIG. 26A is an illustration of a treatment delivery component configured for use with a first treatment portion of a user, and a FIG. 26B is an illustration of the delivery component of FIG. 26A configured for use with a second treatment portion of a user, according to an embodiment.

FIGS. 27A to 27G are illustrations of a treatment delivery component that is reconfigurable for use with either a lower leg and foot, or an upper arm and shoulder of a user, according to an embodiment.

FIG. 27H is an illustration of a treatment delivery component configured for user with an upper leg of a user, according to an embodiment.

FIGS. 28A to 28G are illustrations of various operations of a process for reconfiguring the treatment delivery component of FIGS. 27A to 27G for use with either a lower leg and foot of a user, or an upper arm and shoulder of the user.

FIGS. 29A to 29C are flow charts of a method of treatment of a lower leg and foot, or an upper arm and shoulder of a user with the treatment delivery component of FIGS. 27A to 27G, accordingly to an embodiment.

### DETAILED DESCRIPTION

Embodiments and implementations described herein relate to systems in which pressure treatment, thermal treatment (cooling and/or heating), and/or other treatment (non-pressure, and non-thermal) may be applied to a treatment portion of a user's body, concurrently and/or sequentially, for therapeutic purposes including recovery from athletic activity (including muscle soreness after exercise), muscle ischemia, muscle trauma, phantom limb pain, muscle cramps, night leg cramps and spasms, and/or promotion of tissue healing.

In some embodiments, a treatment system includes a treatment delivery component that includes a pressure delivery component that has a pressure applicator configured to selectively apply therapeutic pressure to a treatment portion of a user body with pressurized fluid received through a pressure conduit coupled to the pressure applicator. The apparatus may also include a thermal delivery component that has a thermal applicator that is a configured to apply thermal treatment to the treatment portion with thermal energy received from or withdrawn by a thermal conduit coupled to the thermal applicator. The thermal applicator may be removably disposable in operative relationship with the pressure delivery component in a use configuration of the treatment delivery component such that the thermal applicator is disposable between the treatment portion and the pressure applicator when the treatment delivery component is disposed on the treatment portion in the use configuration. Moreover, the pressure applicator is operable to apply pressure to the thermal applicator to enhance apposition of the thermal applicator to the treatment portion.

In some embodiments, an apparatus may include a treatment delivery component configured to be releasably secured around a treatment portion of a user's body. The treatment delivery component may include a pressure delivery component including a pressure applicator having a plurality of pressure elements, each pressure element being in fluid communication with a respective fluid passage in a pressure conduit releasably coupleable to a source of pressurized fluid. Each pressure element may be changeable, in response to receiving the pressurized fluid, from a collapsed configuration to an expanded configuration having a greater volume than the collapsed configuration. The treatment delivery component may also include a thermal delivery component having a thermal applicator removably disposed proximate to the pressure applicator. The thermal applicator may be in fluid communication with a thermal conduit releasably coupleable to a thermal source and configured to conduct therethrough a liquid from the thermal source and to exchange thermal energy between the treatment portion and the liquid. The treatment delivery component may include a first portion and a second portion extending from the first portion. The treatment delivery component may be reconfigurable between: (a) a first configuration in which the treatment portion is a first treatment portion that includes a lower leg of the user's body, the first portion can be disposed on a calf and shin of the user's body, and the second portion can be disposed on a foot of the user's body; and (b) a second configuration in which the treatment portion is a second treatment portion that includes an upper arm and deltoid of the user's body, the first portion can be disposed on an upper arm of the user's body, and the second portion can be disposed on a deltoid of the user's body.

The apparatus may include a liner coupled to the pressure applicator or a portion of the apparatus, that provides a receptacle or cavity in which the thermal applicator may be removably disposable, and can also be removed and washed so as to maintain hygiene and enable hygienic use of the system by multiple users. The apparatus may also be configured to include various components, for example, clips, magnets, bolsters, etc., that allow portions of the pressure applicator and/or the thermal applicator to not be in apposition with the treatment portion so as to conform or fit to various portions of a user's body, or to treatment portions having various sizes. The system may also include a control unit to allow selective delivery of the pressurized fluid to the pressure applicator and/or thermal energy to the thermal applicator independently, simultaneously, sequentially, or in any suitable order. Moreover, the applicator may also include other therapeutic delivery mechanisms, for example, electrostimulation electrodes, electroporation mechanisms, chemical or medicament delivery mechanisms, electromagnetic stimulation mechanisms, vibration actuators, or any other non-pressure or non-thermal delivery mechanisms. The system may also include sensors to sense various parameters indicative of the health of the user, and/or the status or efficacy of any of the treatment modalities being applied to the user by the treatment system.

The terminology used herein is for the purpose of describing particular embodiments only and is not intended to limit the full scope of the claims. Unless defined otherwise, all technical and scientific terms used herein have the same meanings as commonly understood by one of ordinary skill in the art.

As used in this specification, the singular forms “a,” “an,” and “the” include plural referents unless the context clearly dictates otherwise. For example, the term “a member” is intended to mean a single member or a combination of members, “a material” is intended to mean one or more materials, or a combination thereof. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims, are generally intended as “open” terms (e.g., the term “including” should be interpreted as “including but not limited to,” the term “having” should be interpreted as “having at least,” etc.). For example, the terms “comprise(s)” and/or “comprising,” when used in this specification, are intended to mean “including, but not limited to.” While such open terms indicate the presence of stated features, integers (or fractions thereof), steps, operations, elements, and/or components, they do not preclude the presence or addition of one or more other features, integers (or fractions thereof), steps, operations, elements, components, and/or groups thereof, unless expressly stated otherwise.

As used herein the term “and/or” includes any and all combinations of one or more of the associated listed items. Said another way, the phrase “and/or” should be understood to mean “either or both” of the elements so conjoined (i.e., elements that are conjunctively present in some cases and disjunctively present in other cases). It should be understood that any suitable disjunctive word and/or phrase presenting two or more alternative terms, whether in the description, claims, or drawings, contemplate the possibilities of including one of the terms, either of the terms, or both terms. Other elements may optionally be present other than the elements specifically identified by the “and/or” clause, whether related or unrelated to those elements specifically identified. Thus, as a non-limiting example, a reference to “A and/or B” can refer to “A” only (optionally including elements other than “B”), to “B” only (optionally including elements other than “A”), to both “A” and “B” (optionally including other elements), etc.

As used herein, “or” should be understood to have the same meaning as “and/or” as defined above. For example, when separating items in a list, “or” or “and/or” shall be interpreted as being inclusive (e.g., the inclusion of at least one, but also including more than one, of a number or list of elements, and, optionally, additional unlisted items). Only terms clearly indicated to the contrary, such as when modified by “only one of” or “exactly one of” (e.g., only one of “A” or “B,” “A” or “B” but not both, and/or the like) will refer to the inclusion of exactly one element of a number or list of elements.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements, unless expressly stated otherwise. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B” or “at least one of A and/or B”) can refer to one or more “A” without “B,” one or more “B” without “A,” one or more “A” and one or more “B,” etc.

All ranges disclosed herein are intended to encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member and/or a fraction of an individual member where appropriate.

As used herein, the terms “about,” “approximately,” and/or “substantially” when used in connection with stated value(s) and/or geometric structure(s) or relationship(s) is intended to convey that the value or characteristic so defined is nominally the value stated or characteristic described. In some instances, the terms “about,” “approximately,” and/or “substantially” can generally mean and/or can generally contemplate a value or characteristic stated within a desirable tolerance (e.g., plus or minus 10% of the value or characteristic stated). For example, a value of about 0.01 can include 0.009 and 0.011, a value of about 0.5 can include 0.45 and 0.55, a value of about 10 can include 9 to 11, and a value of about 100 can include 90 to 110. Similarly, a first surface may be described as being substantially parallel to a second surface when the surfaces are nominally parallel. While a value, structure, and/or relationship stated may be desirable, it should be understood that some variance may occur as a result of, for example, manufacturing tolerances or other practical considerations (such as, for example, the pressure or force applied through a portion of a device, conduit, lumen, etc.). Accordingly, the terms “about,” “approximately,” and/or “substantially” can be used herein to account for such tolerances and/or considerations.

As used herein, the term “set” can refer to multiple features, components, members, etc. or a singular feature, component, member, etc. with multiple parts. For example, when referring to a set of walls, the set of walls can be considered as one wall with multiple portions, or the set of walls can be considered as multiple, distinct walls. Thus, a monolithically constructed item can include a set of walls. Such a set of walls may include multiple portions that are either continuous or discontinuous from each other. A set of walls can also be fabricated from multiple items that are produced separately and are later joined together (e.g., via a weld, an adhesive (glue, etc.), mechanical fastening such as stitching, stapling, etc., or any suitable method).

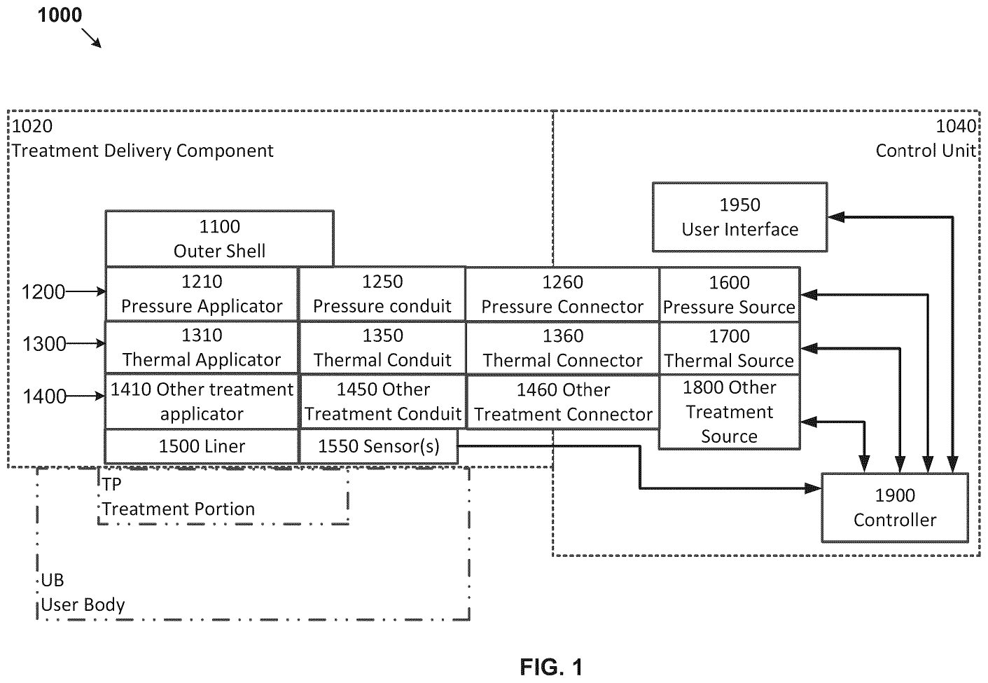

Referring now to the drawings, FIG. 1 is a schematic illustration of a treatment system 1000 according to an embodiment. As shown in FIG. 1, treatment system 1000 includes two primary subsystems—a treatment delivery component 1020 and a control unit 1040.

Treatment delivery component 1020 is configured to be releasably secured to a user body UB of a user to whom treatment is to be delivered by treatment system 1000. Treatment delivery component 1020 includes an outer shell 1100 that can enclose, cover, and/or support one or more of the other components or subsystems of treatment delivery component 1020, and maintain them in operative position with respect to a treatment portion TP of a user body UB to which treatment is to be delivered. Those components or subsystems can include one or more of a pressure delivery component 1200, thermal delivery component 1300, and/or other treatment delivery component 1400, each of which is described in more detail below. Treatment delivery component 1020 can also include a liner 1500 and one or more sensors 1550.

Control unit 1040 can include a controller 1900, a user interface 1950, and one or more of a pressure source 1600 (coupleable to pressure delivery component 1200), thermal source 1700 (coupleable to thermal delivery component 1300), and/or other treatment source 1800 (coupleable to other treatment delivery component 1400).

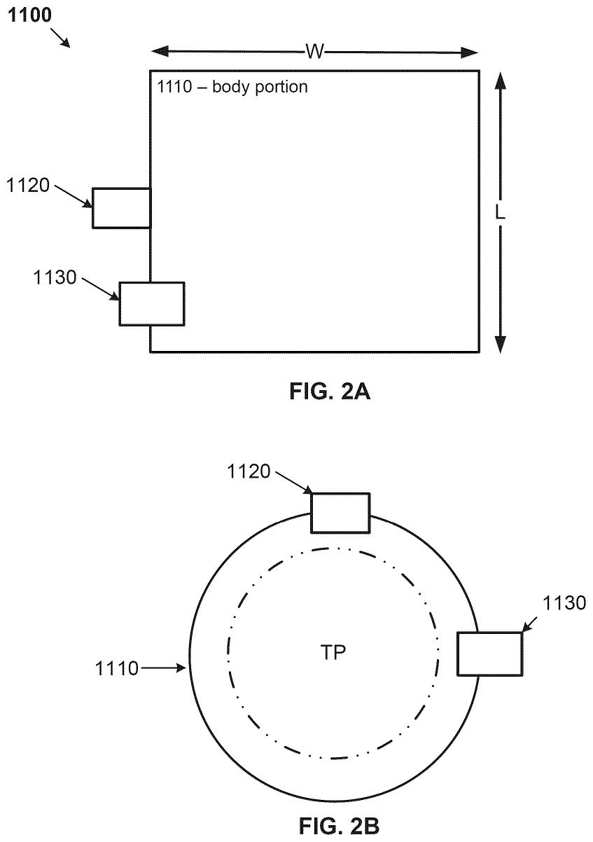

As noted above, outer shell 1100 can enclose, cover, and/or support one or more of the other components or subsystems of treatment delivery component 1020, and maintain them in operative position with respect to a treatment portion TP of a user body UB to which treatment is to be delivered. As shown schematically in FIGS. 2A and 2B, outer shell 1100 may have a body portion 1110 and one or more fastener portions 1120 coupled to body portion 1110 and operable to secure body portion 1110 to, e.g., around a portion of user body UB. Body portion 1110 may be formed as a flexible sheet of material, such as fabric. Fastener portion(s) 1120 may be any suitable fastener that may be secured to one part of body portion 1110 and releasably coupled directly to another part of body portion 1110 (such as by a pin, clamp, hook, etc.) or via a corresponding second fastener portion(s) 1120, or to a corresponding element of the same fastener portion 1120 (e.g. fastener portion 1120 may be a zipper, snap, buckle, hook and loop fastener, etc., with one half secured to one part of body portion 1110 and the mating half secured to another part of body portion 1110). Outer shell 1110 may have a geometry and dimensions that are appropriate to fit to one or more portions of a user body UB to which treatment delivery component 1020 is to be applied to treat treatment portion TP. For example, if treatment delivery component 1020 is configured to be applied to a user leg UL of user body UB, then outer shell 1100 may have a length dimension L sufficient to extend over an appropriate length of user leg UL, e.g., from hip to foot, from hip to knee, from knee to foot, etc. Correspondingly, outer shell 1100 may have a width or circumferential dimension W sufficient to extend around the user leg UL. Although shown schematically in FIGS. 2A and 2B as a having a rectangular shape that may be configured to be fastened to encircle a user leg UL, body portion 1110 may have a more complex geometry to accommodate various anatomical portions of user body UB. For example, body portion 1110 may have a shape that can taper from one end to another to assume an approximately conical shape when secured to a user leg UL, to accommodate the larger diameter of user leg UL near the hip, and the smaller diameter near the ankle. Similarly, body portion 1110 may be a shape that can accommodate and enclose a user's foot. Such geometries are illustrated in embodiments described below. Body portion 1110 may similarly be configured to accommodate and conform to other portions of a user's anatomy, including arms or portions thereof, shoulders, hips, knees, back, head, and torso or portions thereof.

Outer shell 1100 may be configured to be changeable between a first, open configuration (as shown schematically in FIG. 2A) and a second, closed configuration (as shown in FIG. 2B) so that a user may dispose outer shell 1100 on the portion of user body UB to be treated (or dispose the portion of user body on the outer shell 1100) with the outer shell 1100 in the open configuration, and then transition outer shell 1100 to the closed configuration and secure it the closed configuration with fastener portion 1120. However, in some embodiments, outer shell 1100 may be configured to have only a closed configuration. For example, an outer shell configured to treat a user leg UL may be formed as a tube, similar to a pant leg, and the user may don outer shell 1100 like a pant leg, by sliding onto the user leg UL over the foot and up the leg and into the desired longitudinal position.

Outer shell 1100 is configured to enclose and/or support the other subsystems of treatment delivery component 1020 and to hold them in position around and/or against the treatment portion TP of user body UB. These functions of outer shell 1100 will be apparent from the description of the other subsystems below. In addition, outer shell 1100 may include one or more openings or passages 1130 through which one or more components of the other subsystems may pass, e.g., from the interior of the outer shell 1100 in its closed configuration to the exterior of outer shell 1100, e.g., to enable the component(s) of the other subsystem(s) to couple with control unit 1040 and/or to be accessed by the user. In some embodiments, each, any, or all of the other subsystems of treatment delivery component 1020 may be separate from outer shell 1100 and from each other, i.e., may be disposed in operative relationship with each other without coupling to each other, such as by stacking, nesting, etc. In other embodiments, each, any, or all of the other subsystems of treatment delivery component 1020 may be releasably couplable to outer shell 1100 and/or to each other. In still other embodiments, each, any, or all of the other subsystems of treatment delivery component 1020 may be fixedly coupled to outer shell 1100 and/or to each other.

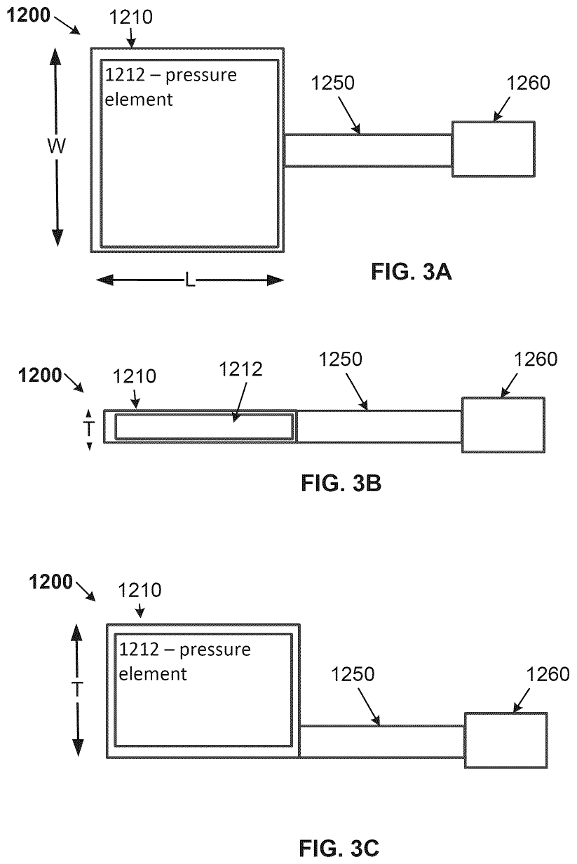

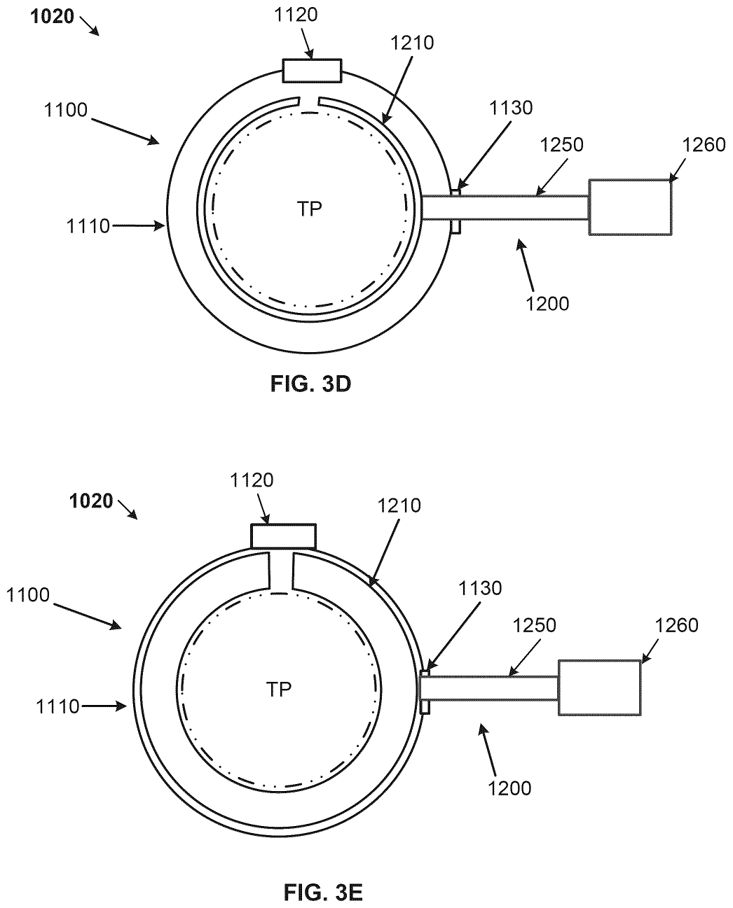

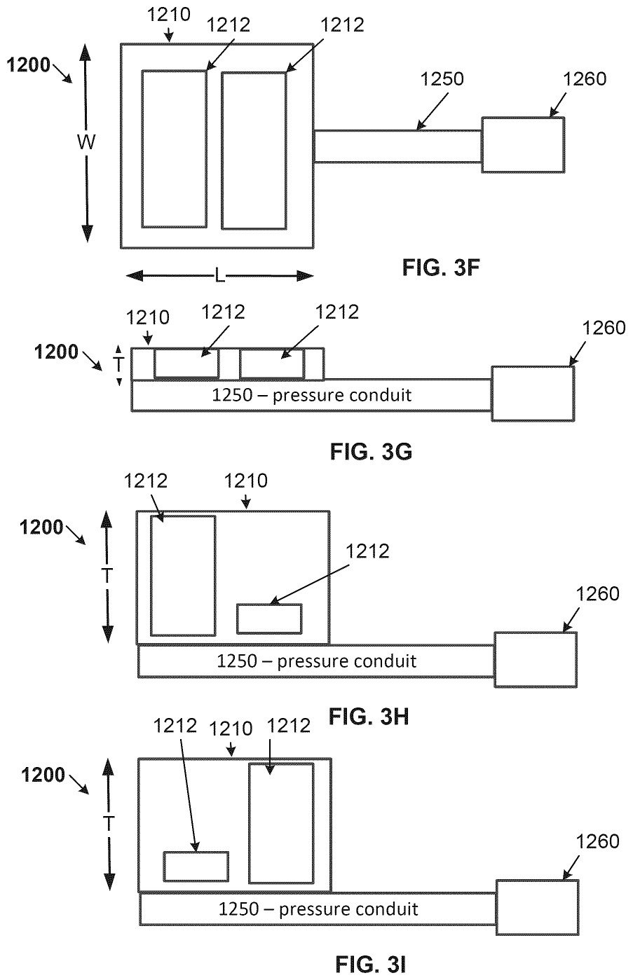

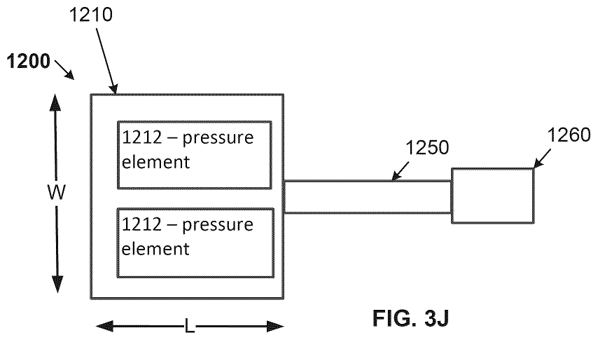

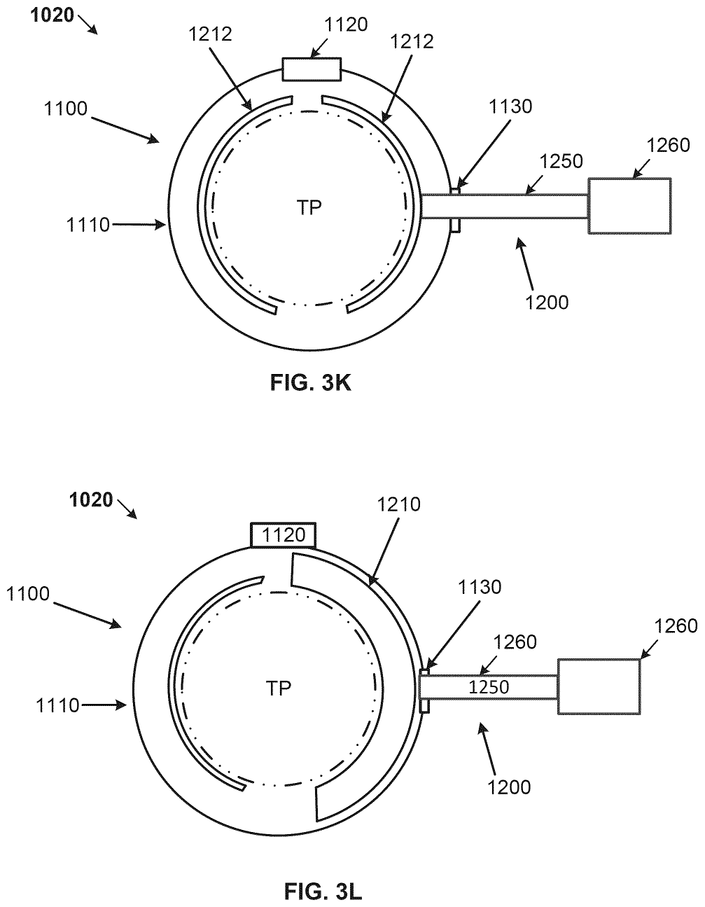

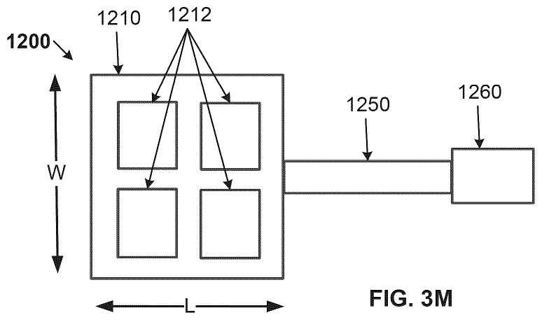

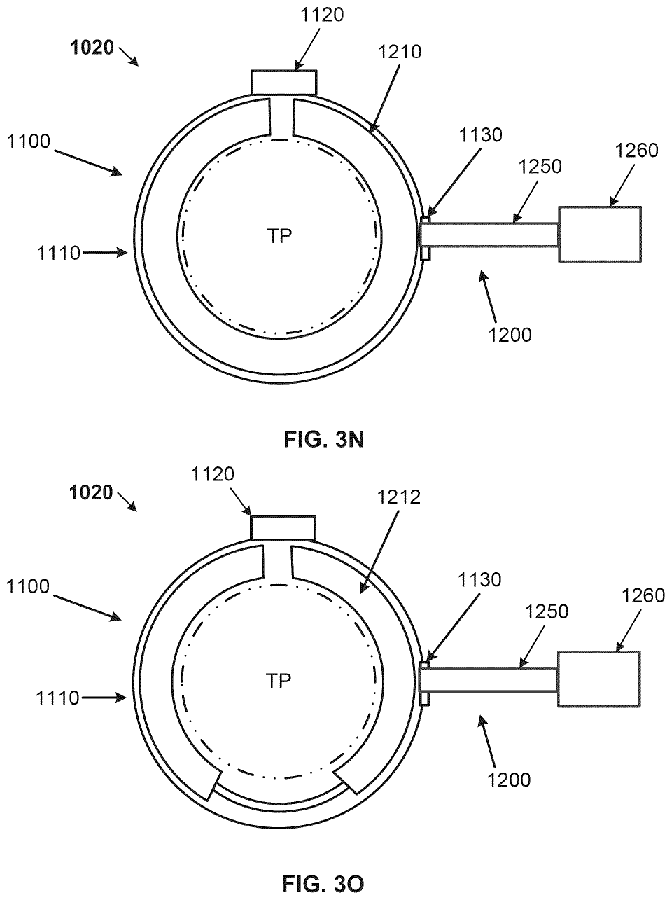

Pressure delivery component 1200 may be operated to provide either or both of two functions: a) it may be operated to selectively deliver pressure treatment or therapy to the treatment portion TP of user body UB; and/or b) it may be operated to interface with outer shell 1100 and one or both of thermal delivery component 1300 and other treatment delivery component 1400 to enhance the effectiveness of those components. Pressure delivery component 1200, also illustrated schematically in FIGS. 3A to 3E, may include a pressure applicator 1210, pressure connector 1260 releasably coupleable to pressure source 1600, and pressure conduit 1250 coupled between pressure connector 1260 and pressure applicator 1210. Thus, pressure applicator 1210 may apply to treatment portion TP of user body UB pressure supplied by pressure source 1600 via pressure connector 1260 and pressure conduit 1250.

As shown schematically in FIG. 3A, as with outer shell 1100, pressure applicator 1210 may have a geometry and dimensions that are appropriate to fit to one or more portions of a user body UB to which treatment delivery component 1020 is to be applied to treat treatment portion TP. For example, if treatment delivery component 1200 is configured to be applied to a user leg UL of user body UB, then pressure applicator 1210 may have a length dimension L sufficient to extend over an appropriate length of user leg UL, e.g., from hip to foot, from hip to knee, from knee to foot, etc. Correspondingly, pressure applicator 1210 may have a width or circumferential dimension W sufficient to extend around the user leg UL.

Pressure (i.e., positive gauge pressure, higher than ambient, atmospheric pressure) may be provided in the form of pressurized fluid, e.g., pneumatic pressure from pressurized gas or hydraulic pressure from pressurized liquid, supplied by pressure source 1600. Correspondingly, pressure source 1600 may be a pump that supplies pressurized liquid, or a compressor that supplies pressurized gas. Pressure source 1600 need not be a powered device such as a pump or compressor, but instead may be a manually actuable device, such as a pump operable by a user's hand (like the bulb of a sphygmomanometer) or foot (like an inflator pump for an air mattress). Pressure applicator 1210 may include one or more pressure elements 1212, which may be volumes, cavities, spaces, or other enclosed portions that may receive the pressurized fluid. In some embodiments, pressure elements 1212 may include one or more bladders or other flexible walled enclosures that may be changeable from a collapsed, deflated, or lower volume configuration having a reduced dimension in a least one direction and an expanded, inflated, or higher volume configuration having an increased dimension in the at least one direction by receiving a volume of the pressurized fluid, and correspondingly may cause the pressure applicator 1210 to change from an unpressurized configuration to a pressurized configuration. This change in configuration is shown schematically in FIGS. 3B and 3C, which show pressure delivery component 1200 in a side view (rather than the top view of FIG. 3A). In the unpressurized configuration shown in FIG. 3B, pressure applicator 1210 has a relatively small thickness T. In contrast, in the pressurized configuration shown in FIG. 3C, pressure applicator 1210 has a relatively large thickness T.

The pressurized fluid may be conducted from pressure source 1600 via pressure conduit 1250, which may be implemented as one or more tubes or pipes of suitable internal diameter to convey the requisite volumetric flow rate of pressurized fluid to cause the pressure applicator 1210 to change from its unpressurized configuration to its pressurized configuration within a desired amount of time, and of appropriate construction to withstand or contain the maximum pressure at which pressurized fluid is to be provided by pressure source 1600.

The interaction of pressure delivery component 1200 and outer shell 1100 is shown schematically in FIGS. 3D and 3E. For ease of illustration, treatment system 1000 is shown only with pressure delivery component 1200 and outer shell 1100, but the other subsystems of treatment system 1000 could also be present. Outer shell 1100 is shown disposed about a treatment portion TP of user body UB, in a closed configuration. Pressure delivery component 1200 is shown with pressure applicator 1210 disposed inside outer shell 1100, and with pressure conduit 1250 extending from pressure applicator 1210 through passage 1130. Pressure applicator is shown in FIG. 3D in its unpressurized configuration, with a relatively small thickness, and in FIG. 3E in its pressurized configuration, with a relatively larger thickness. As shown in FIG. 3E, in its pressurized configuration, pressure applicator 1210 is constrained by outer shell 1100, and therefore presses against, i.e., applies pressure to, treatment portion TP.

Although pressure applicator 1210 is shown in FIGS. 3D and 3E as being separate from outer shell 1110, as noted above pressure applicator 1210 can be releasably coupled to outer shell 1110 (by any suitable mechanism, such as buckles, zippers, hook and loop fasteners, etc.) or may be fixedly coupled to outer shell 1110 (such as by stitching, stapling, welding, gluing, etc.).

As noted above, pressure applicator 1210 may include more than one pressure element 1212. Multiple, independently actuable pressure applicators 1212 can enable differential application of pressure to different regions of treatment portion TP, as illustrated schematically in FIGS. 3F to 31. Pressure applicator 1210 is shown with two independently actuable pressure applicators 1212, which are distributed along the length of pressure applicator 1210. As shown in FIGS. 3H and 31, each pressure element 1212 can be selectively actuated to apply pressure to different lengthwise regions of treatment portion TP. For example, if treatment portion TP is a leg of a user, pressure elements 1212 can be selectively, independently actuated to apply pressure above and below the knee.

In some embodiments, multiple pressure elements 1212 can be distributed across the width of pressure applicator 1210, which may be configured to apply differential pressure treatment to different circumferential regions of treatment portion TP. This is shown schematically in FIGS. 3J to 3L.

In some embodiments, multiple pressure elements 1212 can be distributed across both the width and length of pressure applicator, as shown schematically in FIG. 3M, and the pressure elements can be differentially actuated both lengthwise and circumferentially, essentially combining the operations illustrated schematically in FIGS. 3F to 3L.

Although two pressure elements 1212 are shown in FIGS. 3F to 3J, and four pressure elements are shown in FIG. 3M, this is only for ease of illustration, and pressure applicator 1210 can include any number of pressure elements 1212. Although shown schematically in these figures as being of the same size, pressure elements 1212 can be of different sizes from each other, with different lateral or longitudinal dimensions, which may depend on the shape of the treatment portion TP for which pressure applicator 1210 is configured. Although shown and described herein as being generally rectangular is shape or oriented approximately laterally and longitudinally, pressure elements 1212 can be of any shape, and may be oriented in any directly, e.g. obliquely, spiraling, etc. Although shown schematically in FIGS. 3D-3E, 3K-3L, and 3N-3O as encompassing substantially the entire circumference of treatment portion TP, in some embodiments pressure applicator 1210, and/or collectively all pressure elements 1212, may cover only a portion of the circumference of treatment portion TP. For example, if treatment portion TP is a leg of a user, pressure elements 1212 may be sized and disposed to overlay only the front of the leg (e.g., quadriceps) and not the back of the leg. Although in such embodiments pressure treatment may be delivered only to part of the treatment portion, pressure applicator 1210 can still provide the other functions and benefits described below of adapting thermal applicator 1310 and/or other treatment applicator 1410 to treatment portion TP, ensure good apposition for effective treatment, etc. A potential benefit of having smaller and/or fewer pressure elements is that the energy (e.g. electrical energy) required to expand pressure elements 1212 can be less, and/or the time required to expand them can be less for a given pressure source 1600.

In some embodiments, any or all of one or more pressure elements 1212 can be configured to have non-uniform changes in thickness along their length and/or width dimensions, i.e., to be asymmetric, to provide a desired distribution of pressure application to treatment portion TP and/or achieve particular desired positioning of treatment delivery component 1020 (and outer shell 1100, pressure applicator 1210, thermal applicator 1310, and/or other treatment applicator 1410) relative to treatment portion TP. This is illustrated schematically in FIGS. 3N and 3O, in which pressure element 1212 is configured to have a smaller thickness along portion of its width (or circumference) when actuated. For example, this reduced thickness may be desirable when the treatment portion TP is a user's leg, and less pressure is desired to be applied on the back of the leg, such as on the back of the knee. Such asymmetric configurations may be produced by the geometry of the bladder of envelop of material used to define the pressure element, or by employing different materials, e.g., more or less elastic, to form different portions of the pressure element. The pressure element can also be formed with internal, localized constraints on the extent to which the pressure element can expand. For example, opposed walls (inner and outer) of the pressure element can be selectively fused together (similar to the lines of fusion to form flow diverters in thermal applicators, as described herein) to limit or prevent expansion (by relative movement of the walls) in response to introduction of pressurized fluid.

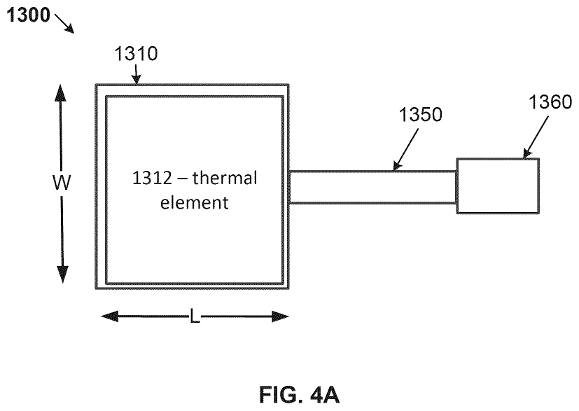

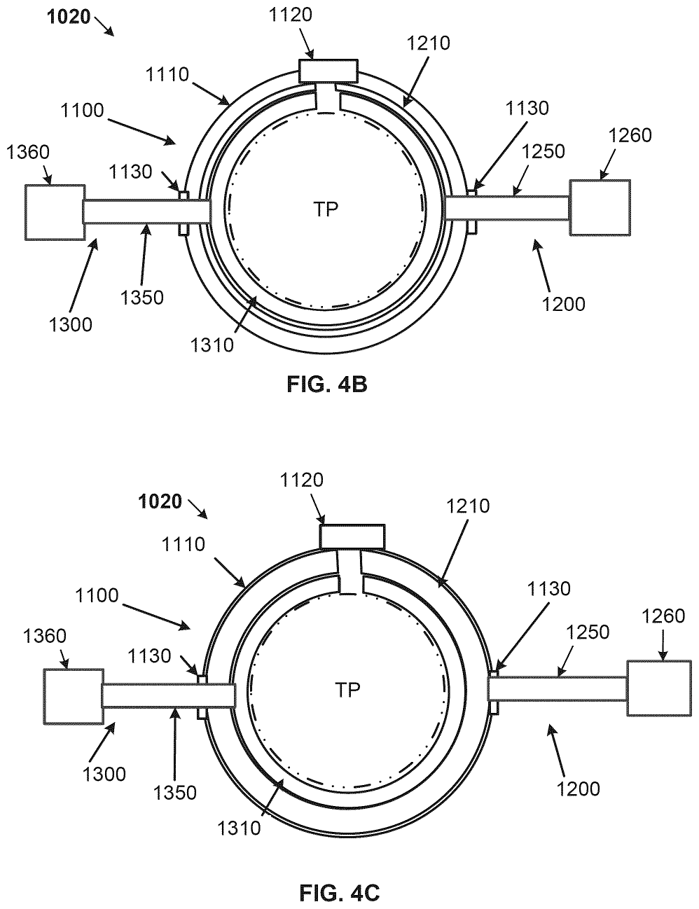

Thermal delivery component 1300 may be operated to exchange thermal energy with the treatment portion TP in either or both of two thermal treatment modes—heating and/or cooling. Heating involves delivering thermal energy to the treatment portion TP, e.g., by contacting treatment portion TP (directly or through other intermediary structures, such as liner 1500) with a component having a temperature higher than body temperature (or skin temperature). Conversely, cooling involves withdrawing thermal energy from the treatment portion TP, e.g., by contacting treatment portion TP (directly or through other intermediary structures, such as liner 1500) with a component having a temperature lower than body temperature (or skin temperature). Thermal delivery component 1300, also illustrated schematically in FIGS. 4A to 4C, may include a thermal applicator 1310 having one or more thermal elements 1312, thermal connector 1360 releasably coupleable to thermal source 1700, and thermal conduit 1350 coupled between thermal connector 1360 and thermal applicator 1310. Thus, thermal applicator 1310 may deliver to, or receive from, treatment portion TP of user body UB thermal energy supplied by, or withdrawn by, thermal source 1700 via thermal connector 1360 and thermal conduit 1350. Thermal source 1700 may thus exchange thermal energy with thermal applicator 1310 (which in turn exchanges thermal energy with treatment portion TP).

As shown schematically in FIG. 4A, as with outer shell 1100 and pressure applicator 1210, thermal applicator 1310 may have a geometry and dimensions that are appropriate to fit to one or more portions of a user body UB to which treatment delivery component 1020 is to be applied to treat treatment portion TP. For example, if treatment delivery component 1020 is configured to be applied to a user leg UL of user body UB, then thermal applicator 1310 may have a length dimension L sufficient to extend over an appropriate length of user leg UL, e.g., from hip to foot, from hip to knee, from knee to foot, etc. Correspondingly, thermal applicator 1310 may have a width or circumferential dimension W sufficient to extend around the user leg UL.

Thermal energy may be delivered to, and/or withdrawn from, treatment portion TP by thermal applicator 1310 (by thermal element(s) 1312) through any of a variety of mechanisms. These mechanisms may be implemented in whole or in part directly in thermal applicator 1310 (or thermal element(s) 1312) and/or in thermal source 1700 (and the thermal energy conveyed to/from thermal applicator 1310 via thermal conduit 1350). One approach involves direct conversion of electrical energy to thermal energy. For example, thermal energy can be generated by passing electric current through an electrical resistance, i.e., by resistive heating. Electrical heating can also be produced by induction heating, e.g., by passing alternating electric current through an electromagnet to produce alternating magnetic fields that produce eddy currents in a conductor, heating the conductor by Joule heating. Thermal energy can also be generated by one of more techniques for using electromagnetic radiation to transfer heat energy to thermal element(s) 1312, or to use thermal element(s) 1312 as the delivery device for the electromagnetic radiation. For example, tissue can be heated with electromagnetic radiation in the microwave, radio frequency (RF), and/or infrared (IR) portions of the frequency spectrum. Ultrasound may also be used to heat tissue. As another example, electrical heating/cooling can be produced by generating an electrical potential by passing electrical current across a thermoelectric material to generate a temperature differential. A heat pump can also be used to transfer thermal energy from a source and deliver it to thermal applicator 1310. One implementation of a heat pump is a thermoelectric cooler (TEC) or Peltier device, i.e., a solid-state heat pump, in which passage of a DC electric current through the device moves thermal energy from one side of the device to the other. The source of thermal energy can be implemented in any suitable manner. For example, the source of thermal energy can be heated fluid, ambient air, a portion of user body UB that is at a higher temperature than another portion, etc. Another implementation of a heat pump is a vapor compression refrigeration system, which circulates a refrigerant through a compressor, condenser, expansion valve, and evaporator. As another example, infrared energy (IR) can be used to deliver thermal energy to the tissue of the user. For example, the thermal element(s) 1312 may include IR lamps configured to generate IR waves that impinge or travel into the tissue and heat the tissue.

Another approach involves conversion of chemical energy to thermal energy, such as an oxidation reaction (e.g., air-activated, iron-based chemistry used in hand warmers), a crystalline phase change reaction (e.g., sodium acetate), or a combustion reaction (e.g., charcoal or lighter fluid). In another approach, thermal source 1700 can be implemented with a reservoir of material (gas, liquid, or solid) with a relatively high specific heat that is at a suitable temperature above body temperature. For example, a reservoir of hot water can be used as the source of thermal energy.

As a sink for thermal energy to be received from thermal applicator 1310, thermal source 1700 can receive the thermal energy through a variety of approaches. Thermal source 1700 can be implemented as a heat pump, to transfer thermal energy from thermal applicator 1310 and deliver it to a suitable heat sink. The same heat pump approaches described above for a source of thermal energy can be used, e.g., Peltier device and/or vapor compression refrigeration cycle. The heat pump used for cooling can be different from the heat pump used for heating. Optionally, with such heat pump implementations, the heat pump can be reversible so that it can operate alternatively to deliver thermal energy to, and receive thermal energy from, thermal applicator 1310. Similarly, thermal source 1700 can also be implemented by conversion of thermal energy to chemical energy, such as the reverse of the crystalline phase change reaction described above. Thermal source 1700 can also be implemented with a reservoir of material (gas, liquid, or solid) with a relatively high specific heat that is at a suitable temperature below body temperature. For example, a reservoir of cold water (including a mixture of water and ice) can be used as the sink for thermal energy. Any other suitable substance that can retain a cold temperature (e.g., dry ice) can be suitably used as a sink.

In some implementations, the exchange of thermal energy between thermal source 1700 and treatment portion TP, or between treatment portion TP and/or thermal source 1700 and the ambient environment, can be via pumping fluid (e.g., air, water, etc.) that may act as an agent to transfer the thermal energy. Treatment system 1000 may implement fluid movers to move the fluid to transfer the heat. For example, treatment system 1000 may implement fluid movers or flow controllers such as fans (e.g., to flow air across heat exchangers), pumps (e.g., to flow fluid past thermal source 1700 and/or thermal applicator 1310), valves (e.g., to direct the flow of fluid), etc.

Thermal source 1700 may function only to deliver thermal energy to thermal applicator 1310, may function only to receive thermal energy from thermal applicator 1310, or may function both to deliver and to receive thermal energy. Although shown in FIG. 1 as having a single thermal source 1700, treatment system 1000 may have more than one thermal source 1700. For example, treatment system 1000 may have one thermal source 1700 to deliver thermal energy and another thermal source 1700 to receive thermal energy, both for application to the same treatment portion TP. In another example, treatment system 1000 may have a separate thermal source 1700 to treat each of two or more treatment portions TP. In some implementations, thermal source 1700 can include a network of interconnected sink(s) and source(s) each accessible and available to a network of heat pumps and/or thermal applicators 1310 via a network of thermal conduits 1350 to deliver thermal modulation to multiple treatment portions TP or an expansive treatment portion TP. Many suitable options are disclosed in the incorporated '059 application.

Depending on the approach used to provide or receive thermal energy, thermal source 1700 may require a source of power. For example, if thermal source 1700 provides thermal energy by resistive heating, or if it provides or receives thermal energy by a Peltier device, it will require a source of electrical energy. Such electrical energy source may be incorporated into, or part of, thermal source 1700, or may be separate from but coupled to thermal source 1700, and still be part of treatment system 1000, such as a primary or secondary battery, or capacitor. Alternatively, the electrical energy source may be separate from thermal source 1700 and treatment system 1000, but thermal source 1700 and/or treatment system 1000 may have an interface to receive electrical energy from the source. Such sources may include DC or AC power (e.g., from a household electric source) with a direct connection, or an indirect connection such as inductive coupling, microwave transfer, laser power transfer, etc.

Thermal conduit 1350 can also be implemented in many different ways, appropriate to the corresponding implementations of thermal source 1700 and thermal applicator 1310, to provide a path for energy to move between thermal source 1700 and thermal applicator 1310, in a single direction or bi-directionally (depending on whether the particular implementation of thermal source 1700 is as a source, sink, or both source and sink for thermal energy). In some implementations, thermal conduit 1350 can operate by conductive, convective, or forced convective transfer, via fluid tubing, via heat pipe, via directed flow of air, passive distribution from one medium to another or within a medium, and/or a combination of approaches. In some implementations, thermal conduit 1350 can be wireless inductive energy transfer that is converted to heat by the receiving thermal applicator 1310. In other implementations, thermal conduit 1350 can be wired conductive electrical energy transfer that is converted to heat by resistive heating by the receiving thermal applicator 1310. In one approach to transferring thermal energy, thermal conduit 1350 can rely on the mechanism of conduction. For example, thermal conduit 1350 can be simply a highly thermally conductive material (e.g., metal) disposed between thermal source 1700 and thermal applicator 1310. Rather than a solid material, thermal conduit can be a thermally conductive liquid. In another approach, thermal conduit 1350 can rely on fluid transport to transfer thermal energy. For example, a liquid heated at an interface (e.g., a heat exchanger) at thermal source 1700 can be conveyed through a tube or pipe to thermal applicator 1310 and transfer thermal energy at an interface (e.g. another heat exchanger) at thermal applicator 1310. Cooled liquid can be returned through a separate tube or pipe to thermal source 1700 to be reheated. The tubing can be formed of any material suitable for conveying the fluid. The tubing at the heat exchanger associated with the thermal applicator 1310 may be thermally conductive (e.g., gold, aluminum, or copper), whereas the tubing in other portions of thermal conduit 1350 may be relatively non-conductive (e.g., polymer), and may optionally be covered with a separate insulating material to further reduce thermal energy transfer between the fluid in the tubing and the environment. The tubing can be of any suitable size, shape or form. For example, in some implementations the tubing can be of a suitably narrow or broad area of cross section and follow a serpentine or other suitably convoluted path to increase a surface area of contact between the fluid path and a heat exchanger or thermal source 1700.

Thermal source 1700 and thermal delivery component 1300 can be implemented with any of the techniques, structures, and component described in the incorporated '059 application.

The interaction of thermal delivery component 1300 with pressure delivery component 1200 and outer shell 1100 is shown schematically in FIGS. 4B and 4C. For ease of illustration, treatment system 1000 is shown only with thermal delivery component 1300, pressure delivery component 1200, and outer shell 1100, but the other subsystems of treatment system 1000 could also be present. Outer shell 1100 is shown disposed about a treatment portion TP of user body UB, in a closed configuration. Pressure delivery component 1200 is shown with pressure applicator 1210 disposed inside outer shell 1100, and with pressure conduit 1250 extending from pressure applicator 1210 through a passage 1130. Thermal delivery component 1300 is shown with thermal applicator 1310 disposed inside outer shell 1100 and pressure applicator 1210, and with thermal conduit 1350 extending from thermal applicator 1310 through another passage 1130. The interaction between thermal conduit 1350 and passage 1130 can aid in maintaining the position of thermal applicator 1310 relative to outer shell 1100. Although shown in FIGS. 4B and 4C as being disposed through body portion 1110 of outer shell 1100, the passage 1130 through which thermal conduit 1350 extends may also be formed through pressure applicator 1210. Pressure applicator 1210 may have one or more welds or seams between, and partially defining, individual pressure elements (not shown) and passage 1130 may be formed in, or adjacent to, such weld or seam. As described herein, pressure applicator 1210 may be integrally formed with, or fixedly secured to, body portion 1110, and passage 1130 may therefore be a single opening formed through both structures. Pressure applicator 1210 is shown in FIG. 4B in its unpressurized configuration, with a relatively small thickness, and in FIG. 4C in its pressurized configuration, with a relatively larger thickness. As shown in FIG. 4C, in its pressurized configuration, pressure applicator 1210 is constrained by outer shell 1100, and therefore presses against, i.e., applies pressure to, thermal applicator 1310, and through thermal applicator 1310 to treatment portion TP.

As described above for pressure applicator 1210, although thermal applicator 1310 is shown in FIGS. 4B and 4C as being separate from outer shell 1110 and from pressure applicator 1210, thermal applicator 1310 can be releasably coupled to outer shell 1110 and/or pressure applicator 1210 (by any suitable mechanism, such as buckles, zippers, hook and loop fasteners, clips, etc.) or may be fixedly coupled to outer shell 1110 and/or pressure applicator 1210 (such as by stitching, stapling, welding, gluing, etc.).

Pressure delivery component 1200 can be operated to maintain a baseline, or minimum, pressure in pressure applicator 1210, by which pressure applicator 1210 can apply sufficient pressure to thermal applicator 1310 to maintain good contact between thermal applicator 1310 and treatment portion TP, i.e., sufficient contact to provide good heat transfer between thermal applicator 1310 and treatment portion TP. Optionally, pressure delivery component 1200 can also be operated at higher pressure(s) to provide pressure therapy via pressure applicator 1210, as described above, applying the pressure therapy through thermal applicator 1310 (whether or not thermal applicator 1310 is actively providing thermal treatment).

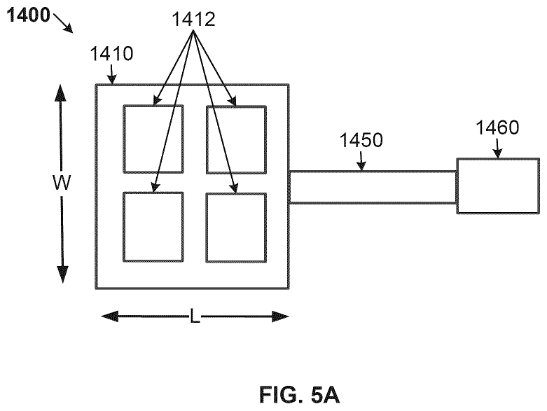

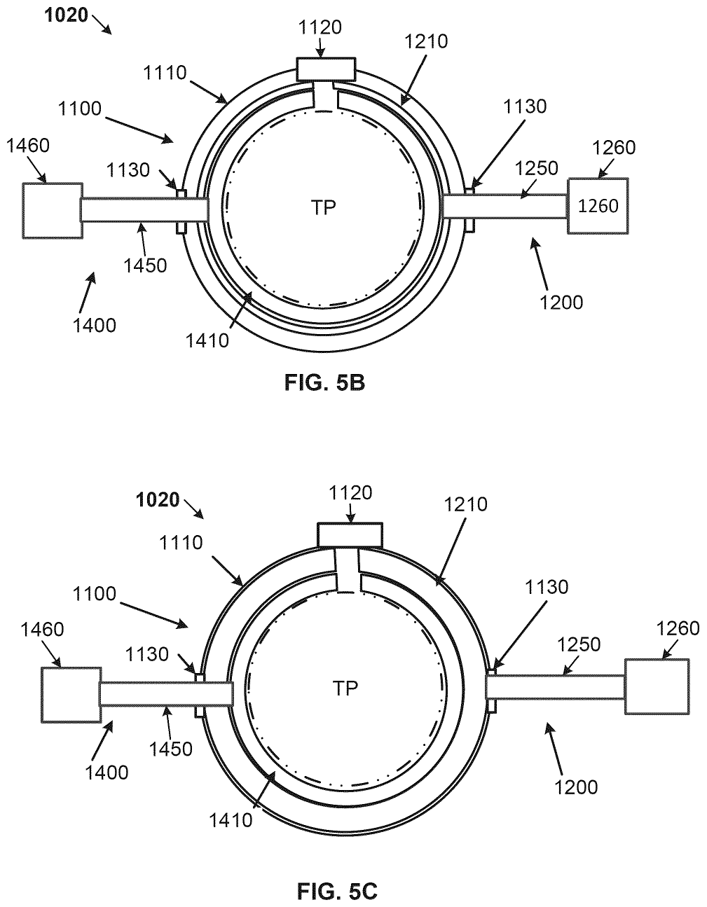

Other treatment delivery component 1400 may be configured to provide any one or more of various treatment modalities. As used herein, “other treatment” means a treatment with a modality other than thermal or pressure, so an “other treatment delivery component” is a treatment delivery component that is not exclusively either a thermal delivery component or a pressure delivery component. “Other treatment” may also be referred to herein as “supplemental treatment,” e.g., is the other treatment is combined with (or supplemental to) pressure and/or thermal treatment. As described in more detail herein, the “other treatment delivery component” may be incorporated into, or integrated with, one of both of a thermal delivery component and a pressure delivery component, or may be a separate component. In some embodiments, the other treatment delivery component 1400 may be completely independent of the other components of treatment delivery component 1020. Such non-thermal, non-pressure treatment modalities may include based on electrical energy (such as transcutaneous electrical nerve stimulation (TENS), electromyostimulation (EMS), neuromuscular electrical stimulation (NEMS), and/or electroporation), on magnetic fields, on other electromagnetic radiation (such as light for phototherapy, or pulsed electromagnetic field (PEMF)), on chemistry (such as delivery of large or small molecule therapeutic compositions), on mechanical force (such as vibration), or combinations thereof (for example, electroporation can enhance delivery of chemical therapeutics into cells in treatment portion TP). For each modality, other treatment delivery component 1400 can include, as shown schematically in FIG. 1 and FIG. 5A, other treatment applicator 1410 with one or more other treatment elements 1412, other treatment conduit 1420, and other treatment connector 1460, by which the other treatment modality can be delivered from other treatment source 1800. Each of those components are configured appropriately for the other treatment modality. For example, for an electrical energy based treatment modality, such as TENS, other treatment applicator 1410 (which may also be referred to as electrical treatment applicator 1410 because the treatment modality is based on electrical energy) can include an array of other treatment elements 1412 (or electrical treatment elements 1412), each of which is an electrode configured to be applied to the surface (e.g., skin) of treatment portion TP so that electrical energy can be supplied by conduction to treatment portion TP. Correspondingly, other treatment conduit 1410 (or electrical treatment conduit 1410) can be an electrical conductor (wire(s), etc.), and other treatment connector 1460 (or electrical treatment connector 1460) can be an electrical connector, and these components can convey electrical energy from other treatment source 1800 (or electrical treatment source 1800), which may be, for example, an electrical pulse generator. Any or all of the electrodes can also be used to confirm apposition or electrical contact with the surface of treatment portion TP, so that controller 1900 can determine which, if not all, of the electrodes should receive electrical energy. Other treatment applicator 1410 can include a substrate for support of other treatment elements 1412, which can have a variety of constructions. For example the substrate can be a sheet of woven or non-woven fabric, mesh, or other material, which is preferably relative inelastic, so that it does not stretch (and thus change the relative spacing of other treatment elements 1412). Other treatment applicator 1410 can include multiple layers, with different treatment modalities on different layers, e.g., a layer with electrodes for delivery of electrical and/or magnetic treatment modalities, and a layer with vibration actuators or transducers to deliver a mechanical treatment modality. As discussed herein, other treatment applicator 1410 can be integrated with pressure applicator 1210 and/or thermal applicator. In other embodiments, other treatment applicator can be integrated with liner 1500 (discussed below).

In another example, for a chemistry based treatment modality, such as delivery of a drug or other chemical therapeutic, other treatment applicator 1410 (which can also be referred to as chemical applicator 1410) can include one or more other treatment elements 1412 (or chemical elements 1412), each of which may be a drug delivery device such as a needle, array of microneedles, drug delivery patch, etc. by which the drug can be delivered to (e.g., dermally) or into (e.g., transdermally, subcutaneously, intramuscularly) treatment portion TP. Correspondingly, other treatment conduit 1450 (or chemical conduit 1450) can be a tube, and other treatment connector 1460 (or chemical connector 1460) can be a fluid connector, by which a drug (e.g., in fluid form, in solution, etc.) can be conveyed from other treatment source 1800 (or chemical source 1800), which may be, for example a reservoir of the drug. Many therapeutics are delivered transdermally, and the delivery of the therapeutic depends on many factors including temperature and the quality of the contact. A therapeutic could be applied or added to an other treatment applicator, such as in the form of a membrane that is pressurized and forced to have good apposition with the skin for delivery. This can be done with any membrane surface using the pressure applicators described herein.

For other treatment modalities such as TENS, it may be desirable for the other treatment elements 1412 (or electrical elements 1412, e.g., electrodes) to be arranged on a substrate (such as a non-conductive, flexible fabric) in a specific spatial relationship, and for that spatial relationship to be maintained independently of the size of the treatment portion TP of the user. It may therefore be desirable for the substrate to be relatively inelastic, i.e., not to stretch or distort when applied to treatment portion TP, and also not to wrinkle, crease, or fold. The overlying relationship of pressure applicator 1210 can aid in minimizing distortion, etc. of other treatment applicator 1410.

Other treatment modalities could be used for many other conditions, such as muscle soreness after exercise, muscle ischemia, muscle trauma, phantom limb pain, muscle cramps, night leg cramps and spasms, promotion of tissue healing, etc.

As shown schematically in FIG. 5A, as with outer shell 1100, pressure applicator 1210, and thermal applicator 1310, other treatment applicator 1410 may have a geometry and dimensions that are appropriate to fit to one or more portions of a user body UB to which treatment delivery component 1020 is to be applied to treat treatment portion TP. For example, if treatment delivery component 1020 is configured to be applied to a user leg UL of user body UB, then other treatment applicator 1410 may have a length dimension L sufficient to extend over an appropriate length of user leg UL, e.g., from hip to foot, from hip to knee, from knee to foot, etc. Correspondingly, other treatment applicator 1410 may have a width or circumferential dimension W sufficient to extend around the user leg UL. In other embodiments, other treatment applicator 1410 may be smaller in width or length than the overlying pressure applicator 1210 or outer shell 1100, e.g., if a smaller area of the treatment portion is desired to be treated with the other treatment modality.

The interaction of other treatment delivery component 1400 with pressure delivery component 1200 and outer shell 1100 is shown schematically in FIGS. 5B and 5C. For ease of illustration, treatment system 1000 is shown only with other treatment delivery component 1400, pressure delivery component 1200, and outer shell 1100, but the other subsystems of treatment system 1000 could also be present. Outer shell 1100 is shown disposed about a treatment portion TP of user body UB, in a closed configuration. Pressure delivery component 1200 is shown with pressure applicator 1210 disposed inside outer shell 1100, and with pressure conduit 1250 extending from pressure applicator 1210 through a passage 1130. Other treatment delivery component 1400 is shown with other treatment applicator 1410 disposed inside outer shell 1100 and pressure applicator 1210, and with other treatment conduit 1450 extending from other treatment applicator 1410 through another passage 1130. Pressure applicator is shown in FIG. 5B in its unpressurized configuration, with a relatively small thickness, and in FIG. 5C in its pressurized configuration, with a relatively larger thickness. As shown in FIG. 5C, in its pressurized configuration, pressure applicator 1210 is constrained by outer shell 1100, and therefore presses against, i.e., applies pressure to, other treatment applicator 1410, and through other treatment applicator 1410 to treatment portion TP.

As described above for pressure applicator 1210 and thermal applicator 1310, although other treatment applicator 1410 is shown in FIGS. 5B and 5C as being separate from outer shell 1110 and from pressure applicator 1210, other treatment applicator 1410 can be releasably coupled to outer shell 1110 and/or pressure applicator 1210 (by any suitable mechanism, such as buckles, zippers, hook and loop fasteners, clips, etc.) or may be fixedly coupled to outer shell 1110 and/or pressure applicator 1210 (such as by stitching, stapling, welding, gluing, etc.).

As with thermal applicator 1310, pressure delivery component 1200 can be operated to maintain a baseline, or minimum, pressure in pressure applicator 1210, by which pressure applicator 1210 can apply sufficient pressure to other treatment applicator 1410 to maintain good contact between other treatment applicator 1410 and treatment portion TP, i.e., sufficient contact to provide good application of the treatment modality (such as good electrical contact for electrical energy based treatment modalities). And, optionally, pressure delivery component 1200 can also be operated at higher pressure(s) to provide pressure therapy via pressure applicator 1210, as described above, applying the pressure therapy through other treatment applicator 1410 (whether or not other treatment applicator 1410 is actively providing treatment).

Although shown and described above as being separate from the pressure delivery component 1200 and thermal delivery component 1300, other treatment delivery component 1400 can be integrated with one of the other treatment delivery components. For example, for an electrical energy based other treatment modality, other treatment elements 1410 can be incorporated into a surface of thermal applicator 1310 (if used) or into a surface of pressure applicator 1210 (if treatment delivery component 1020 is not configured to include a thermal delivery component 1300).

Other treatment delivery component 1400 can also be separate from, but used in conjunction with, both pressure delivery component 1200 and thermal delivery component 1300. For example, other delivery component 1400 can be disposed between thermal delivery component 1300 and treatment portion TP, and configured to have a relatively low thermal insulation value so as not to materially reduce the amount of thermal energy deliverable via thermal delivery component 1300. In some embodiments, other treatment applicator 1410 can be disposed on treatment portion TP independently of the other components of treatment delivery component 1020, and held in operative position on treatment portion TP by disposing thermal applicator 1310 and/or pressure applicator 1210 on top of other treatment applicator 1410.

As noted above, treatment delivery component 1020 can also include a liner 1500.

Treatment delivery component 1020 can be configured so that liner 1500 is the only, or substantially the only, portion of treatment delivery component 1020 that contacts the skin of the user, e.g., the skin on the treatment portion TP of the user body UB. This may be a desirable configuration if treatment delivery component 1020 is to be used by multiple users, or by the same user for many treatment delivery sessions, so that the liner can be washed, or replaced, between treatment sessions and/or between users, to provide for more hygienic delivery of treatment. Liner 1500 may thus be configured to be releasably coupleable to outer shell 1100, pressure applicator 1210, thermal applicator 1310, and/or other treatment applicator 1410. In other embodiments, liner 1500 may be fixedly coupled to one or more of the other components of treatment delivery component 1020. In use, a previously unused liner 1500 may be coupled to the other component(s) of treatment delivery component 1020 before treatment delivery component 1020 is operatively engaged with a user to deliver treatment. After the treatment is delivered to the user, the liner 1500 may then be removed and washed before use by the same user for a subsequent treatment delivery session, or by a different user. Alternatively, the liner 1500 may be discarded and replaced by a new liner 1500. Liner 1500 may also be formed of, or be treated with, material having antimicrobial properties. Liner 1500 may also be configured to provide containment, support, and/or aid in coupling or desired alignment of any of the applicators. For example, liner 1500 may be coupled to, and define with, outer shell 100 and/or pressure applicator 1210 a sleeve or pocket into which thermal applicator 1310 may be disposed.

Liner 1500 may be formed of material(s) that provide desired properties for liner 1500. For example, if liner 1500 is to be used in conjunction with thermal applicator 1310, and thus be disposed between thermal applicator 1310 and treatment portion TP, it may be desirable that liner 1500 have a minimal insulation value, so that it imposes a minimal loss of thermal energy transfer between thermal applicator 1310 and treatment portion TP. This thermal property may be achieved with a fabric woven with fine fibers and a high fiber count or tight weave, so that it traps very little air between the fibers, and a very thin layer of insulating air between thermal applicator 1310 and treatment portion TP. Alternative, in some applications it may be desirable for liner 1500 to have a larger insulation value, to produce a significant difference in temperature between the surface of thermal applicator 1310 and the surface of treatment portion TP (i.e., the user's skin, for example, if thermal applicator 1310 is circulating ice water or other very cold fluid, it may be desirable not to expose the user's skin to that temperature). In some embodiments, a user may be provided with multiple interchangeable liners 1500 with different properties to use for different treatment regimens. If liner 1500 is to be used with an other treatment applicator 1400 employing an electrical energy based treatment modality, it may be desirable for liner 1500 to be electrically conductive. In some embodiments, liner 1500 may have openings or apertures therethrough to permit electrical elements 1412 (e.g. electrodes) from an overlying electrical applicator to contact the surface of treatment portion TP therethrough. In other embodiments, liner 1500 and other treatment applicator 1410 may be integrated, e.g. liner 1500 may incorporate other treatment elements 1412. Such an arrangement may be advantageous in that a user may obtain a treatment delivery component 1020 that includes a pressure treatment component 1200 and/or thermal treatment component 1300, and separately or subsequently obtain an integrated liner 1500/other treatment applicator 1410 and releasably couple to the other components to enable delivery of the other treatment modality. If liner 1500 is to be used with an other treatment applicator employing a chemistry based treatment modality, it may be desirable for liner 1500 to be permeable to the drug or other chemical therapeutic delivered by other treatment delivery component 1400.

In some embodiments, liner 1500 may be coupled to outer shell 1100, pressure applicator 1210, thermal applicator 1310, and/or other treatment applicator 1410 so as to enclose, support, or otherwise aid in retaining or maintaining in a desired position any one or more of the applicators. For example, liner 1500 may be coupled to outer shell 1100 to form a pocket in which thermal applicator 1310 may be releasably disposed (as described in more detail below).

As noted above, treatment delivery component 1020 can also include one or more sensors 1550. Such sensors could include sensors to measure parameters such as temperature (in a single location, or multiple locations to measure temperature gradient), pressure (in a single location, or multiple locations to measure pressure gradient), electrical field, electrical current, magnetic field, EKG, EMG, chemical concentration, motion, acceleration, user vital signs (blood pressure, heart rate, O₂ saturation, blood flow (e.g. by laser doppler or similar measurement), respiration rate, etc.) and/or other parameters that may be indicative of the status or efficacy of any of the treatment modalities being applied to a user by treatment system 1000. Sensor(s) 1500 may be disposed in operative relationship with the treatment portion TP of the user, or some other portion of user body UB. For example, one or more sensors may be disposed in contact or close proximity with the surface (e.g., skin) of treatment portion TP, including between the treatment portion and the most proximal layer of treatment delivery component 1020 (e.g., liner 1500, other treatment applicator 1410, thermal applicator 1410, or pressure applicator 1210). Additionally or alternatively, one or more sensors may be disposed in operative relationship with one or more components of treatment delivery component 1020, such as disposing a pressure sensor to measure a pressure in each of one or more pressure elements 1212 (such as a bladder), or disposing an EMG sensor adjacent to (or as part of) a muscle stimulator. The output(s) of such sensor(s) 1500 may be communicated to controller 1900, such as by wired or wireless communication channel(s). The effectiveness, accuracy, and/or reliability of such sensors 1550 can be enhanced by good apposition with the surface of treatment portion, using any of the components and techniques described below. Similarly, the repeatability of sensor measurements can be improved by disposing the sensors on a non-expanding membrane or fabric.

Controller 1900 can be any suitable compute device that can electronically control functioning of treatment system 1000. As shown in FIG. 1, controller 1900 can be configured to be appropriately suited for the corresponding implementation of treatment system 1000, including any suitable hardware-based computing device and/or a multimedia device, such as, for example, a server, a microprocessor, a desktop compute device, a smartphone, a tablet, a wearable device, a laptop and/or the like.

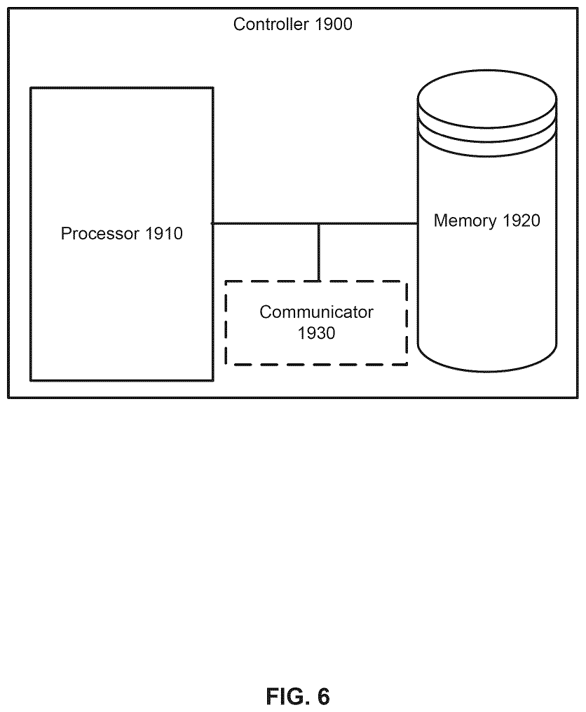

FIG. 6 is a schematic block diagram of controller 1900, according to an example implementation. Controller 1900 includes a processor 1910, a memory 1920 (e.g., including data storage), and optionally a communicator 1930.

Processor 1910 can be, for example, a hardware based integrated circuit (IC) or any other suitable processing device configured to run and/or execute a set of instructions or code. For example, processor 1910 can be a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. Processor 1910 can be operatively coupled to memory 1920 through a system bus (for example, address bus, data bus and/or control bus).

Processor 1910 can be configured to send instructions to one or more components of treatment system 1000 to operate the components. For example, processor 1910 can generate and/or receive instructions and send instructions to activate and/or deactivate pressure source 1600, thermal source 1700, and/or other treatment source 1800, one or more fluid movers or flow controllers to convey fluid via the pressure conduit 1250, thermal conduit 1350, or other treatment conduit 1450, one or more portions of pressure applicator 1210, thermal applicator 1310, and/or other treatment applicator 1410, following the associated instructions. In some embodiments, processor 1910 can be configured to maintain logs or schedules of treatment and associated instructions used to carry out the treatment. In some embodiments, the instructions used to carry out the treatment are adjusted by processor 1910 based on information provided by or related to the user. Processor 1910 can also be configured to maintain a log of information related to the user (e.g., identifier of the user, time and date of treatment, settings and preferences associated with the user (e.g., temperature settings for thermal treatment, pressure settings for pressure treatment, other settings for other treatment modalities, duration of treatment, etc.), timetable of treatment administration, etc.). Processor 1910 can store data and/or files associated with a user and/or a treatment approach or protocol. In some embodiments, processor 1910 can receive feedback from sensor(s) 1550 and/or the user (e.g., behavioral responses including perception of degree of pain, level of pain relief experienced, physiological responses like heart rate, breathing, blood pressure, etc., and input provided by the user like sensitivity to heat, sensitivity to cold temperatures, etc.). Data from sensors 1550 can be used by processor 1910 to monitor and/or modify operation of control unit 1040 and/or treatment delivery component 1020. For example, if processor 1910 receives temperature data from a sensor 1550 that indicates a temperature at the surface of treatment portion TP exceeds a high temperature threshold, or falls below a low temperature threshold, processor 1910 may suspend or terminate operation of thermal delivery component 1300 to avoid injury to treatment portion TP. Similarly, if processor 1910 receives blood flow data from a sensor 1550 that indicates a blood flow rate in treatment portion TP falls below a threshold flow rate, processor 1910 may suspend or terminate operation of pressure delivery component 1200 to avoid injury to treatment portion from lack of blood supply. Processor 1910 may cause data received from one or more sensor 1550 to be displayed to the user on display 1960. Data from multiple sensors 1550 may be used by processor 1910 to determine additional information about the user. For example, data from a blood flow sensor and a pressure sensor could be used in combination to determine the pressure at which blood flow is cut off, to calculate a blood pressure (diastolic and/or systolic) of the user.

Memory 1920 of controller 1900 can be, for example, a random access memory (RAM), a memory buffer, a hard drive, a read-only memory (ROM), an erasable programmable read-only memory (EPROM), and/or the like. Memory 1920 can store, for example, one or more software modules and/or code that can include instructions to cause processor 1910 to perform one or more processes, functions, and/or the like (e.g., receiving signals from sensors 1500, sending signals to fluid movers and/or flow controllers, sending signals to thermal treatment elements, etc.). In some embodiments, memory 1920 can include extendable storage units that can be added and used incrementally. In some implementations, memory 1920 can be a portable memory (for example, a flash drive, a portable hard disk, and/or the like) that can be operatively coupled to processor 1910. In other instances, memory 1920 can be remotely operatively coupled with controller 1900. For example, a remote database server can serve as a memory and be operatively coupled to the compute device.

Communicator 1930 can be a hardware device operatively coupled to processor 1910 and memory 1920 and/or software stored in memory 1920 executed by processor 1910. Communicator 1930 can be, for example, a network interface card (NIC), a WI-FI™ module, a Bluetooth® module and/or any other suitable wired and/or wireless communication device. Furthermore, communicator 1930 can include a switch, a router, a hub and/or any other network device. Communicator 1930 can be configured to connect controller 1900 to a communication network. In some instances, communicator 1930 can be configured to connect to a communication network such as, for example, a near field communication (NFC) network, the Internet, an intranet, a local area network (LAN), a wide area network (WAN), a metropolitan area network (MAN), a worldwide interoperability for microwave access network (WiMAX®), an optical fiber (or fiber optic)-based network, network using HTTP and other protocols, networks implementing WLAN (including 802.11a/b/g/n and other radio frequency-based protocols and methods), network supporting analog transmissions, Global System for Mobile Communications (GSM), 3G/4G/LTE, a BLUETOOTH® network, a virtual network, network implementing communications via ZigBee, EnOcean, TransferJet, Wireless USB, and/or any combination thereof.

In some instances, communicator 1930 can facilitate receiving and/or transmitting data and/or files through a communication network. In some instances, a received file can be processed by processor 1910 and/or stored in memory 1920 and used to control the operation of treatment system 1000 as described herein.

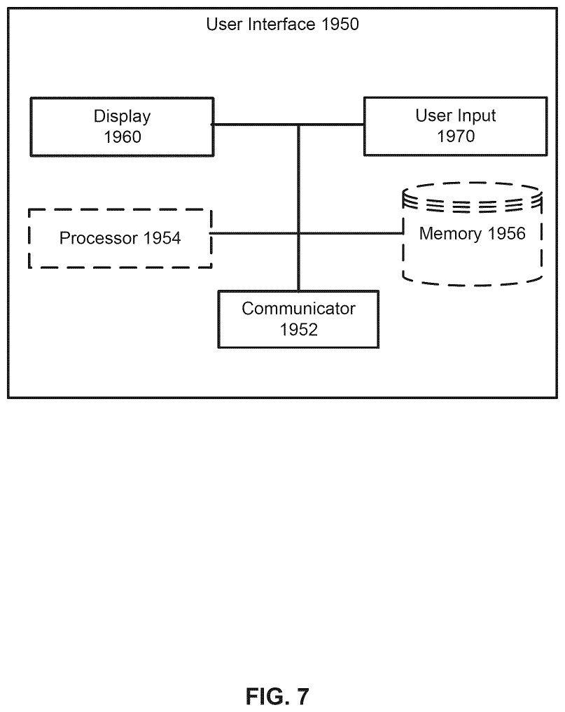

As noted above, control unit 1040 can include a user interface 1950. As shown schematically in FIG. 7, user interface 1950 can include a communicator 1952, an optional processor 1954, and an optional memory 1956, which may function, and be implemented, in similar fashion to processor 1910, memory 1920, and communicator 1930, as described above for controller 1900. Communicator 1952 may communicate with optional communicator 1930 of controller 1900, and/or may communicate directly with, for example, processor 1910. In addition, user interface 1950 may include a display 1960 and a user input 1970. Display 1960 may provide a visual display to the user operating parameters for treatment system 1000, such as pressure for pressure delivery component 1200 (e.g. for pressure source 1600, and/or any or all of pressure elements 1212), temperature for thermal delivery component 1300 (e.g. for thermal source 1700 and/or any thermal element 1312), and/or any relevant operating parameter(s) for other delivery component 1400 (including other treatment source 1800 and/or any other treatment element 1412), time (planned treatment time, elapsed actual treatment time, and/or other time parameters for any of the treatment delivery components), and/or other information of relevance to the user. User input 1970 may provide input mechanisms (dial, knob, button, user interactive panel, and/or the like) by which the user can provide inputs to the user input 1970 to be communicated to controller 1900 (e.g., processor 1910) In some implementations, display 1960 and user input 1970 may be combined, e.g., as a touch screen.

Although shown in FIG. 1 as being part of control unit 1040, in some embodiments user interface 1950 may be implemented on a device that is physically separate from control unit 1040 (and its other subsystems, such as pressure source 1600, thermal source 1700, other treatment source 1800, and controller 1900). For example, user interface 1950 may be implemented in software operating on a separate device such as a smartphone or tablet (e.g., in a dedicated app), and the touch screen of the smartphone or tablet may combine the functions of display 1960 and user input 1970, so that the device can control operation of the control unit 1040.

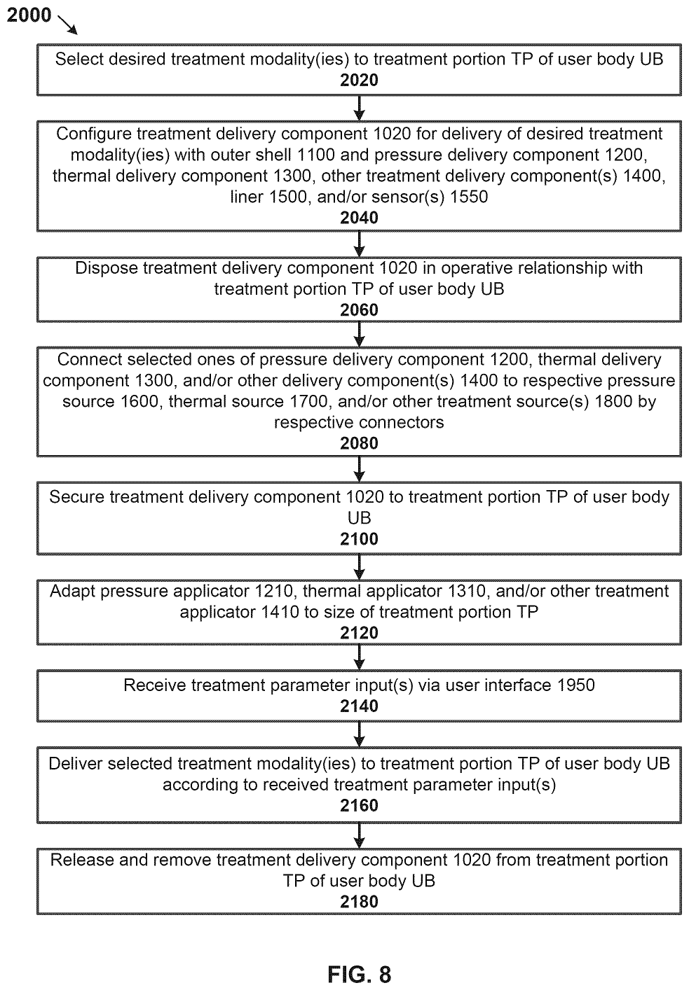

An exemplary method of treatment of a user with treatment system 1000 is illustrated in FIG. 8. As shown in FIG. 8, method 2000 includes a series of steps or actions—many of these steps may be optional, the steps may be performed in sequences other than those shown in FIG. 8, and other steps may be included in the treatment of a user. At 2020, one or more desired treatment modalities (e.g., pressure, thermal, and/or other) may be selected for treatment of treatment portion TP of user body UB. The selection may be made by the user and/or by a third party (physician or other medical practitioner, trainer, physical therapist, etc.). At 2040, treatment delivery component 1020 of treatment system 1000 can be configured for delivery of the desired treatment modality(ies). For example, outer shell 1100 may be associated with or coupled to one or more of liner 1500, pressure delivery component 1200, thermal delivery component 1300, other treatment delivery component 1400, and/or sensor(s) 1550. At 2060, the configured treatment delivery component 1020 may be disposed in operative relationship with treatment portion TP of user body UB. For example, if the treatment portion TP is a leg of a user, treatment delivery component 1020 may be disposed on a floor, table, or other surface in an open configuration, and the user can place the leg on the inside surface of treatment delivery component 1020 (e.g., on liner 1500, if included in the configuration). At 2080, the selected delivery components (e.g. pressure delivery component 1200, thermal delivery component 1300, and/or other delivery component 1400) can be connected to their respective sources (pressure source 1600, thermal source 1700, and/or other treatment source 1800) by their respective connectors (pressure connector 1260, thermal connector 1360, and/or other treatment connector 1460). At 2100, treatment delivery component 1020 can be secured to treatment portion TP of user body UB, for example by fastening fastener portion 1120 of outer shell 1100. For example, if the treatment portion TP is a leg of a user, treatment delivery component 1020 be secured around the leg with fastener portion 1120. At 2120, pressure applicator 1210, thermal applicator 1310, and/or other treatment applicator 1410 can be adapted to the size of the treatment portion TP of user body UB. For example, if the treatment portion TP is a leg of a user, the selected applicators can be adjusted to fit the circumference of the leg (e.g., to engage in appropriate apposition, with no slack, folds, etc.) as described above, and in more detail below. At 2140, treatment parameter input(s) can be received by treatment system 1000 via user interface 1950. For example, the user may provide inputs (or a third party, such as those identified above, may provide the inputs on behalf of the user) to user interface 1950 to select a desired treatment regime, e.g., select from among available options for pressure treatment programs, thermal treatment programs, and/or other treatment programs. At 2160, the selected treatment modalities (with selected treatment regimens/programs) can be delivered to treatment portion TP of user body UB by treatment system 1000. After completion of delivery of the selected treatment modalities, treatment delivery component 1020 can be released from, and then removed from treatment portion of user body UB.

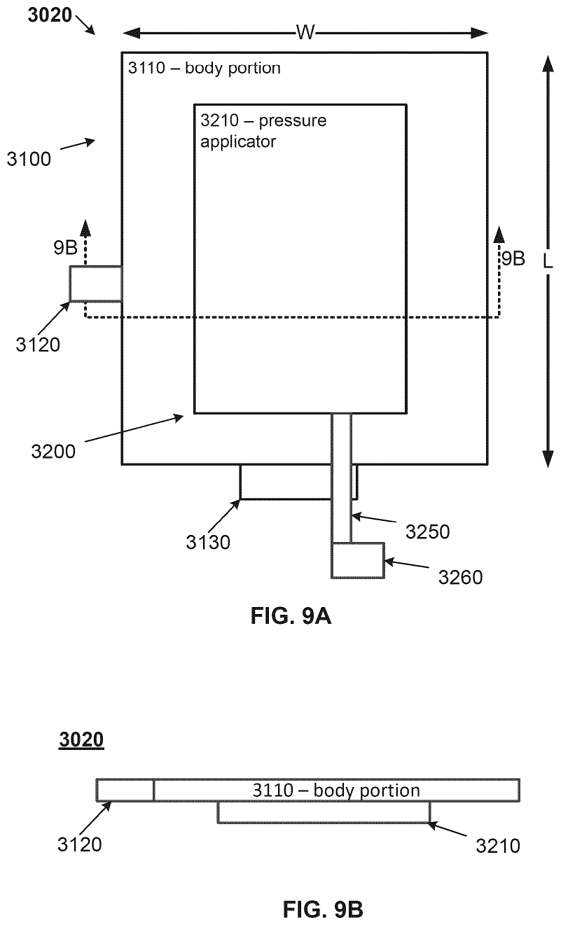

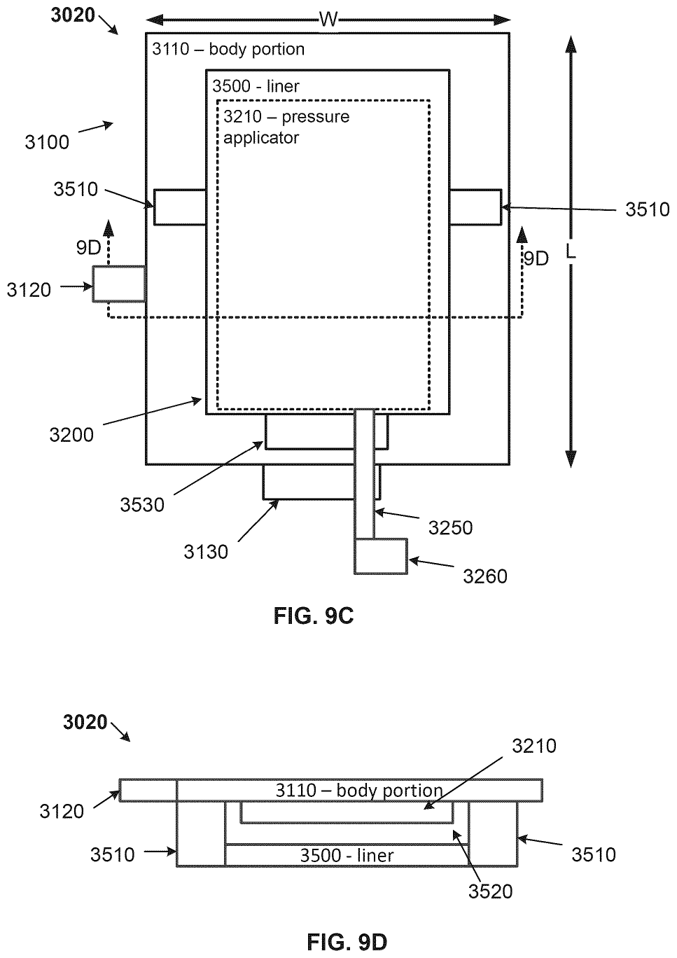

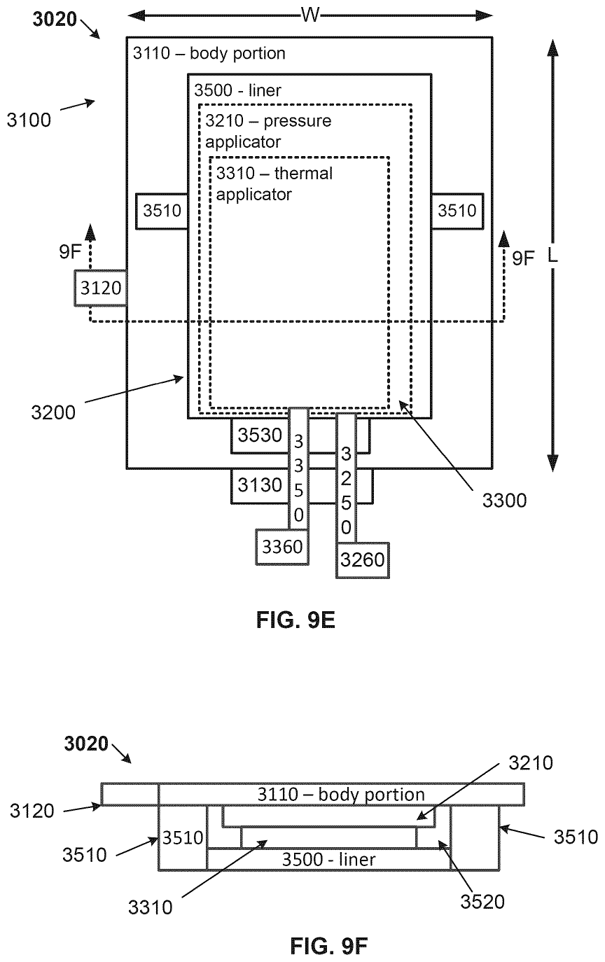

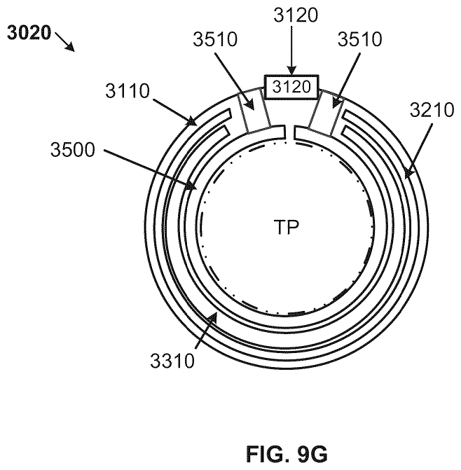

As discussed above, in some embodiments, each, any, or all of the other subsystems of treatment delivery component 1020 may be separate from outer shell 1100 and from each other, i.e., may be disposed in operative relationship with each other without coupling to each other, such as by stacking, nesting, etc. In other embodiments, each, any, or all of the other subsystems of treatment delivery component 1020 may be releasably couplable to outer shell 1100 and/or to each other. In still other embodiments, each, any, or all of the other subsystems of treatment delivery component 1020 may be fixedly coupled to outer shell 1100 and/or to each other. Some of these options are illustrated schematically for a treatment delivery component 3020 in FIGS. 9A to 9G. Treatment delivery component 3020 is shown in FIG. 9A in a plan view, and in FIG. 9B in a cross-section along line 9B-9B of FIG. 9A. In these figures, body portion 3110 of outer shell 3100 is shown, in an open configuration, e.g., laid out flat, with fastener portion 3120 unfastened. In these figures, pressure delivery component 3200 is shown with pressure applicator 3210 disposed on an inner surface (i.e., the surface that will face treatment portion TP of user body UB when treatment delivery component 3020 is in use) of body portion 3110, with pressure conduit 3250 extending from pressure applicator 3210, through passage 3130 of outer shell 3100, to pressure connector 3260. As described above, pressure applicator 3210 may be secured to body portion 3110 by any suitable technique, either fixedly or releasably, or may be disposed in operative relationship but not secured.

Treatment delivery component 3020 is further shown in FIG. 9C in a plan view, and in FIG. 9D in a cross-section along line 9D-9D of FIG. 9C. In these figures, liner 3500 is shown, added to the arrangement shown in FIGS. 9A and 9B. Liner 3500 is shown disposed on top of (i.e., closer to treatment portion TP when in use) pressure applicator 3210 and body portion 3110, and releasably secured to body portion 3110 by liner couplers 3510. Pressure conduit 3250 is shown extending through a liner opening 3530 of liner 3500—liner opening 3530 may be an aperture in liner 3500, or may be a space or gap between liner 3500 and body portion 3110. As shown in FIG. 9D, liner 3500 may be coupled to body portion 3110 to define a liner pocket 3520, e.g., a space, gap, or open volume between liner 3500, body portion 3110, and treatment applicator 3210. Liner 3500 may be coupled to body portion 3110 at discrete, discontinuous locations, i.e., liner couplers 3510 may be in the form of buttons, snaps, short segments of hook and loop fastener, etc. Alternatively, liner couplers 3510 may be continuous, e.g., zippers or elongated sections of hook and loop fastener, and may extend along the entire length and/or width of liner 3500. Correspondingly, liner pocket 3520 may be completely enclosed, e.g., by continuous fastening of liner 3500 around its entire periphery, in which configuration thermal applicator 3310 would be disposed on the surface of pressure applicator 3210 before liner 3500 is coupled thereto. In other embodiments, liner pocket 3520 may be open along one of its edges, e.g., a top edge, a bottom edge, or a side edge, such that thermal applicator 3310 can be slidably inserted through the open edge into liner pocket 3520.

Treatment delivery component 3020 is further shown in FIG. 9E in a plan view, and in FIG. 9F in a cross-section along line 9F-9F of FIG. 9E. In these figures, thermal delivery component 3300 is shown, added to the arrangement shown in FIGS. 9C and 9D. Thermal delivery component 3300 is shown with thermal applicator 3310 disposed between pressure applicator 3210 and liner 3500, in liner pocket 3520, and with thermal conduit 3350 extending through liner opening 3530 and passage 3130 to thermal connector 3360. As described above, thermal applicator 3310 may be secured to any or all of the other components of treatment delivery component 3020 by any suitable technique, either fixedly or releasably, or may be disposed in operative relationship but not secured. For example, in this embodiment, thermal applicator 3310 may be captured or restrained in liner pocket 3520 (i.e., with limited, or no, range of movement laterally (in the width direction W) or longitudinally (in the length direction L), without the use of any mechanical fastener or other coupler to liner 3500, pressure applicator 3210, or body portion 3110. Thermal applicator 3310 may be retained in operative position through frictional engagement with liner 3500 and/or with the surface of pressure applicator 3210. Thermal applicator may be entirely covered by liner 3500, e.g., entirely contained within liner pocket 3520, or may have a portion extending out of liner pocket 3520.

As described above with reference to FIG. 8, in a method of treatment using a treatment delivery component, a user may configure the treatment delivery component 3020 for delivery of desired treatment modalities. Treatment delivery component 3020 can be configured for delivery of treatment in several ways. For example, a user may first dispose treatment delivery component 3020 in the arrangement shown in FIGS. 9A and 9B and, if pressure applicator 3210 is not already (e.g., fixedly) coupled to body portion 3110, the user may couple these components together and dispose pressure conduit 3250 through passage 3130. The user may then secure liner 3500 to body portion 3110 by liner connectors 3510 and dispose pressure conduit 3250 through liner opening 3530, resulting in the configuration shown in FIGS. 9C and 9D. The user may then dispose thermal delivery component 3300 in the arrangement shown in FIGS. 9E and 9F, such as by introducing pressure connector 3360 and pressure conduit 3350 into liner pocket 3520 from the upper (top in FIG. 9E) end of liner pocket 3520, then feeding pressure connector 3360 and pressure conduit 3350 through liner pocket 3520 and through liner opening 3530 and passage 3130, while introducing thermal applicator 3310 into the upper end of liner pocket 3520 and finally moving thermal delivery component 3300 into the position shown in FIG. 9E. Alternatively, a user may configure treatment delivery component 3020 by the same process described above, but by disposing thermal delivery component 3300 in the position shown in FIG. 9E, and then securing liner 3500 to body portion 3110 by liner connectors 3510, overlying thermal applicator 3310.

Many other variations are also contemplated for configuration of treatment delivery component 3020. For example, thermal applicator 3310 may be releasably secured to pressure applicator 3210 (such as by hook and loop fasteners), and liner 3500 may subsequently be secured to body portion 3110, overlying thermal applicator 3310. Thermal applicator 3310 may be maintained in position laterally and/or longitudinally by the releasable coupling to pressure applicator 3210, and simply covered by liner 3500 (rather than relying on liner 3500 to define boundaries for liner pocket 3520 that retain pressure applicator 3310 in position).

After treatment delivery component 3020 has been configured, it may be secured to treatment portion TP of user body UB, as described above with reference to FIG. 8 at 2100. Treatment delivery component 3020 is shown secured to treatment portion TP in FIG. 9G, in a closed configuration. As shown in FIG. 9G, treatment delivery component 3020 is disposed with liner 3500 adjacent the surface of treatment portion TP (e.g., in contact with the user's skin, or overlying clothing disposed on treatment portion TP). Body portion 3110 is coupled in place around treatment portion TP by connecting its lateral edges (in the width direction W shown in FIG. 9E) with fastener portion 3120. The remainder of treatment method 2000 described above with reference to FIG. 8 may then be performed.

Although shown in FIGS. 9A to 9G as including a thermal delivery component 3300, treatment delivery component 3020 may include an other delivery component instead of, or in addition to, thermal delivery component 3300, as described above with reference to treatment delivery component 1020 and treatment system 1000. And although shown as including a pressure delivery component 3200, treatment delivery component 3020 may not have a pressure delivery component, and may instead have only thermal delivery component 3300, or an other delivery component, as also describe above with reference to treatment delivery component 1020 and treatment system 1000.

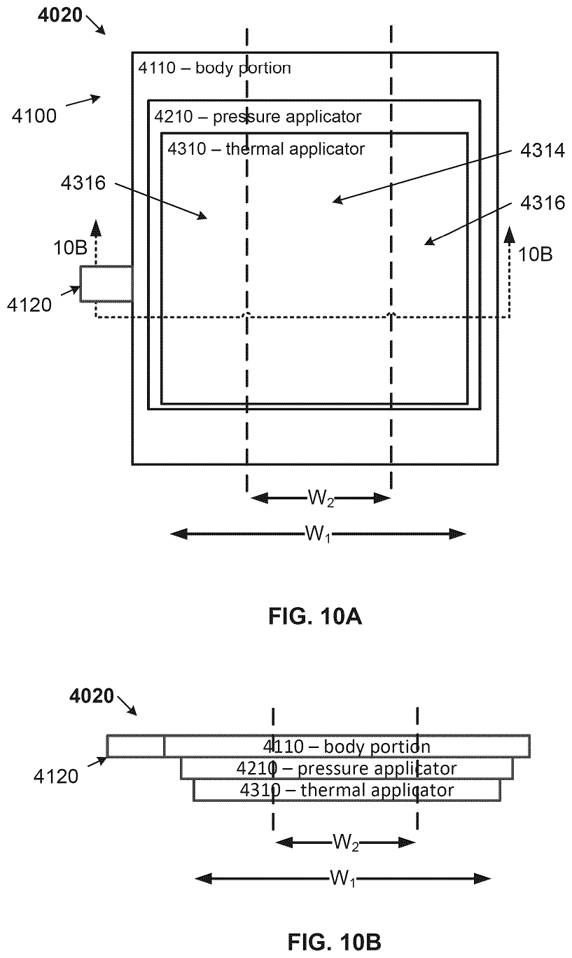

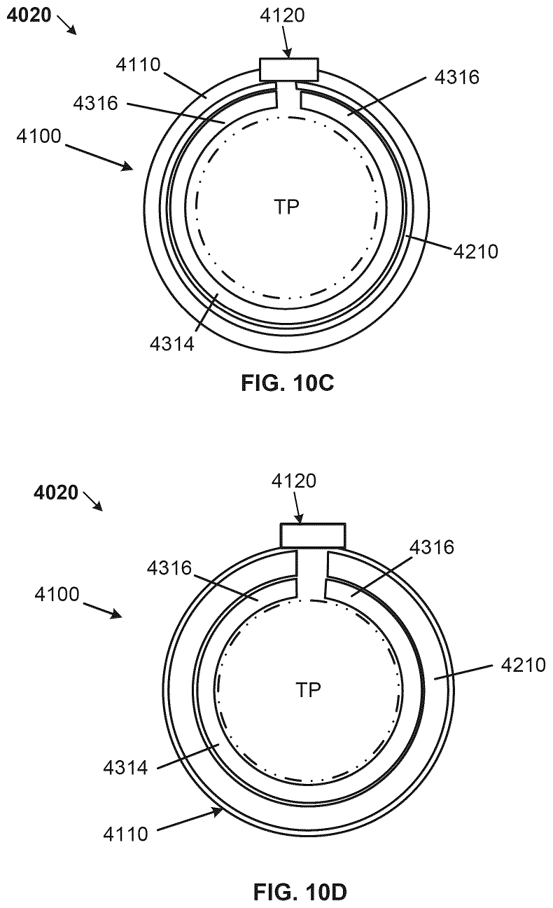

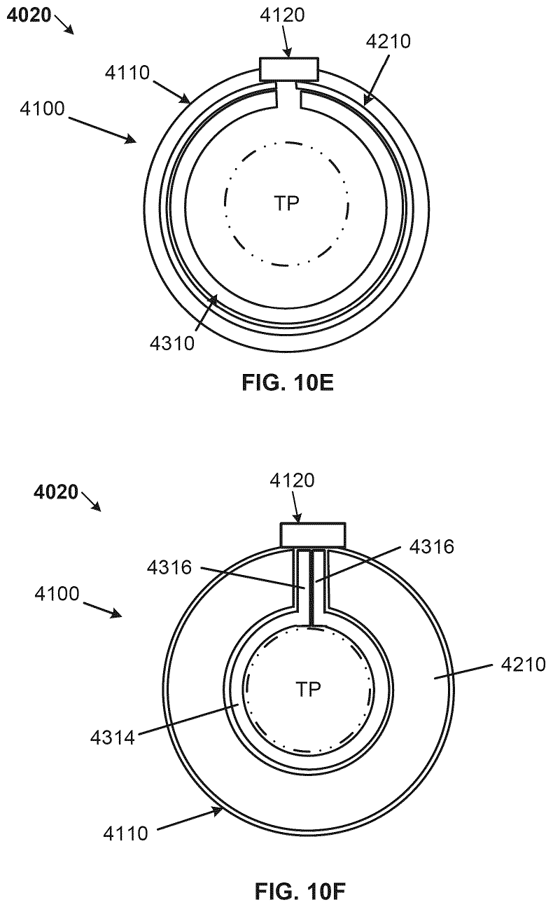

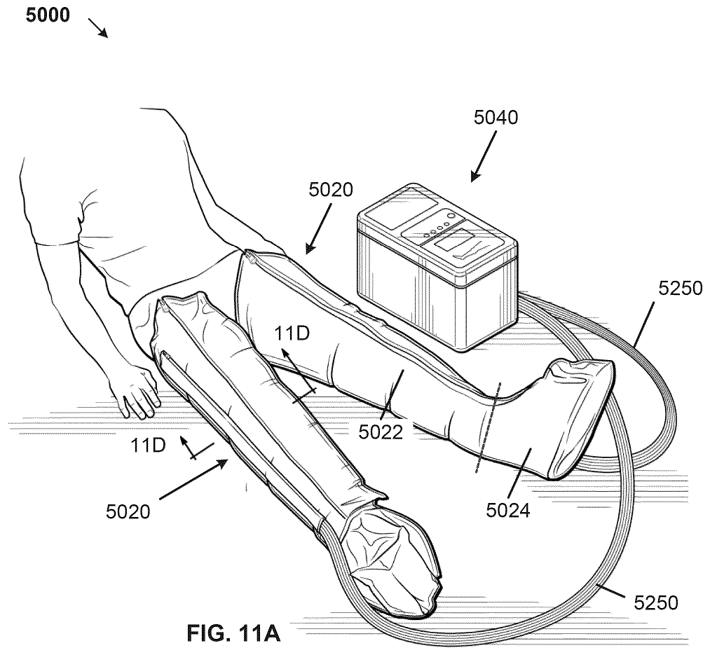

As described above with reference to treatment system 1000, pressure delivery component 1200 may be operated to provide either or both of two functions: a) it may be operated to selectively deliver pressure treatment or therapy to the treatment portion TP of user body UB; and/or b) it may be operated to interface with an outer shell 1100 and one or both of thermal delivery component 1300 and other treatment delivery component 1400 to enhance the effectiveness of those components. As shown and described above, the effectiveness of thermal delivery component 1300 and/or other treatment delivery component 1400 can be enhanced by applying pressure from pressure delivery component 1200 to establish and maintain good apposition of thermal applicator 1310 and/or other treatment applicator 1410 with the surface of treatment portion TP of user body UB (e.g., the user's skin). Another way in which pressure delivery component 1200 can enhance the effectiveness of thermal delivery component 1300 and/or other treatment delivery component 1400, and of treatment delivery system 1000 overall, is to adapt the treatment applicators to the dimensions of the treatment portion TP of user body UB for different users of different sizes, and/or for different treatment portions of the same user. In this way, a single size of treatment delivery component 1020 can be used to deliver treatment to, for example, the leg of a small female user and the leg of a large male user. This capability can be commercially desirable because only one size or model of treatment delivery component is required to be manufactured, distributed, stored, maintained, etc. to be used with control units 1040 for treatment of a wide range of users. This size adapting capability can also be provided at least in part by one or more components separate from pressure delivery component 1200, e.g., components that do not play a role in the delivery of pressure therapy, as described in more detail below in connection with some embodiments. This size adapting functionality is illustrated schematically for one embodiment in FIGS. 10A to 1° F. for a treatment delivery component 4020.

Treatment delivery component 4020 is shown in FIGS. 10A to 10F, for ease of illustration, only with body portion 4110 and fastener portion of outer shell 4100, with pressure applicator 4210, and with thermal applicator 4310. However, treatment delivery component 4020 can include all of the elements described above for treatment delivery components 1020 and 3020.

As shown in FIGS. 10A and 10B, thermal applicator has a central portion 4314 and side portions 4316, which for ease of reference are shown as separated by the dashed lines in FIGS. 10A and 10B. The width of central portion 4314 is indicated by W 2, and the overall width of thermal applicator 4310 (including central portion 4314 and both side portions 4316) is indicated by Wi. Width Wi can correspond to the circumference (or other lateral extent, e.g., for a treatment portion that is not enclosable by the treatment delivery component) of the largest treatment portion TP to which thermal applicator 4310 can be applied and provide thermal treatment to the entire circumferential (or other) extent of treatment portion TP. W₂ can correspond to the circumference (or other extent) of the smallest treatment portion TP to which thermal applicator 4310 can be applied while being capable of providing effective thermal treatment to treatment portion TP. FIGS. 10C and 10D schematically illustrate treatment delivery component 4020 secured to a treatment portion TP having a circumference corresponding to Wi (the gap between the edges of thermal applicator 4310 is shown for easy of illustration). Pressure applicator 4210 is shown in an unpressurized configuration and a pressurized configuration, respectively, in FIGS. 10C and 10D.

Treatment delivery component 4020 is schematically illustrated in FIGS. 10E and 10F secured to a treatment portion TP having a circumference corresponding to W₂. Although not shown in FIGS. 10E and 10F, the edges of thermal applicator 4310 are maintained in an approximately fixed, and relatively closely spaced, relationship with the edges of body portion 4110. Thus, as shown in FIG. 10E, when pressure applicator 4210 is in an unpressurized configuration, thermal applicator 4310 is substantially spaced from the surface of (relatively small) treatment portion TP, and thus not in good thermal apposition to permit effective delivery of thermal treatment. However, when pressure applicator 4210 is in a pressurized configuration, as shown in FIG. 10F, pressure applicator 4210 urges thermal applicator into a configuration in which central portion 4314 is in good apposition with the full circumference of treatment portion TP, while side portions 4316 are approximated or urged together (or towards each other, if there is other structure, such as liner 4500, between them), and extend radially approximately from the outer surface of treatment portion TP to their connections to the edges of body portion 4110. Thus, side portions 4316 face each other, i.e., the inner surfaces of side portions 4316 (which would otherwise be engaged with, or facing, treatment portion TP) are adjacent or in contact, and do not overlap each other (i.e. the inside surface of one side portion 4316 does not face the outside surface of the other side portion 4316). The side portions 4316 may be considered to be “wasted,” in that they are not in apposition with the surface of treatment portion TP, and thus cannot deliver thermal treatment thereto. However, central portion 4314 is in good apposition with treatment portion TP and can deliver thermal treatment thereto. This “wasting” effect is a desirable capability of treatment delivery component 4020, enabling it to be secured to and effectively treat a wide range of sizes of treatment portions TP. The division of thermal applicator 4310 into central portion 4314 and side portions 4316 is arbitrary, in that central portion 4314 can just be considered to be the portion that can be disposed in good apposition with the surface of whatever size treatment portion TP thermal applicator 4310 has been secured to, and side portions 4316 can just be considered to be the portions of thermal application 4310 that are “wasted” by being urged together, and not in contact with treatment portion TP. Although the benefits of wasting thermal applicator 4310, having the inner surfaces of side portions 4316 face each other, is described here in the context of thermal treatment, the approach and benefits are also applicable to other treatment modalities, and thus can be used for an other treatment applicator, including an electrical treatment applicator. Such other treatment applicator may also have a center portions and side portions, and the inner surfaces of the side portions approximated, as described above for the thermal applicator 4310.

The arrangement of the elements of treatment delivery component 4020 described above have several advantages and benefits. Some known approaches to adapting thermal or pressure treatment devices to different sizes of users or their treatment portions involve wrapping the devices around the treatment portions, so that a portion of the inner surface (the surface intended to face the treatment portion in use) of the device(s) overlaps the outer surface of the device(s), as in a partial spiral. Such devices may be secured in this overlapping arrangement or configuration by releasable coupling mechanisms such as hook and loop fasteners. Such systems rely on the user to wrap the system on the treatment portion to a suitable degree of tightness (not too tight, not too loose). In contrast, in embodiments disclosed herein, the treatment delivery component 4020, the pressure, thermal, or other treatment delivery components are not overlapped when applied to a smaller user or treatment portion TP. Rather, treatment delivery component 4020 is secured around treatment portion TP in an edge-to-edge arrangement, such as by having body portion 4110 of outer shell 4100 secured at its edges by fastener portion 4120. With this arrangement, neither pressure applicator 4210 nor thermal applicator 4310 overlaps with itself when disposed around a relatively smaller treatment portion TP. Rather, as shown in FIG. 10F, the inner surface of thermal applicator 4310 is either in apposition with treatment portion TP (for central portion 4314) or faces itself (for side portions 4316). Also, advantageously, the user is not relied upon to properly fit treatment delivery component 4020 to treatment portion TP as with previous known approaches. Rather, the user need only dispose treatment portion TP in treatment delivery component 4020 and fasten body portion 4110 of outer shell 4100 by fastener portion 4120, and the expansion of pressure elements 4212 automatically adapts treatment delivery component 4020 to the size of treatment portion TP.

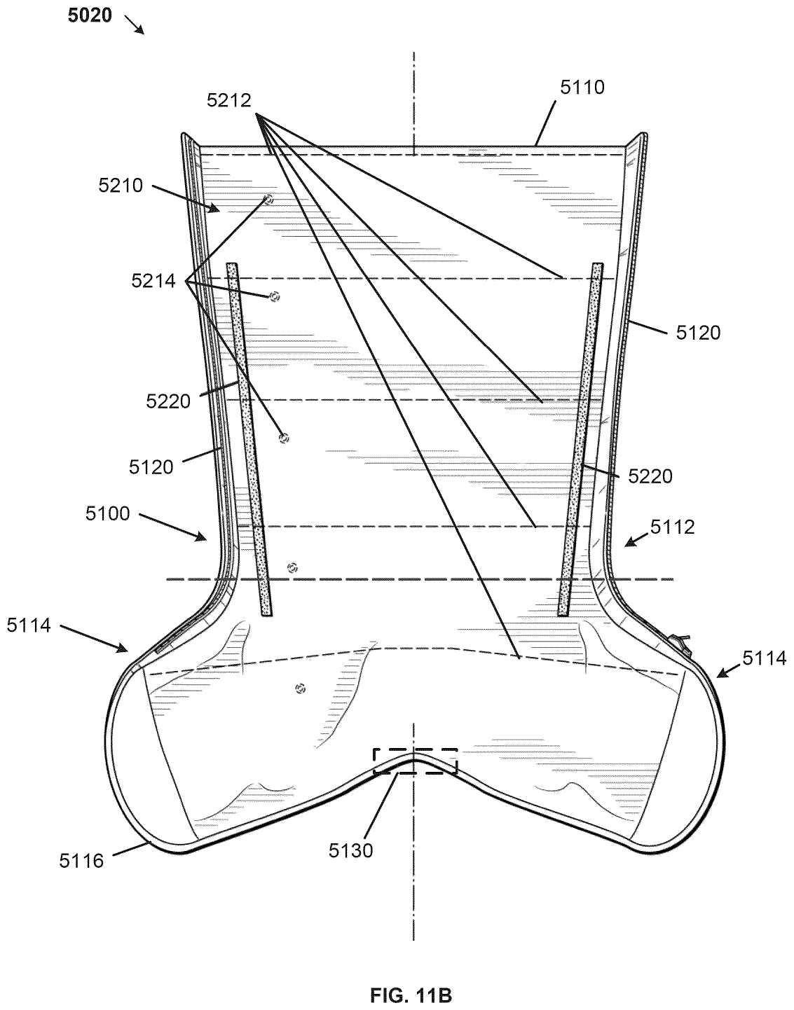

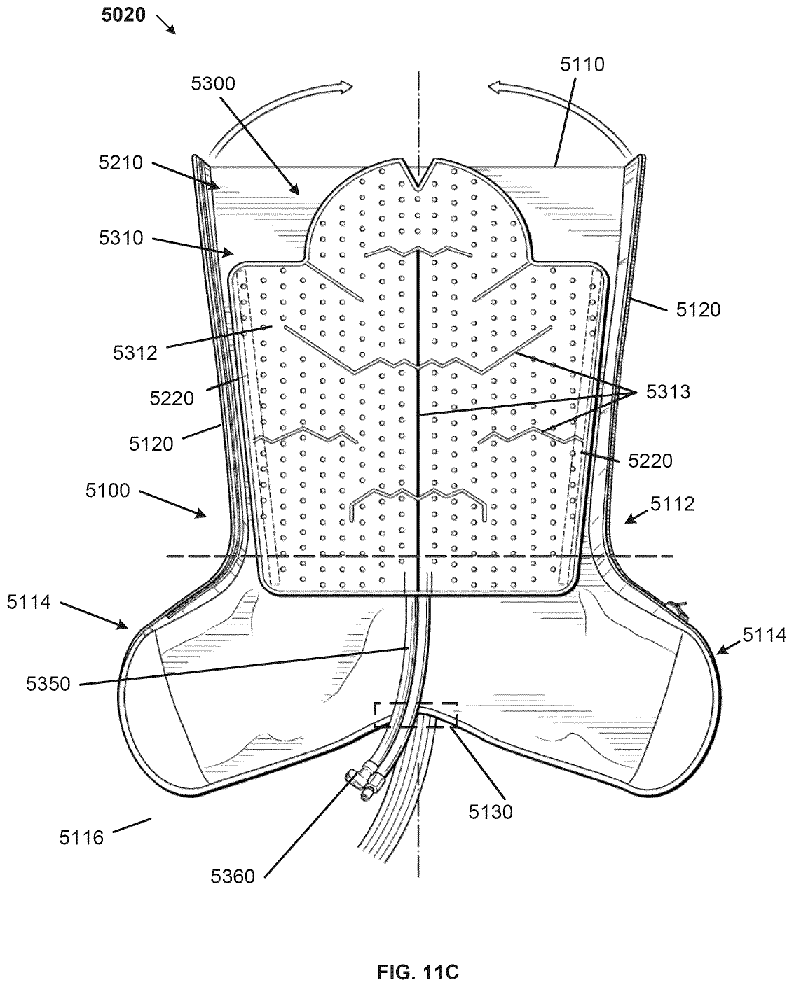

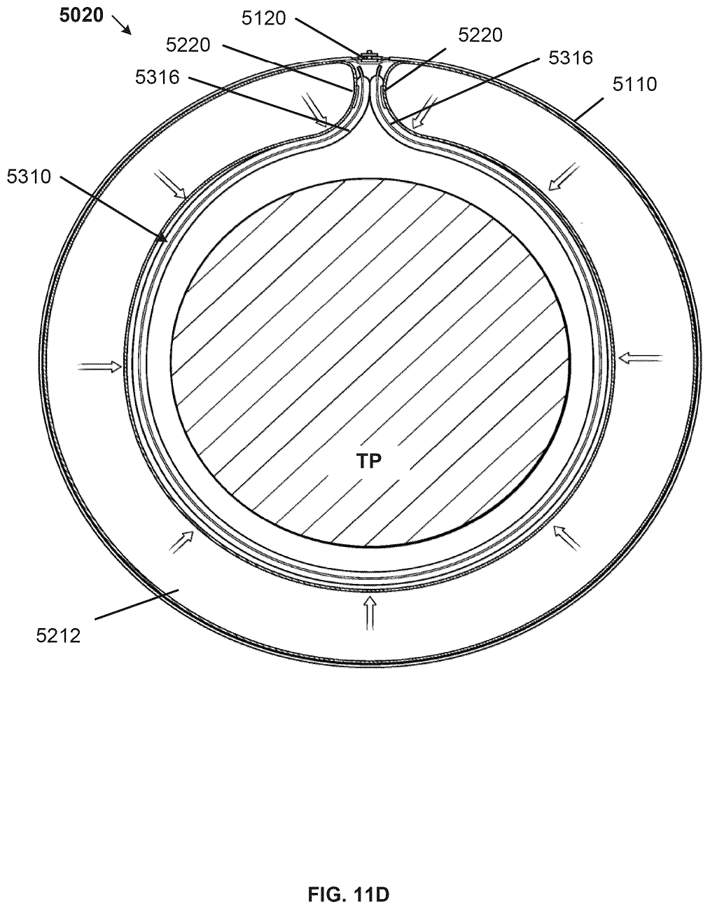

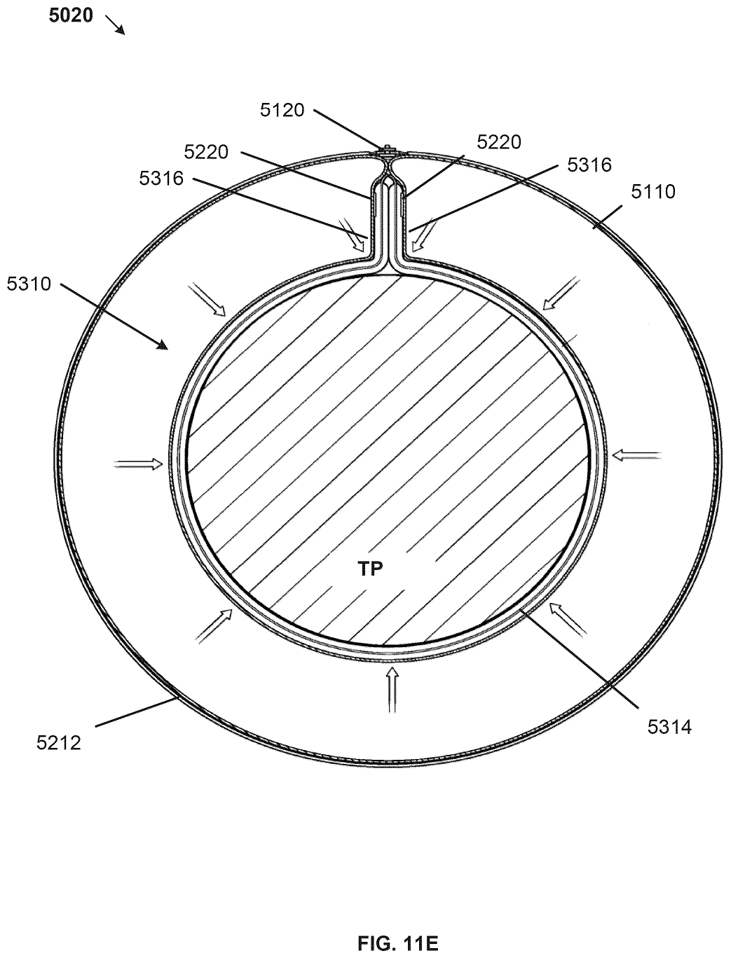

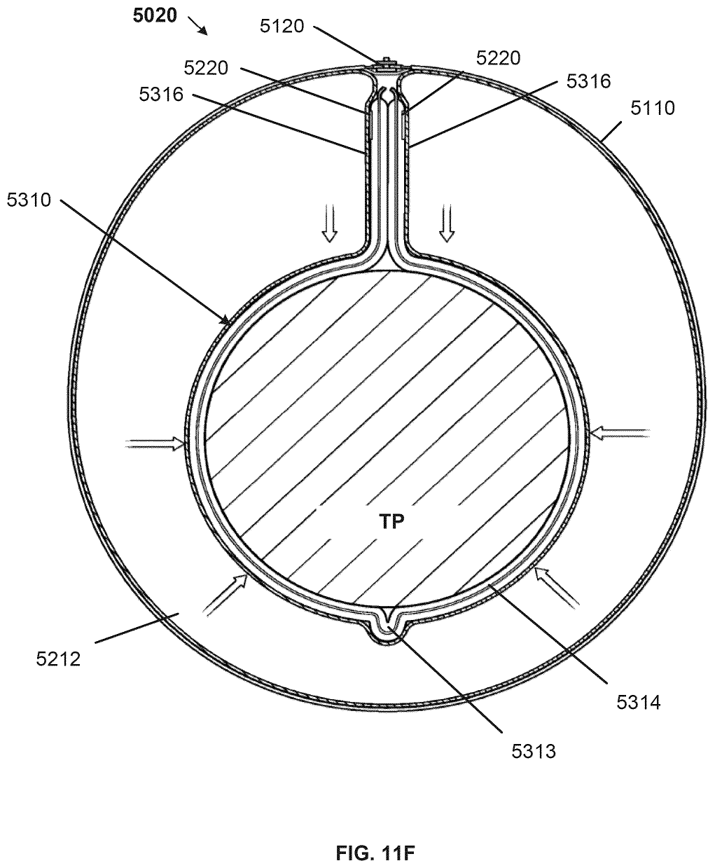

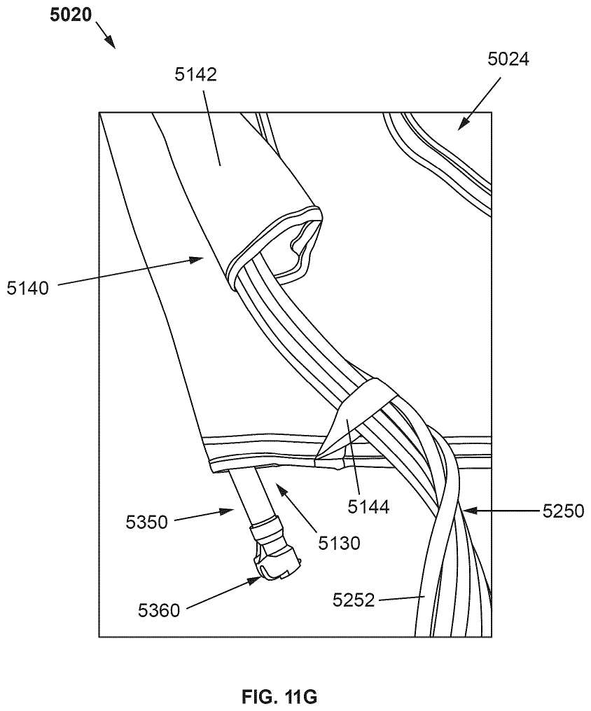

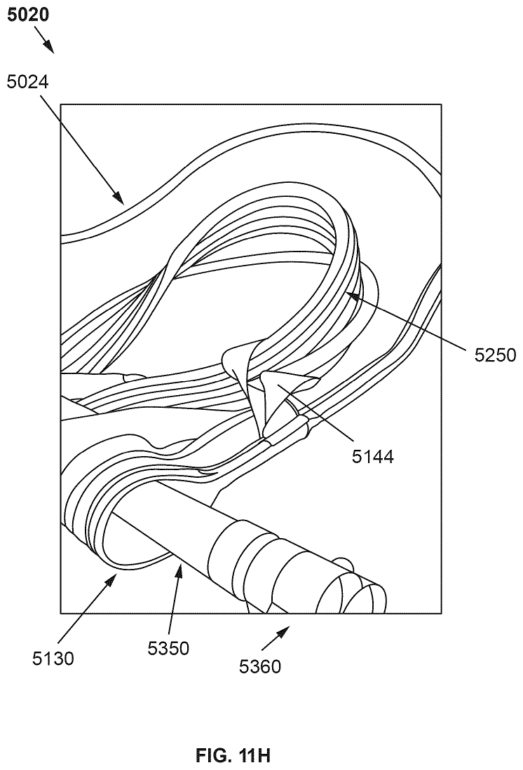

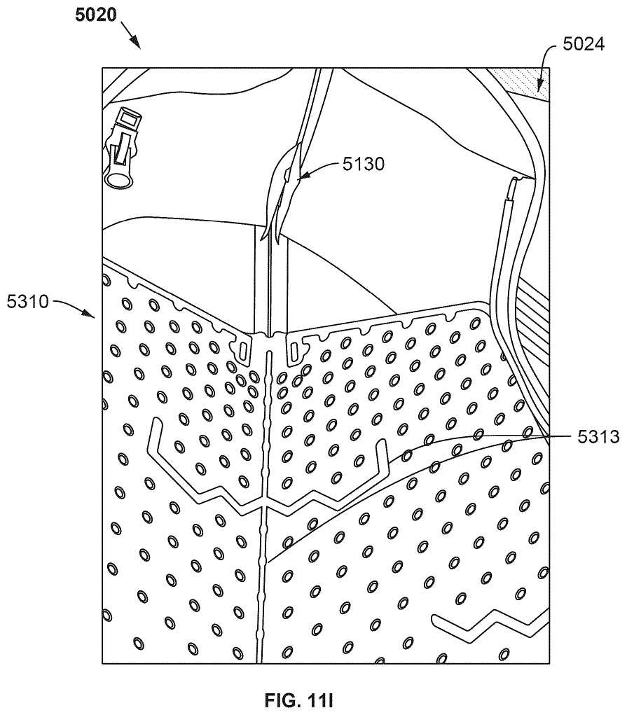

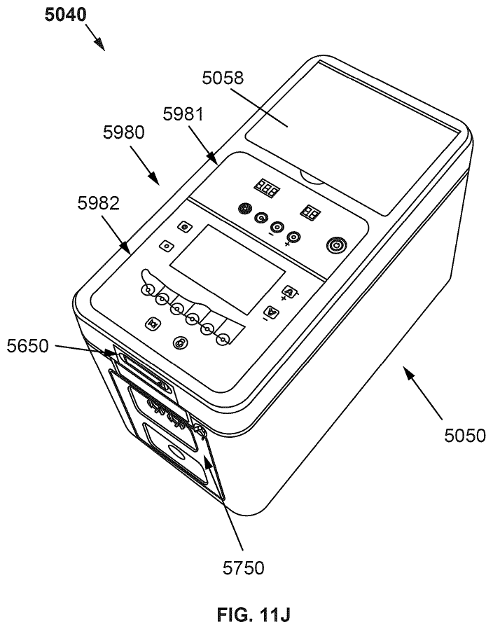

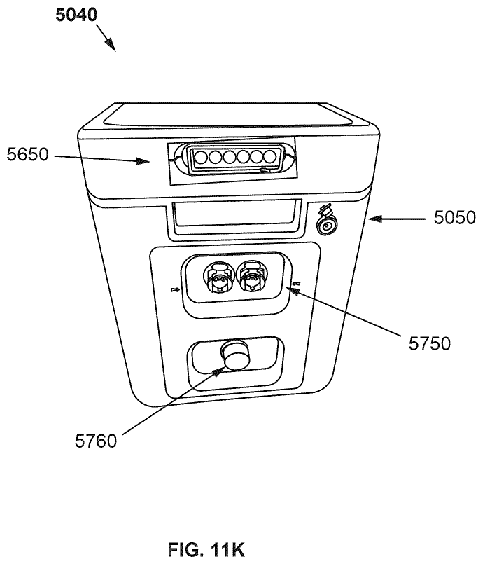

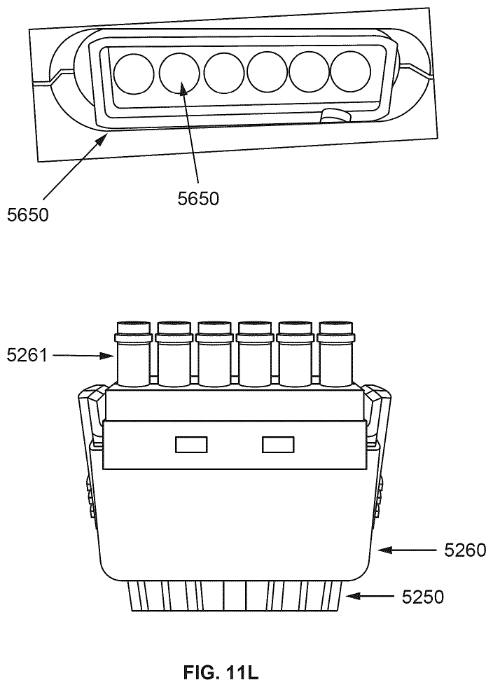

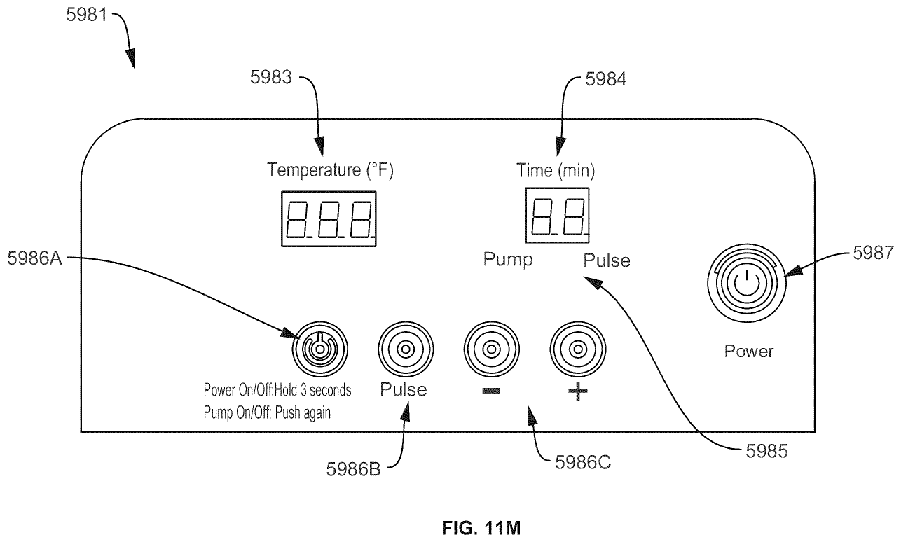

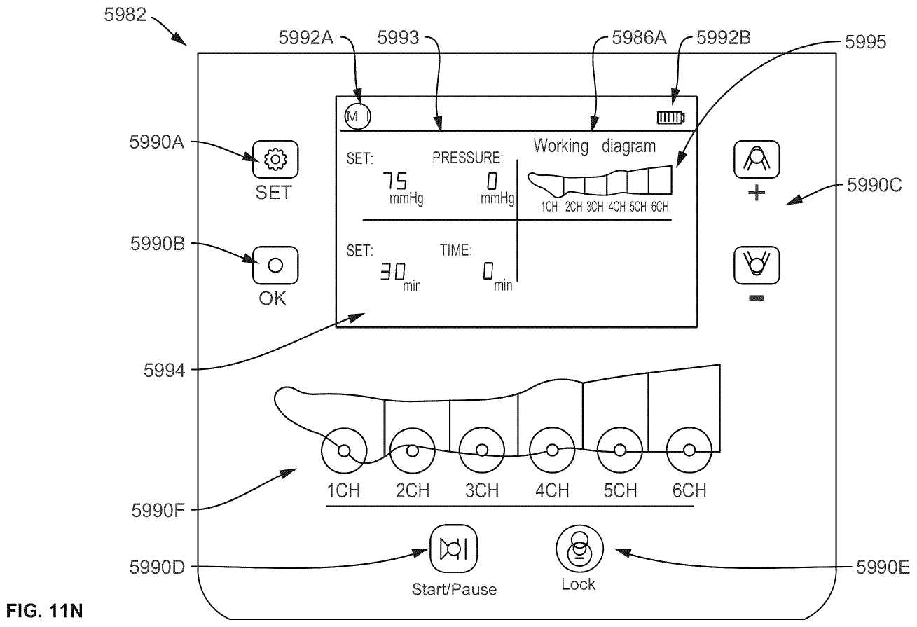

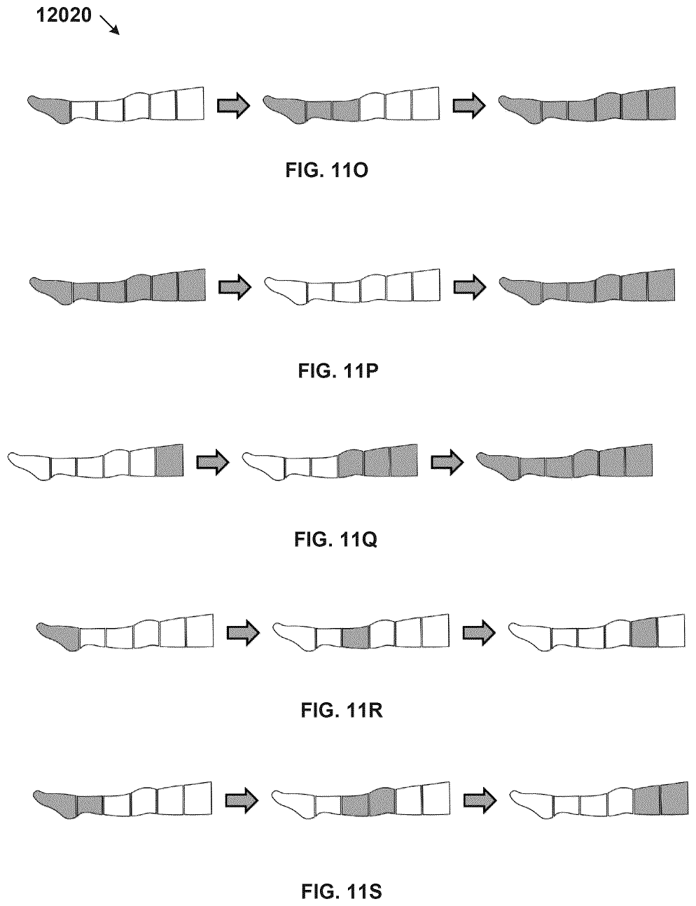

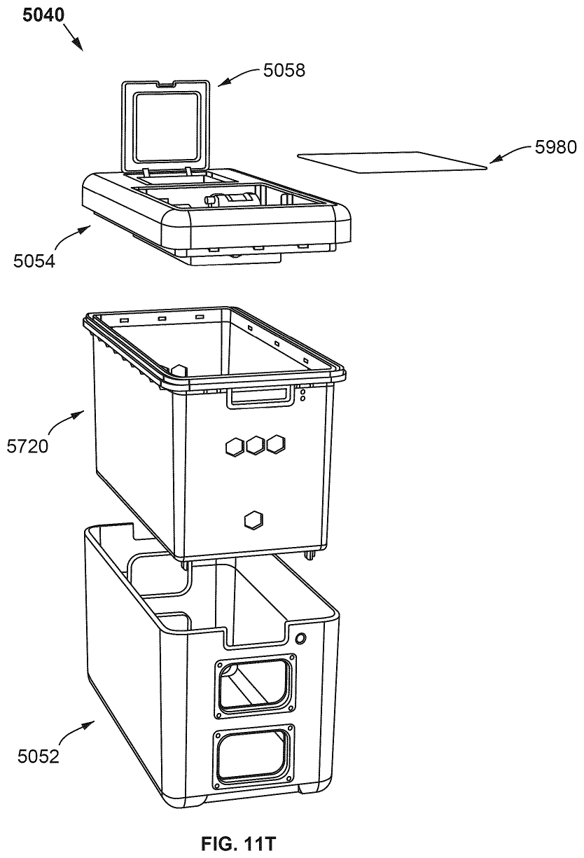

An embodiment of a treatment system is shown in FIGS. 11A to 11T. As shown in FIG. 11A, treatment system 5000 includes a control unit 5040 and two treatment delivery components 5020. Although shown with two treatment delivery components, system 5000 could include a single treatment delivery component. In this embodiment each treatment delivery component 5020 is configured to treat a lower limb (leg) of a user, and includes a leg portion 5022 that is configured to be disposed around the leg (thigh, knee, and calf), and a foot portion 5024 that is configured to be disposed around the foot (ankle and foot) of the user. The boundary between the leg portion 5022 and the foot portion 5024 is shown with a dashed line in FIG. 11A, but is shown only for ease of reference, and is not a precise boundary. Also shown in FIG. 11A is a pressure conduit 5250 for the pressure delivery component of each treatment delivery component 5020, as described in more detail below. Although this embodiment is configured to treat a lower limb of a user, other than the specific shape of treatment delivery component 5020 and arrangement of specific elements of treatment delivery component 5020, and some specific displays and controls for control until 5040, all of the features and functions described with reference to this embodiment would be applicable to treatment delivery components and control units configured to be used to treat other treatment portions TP, as are described above.

One of the treatment delivery components 5020 is shown in more detail in FIGS. 11B and 11C. FIG. 11B shows outer shell 5100 and pressure applicator 5210. In this embodiment, these two components are fixedly connected to each other. For example, a multi-layer construction, such as two layers of a material, each having fabric on the outside and plastic (airtight) on the inside may be inside (airtight), may be fused together to define the pressure applicator's pressure elements 5212 between the insides of each layer. In other embodiments, the pressure elements may be formed as discrete bladders, e.g., formed of elastomeric material, and the bladders may be disposed within pockets or sleeves formed of fabric material.

Outer shell 5100 includes a body portion 5110, which includes a leg portion 5112 and foot portion 5114 (corresponding to leg portion 5022 and foot portion 5024 of treatment delivery component 5020), again shown with a dashed line representing the boundary between the two portions only for ease of illustration. Outer shell 5100 also includes fastener portion 5120, which in this embodiment is implemented as a zipper, with cooperating portions on each edge of body portion 5110, extending along the entirety of leg portion 5112 and onto the upper part of foot portion 5114. Body portion 5110 is shown in FIGS. 11B and 11C as being in an open configuration, but for ease of illustration is shown fully opened, and flat. However, foot portion 5114 is fixed together around its perimeter along seam 5116 (e.g., by stitching, as can be seen in FIG. 11G) up to the lower end of the zipper of fastener portion 5112, and is thus configured to receive the foot of the user by having the foot slid into it, rather than receiving the foot and then being closed around the foot, as with the leg portion and the user's leg. The edges of the foot portion are not joined together at the center of the foot portion, i.e., where the heel of the user's foot would be disposed, leaving a gap that defines a passage 5130.

In this embodiment, pressure delivery component 5200 includes a pressure applicator 5210 with six pressure elements 5212 (five are shown here), each implemented as an expandable bladder. Each pressure element 5212 includes a pressure port 5214 through which pressurized fluid can be introduced into pressure element 5212 to change it from a collapsed configuration to an expanded configuration, and to increase its pressure, and from which pressurized fluid can be released or withdrawn to reduce its pressure and to change it from an expanded configuration to a collapsed configuration. In this embodiment, the pressurized fluid is a gas, e.g., air. Although not shown in FIG. 11B, each pressure port 5214 can be fluidically coupled to a respective fluid passage 5252 of pressure conduit 5250, and thus to pressure source 1600.

In this embodiment, pressure applicator 5210 includes optional thermal applicator couplers 5220, by which thermal applicator 5310 can be releasably coupled to pressure applicator 5210. In this embodiment, thermal applicator couplers 5220 are implemented as one half of a hook and loop fastener arrangement, with the mating (hook or loop) portion of the fastener arrangement disposed on one side of thermal applicator 5310 (as shown in FIG. 11C).

As shown in FIG. 11C, treatment delivery component 5020 includes a thermal delivery component 5300, with a thermal applicator 5310, a thermal conduit 5350, and a thermal connector 5360. In this embodiment, thermal applicator 5310 is implemented with a thermal element 5312 that is a flexible pad formed by fusing or otherwise securing two layers of polymer or other material together around their perimeter (defining the edges of thermal element 5312 and enclosing its overall volume) with elongate fused portions defining flow diverters 5313 that can direct the flow of fluid though thermal element 5312. The two layers can also be fused together at numerous small diameter spots to keep the pad relatively thin, rather than ballooning up when fluid is forced into and through it, and to more uniformly distribute the flow of thermal fluid through the interior of pressure element 5312. Thermal fluid can be introduced into, and withdrawn from, the interior of thermal element 5312 via thermal conduit 5350, which in this embodiment includes two fluid passages—one to introduce the thermal fluid and one to withdraw the thermal fluid. The two fluid passages couple to the interior of thermal element 5312 on opposite side of a central flow diverter 5313, so that fluid will circulate through the entire interior volume of the thermal element 5312. Thermal conduit 5350 terminates at thermal connector 5360. FIG. 11C shows thermal applicator 5310 disposed on, and releasably secured to, pressure applicator 5210, coupled by thermal applicator couplers 5220. In some embodiments, the side of thermal applicator couplers 5220 on thermal applicator 5310 may cover all or a large portion of the surface of thermal applicator 5310, such as by fixing a large area of hook or loop, that can be releasably secured to a relative narrow, elongate area of the mating loop or hook material fixed to the pressure applicator 5210. Thermal conduit 5350 is shown disposed in passage 5130 through foot portion 5114 of body portion 5110 of outer shell 5100. The arrows in FIG. 11E indicate that the edges of body portion can be approximated to enclose a user's leg, and releasably secured by fastener portion 5120.

Treatment delivery component 5020 is shown in cross-section (along line 11D-11D in FIG. 11A) in FIGS. 11D and 11E, secured to the treatment portion TP (leg) of the user. As shown in FIGS. 11D and 11E, body portion 5110 of outer shell 5100 is connected at its edges by fastener portion 1120 (zipper), and pressure element 5212 (bladder) of pressure applicator 5210 is secured to body portion 5110. Thermal applicator 5310 is secured (at its side portions 5316) to pressure applicator 5210 by thermal applicator couplers 5220 (hook-and-loop fasteners). In the configuration shown in FIG. 11D, pressure element 5212 is partially expanded, and has urged thermal applicator towards treatment portion TP (as indicated by the arrows), but there remains a gap or space between thermal applicator 5310 and treatment portion TP. In the configuration shown in FIG. 11E, pressure element 5212 is further expanded, and has pressed or urged central portion 5314 of thermal applicator 5310 into apposition with treatment portion TP (as indicated by the arrows), and has pressed side portions 1316 of thermal applicator 5310 together, “wasting” those portions of thermal applicator 5310. Thus, treatment delivery component 5020 has been adapted to the size of treatment portion TP (the user's leg) and is ready for delivery of thermal treatment by thermal applicator 5310, and/or pressure treatment by pressure element 5212 (and the other pressure elements 5212 of pressure applicator 5210), such as by further increasing the pressure of the gas within pressure element 5212 above the pressure required to establish apposition of thermal applicator 5310 with treatment portion TP.

FIG. 11F illustrates treatment delivery component 5020 in the same cross section as shown in FIGS. 11D and 11E, but disposed on a treatment portion TP (leg of user) having a smaller circumference than the treatment portion TP shown in FIGS. 11D and 11E. This view illustrates the size adapting functionality provided by pressure applicator 5210 (and pressure element 5212). Also shown in FIG. 11F is that pressure element 11F can be configured to expand to a greater degree upon pressurization on the upper side (as viewed in FIG. 11F) than the lower side of treatment delivery element 5020. Also shown in FIG. 11F is that the central, elongate fused portion or flow diverter 5313 of thermal applicator 5310 locally reduces the bending stiffness of thermal applicator 5310, so that thermal applicator 5310 preferentially folds or creases along the line of fused portion of flow diverter 5313 when the pressure element 5212 is expanded. This can fine tune the compliance of the thermal applicator 5310 to treatment portion TP, and avoid undesirable buckling or folding of thermal applicator 5310 that could interfere with complete apposition, and reduce the effectiveness of the thermal treatment delivery. More than one lengthwise-oriented fused portion can be formed to create more preferential fold lines. This approach can complement the “wasting” technique to maximize apposition and minimize buckling or folding.

Although the foregoing figures do not illustrate a liner, treatment delivery component 5020 could include a liner, as described above with respect to other embodiments.

Although treatment delivery component 5020 may be configured to adapt to a large range of sizes of treatment portion TP, e.g., of varying diameter of circumference, in some embodiments treatment delivery component 5020 may be configured to accommodate treatment portions having a range of axial sizes (e.g., length of leg), and it may be desirable to have different models or sizes of treatment delivery component 5020, e.g., short, regular, and tall, to accommodate different ranges of sizes of treatment portion TP.

FIGS. 11G to 11I are close-up views of the heel part of foot 5024 portion of treatment delivery component 5020—FIGS. 11G and 11H from the exterior, and FIG. 11I from the interior. Passage 5130 in outer shell 5100 can be seen in each figure. As shown in FIGS. 11G and 11H, thermal conduit 5350 is disposed in passage 5130, with thermal connector 5360 disposed on the exterior of treatment delivery component 5020. As best seen in FIG. 11G, in this embodiment outer shell 5100 includes conduit management 5140, which includes a conduit sleeve 5142 and conduit loop 5144 through which pressure conduct 5250 is disposed. Conduit management 5140 helps to protect thermal conduit 5250 from damage and/or entanglement with objects in the setting in which treatment system 5000 is used. It can also be seen in FIG. 11G that thermal conduit 5250 includes five separate fluid passages 5252, each of which is fluidically coupled to a respective pressure element 5212 via pressure port 5214, as described above.

Control unit 5040 is shown in more detail in FIGS. 11J to 11T. As shown in FIG. 11J, control unit 5040 includes a housing 5050 and a pressure coupling 5650 and thermal coupling 5750 on a front surface of housing 5050. As discussed above, in this embodiment, thermal treatment component 5300 employs thermal liquid, e.g., water. Correspondingly, thermal source 5700 includes a liquid reservoir 5720 and a liquid pump 5730 (not shown in these figures), which can supply thermal liquid to, and receive thermal liquid from, a thermal coupler 5750, disposed on the front face of housing 5050. Although not shown in these figures, in some embodiments control unit 5040 can include a second thermal coupling 5750, also fluidically coupled to liquid pump 5730 and liquid reservoir 5720, so that control unit 5040 can deliver thermal fluid simultaneously, or sequentially, to two treatment delivery components 5020, and thus to provide treatment to two users, or to two treatment portions of a single user. Thermal connector 5360 can be releasably coupled to thermal coupler 5750, establishing fluidic communication between thermal source 5700 and thermal applicator 5310 via thermal conduit 5350. Liquid reservoir 5720 may be filled with water that is below body temperature (such as ice water, for cryotherapy) and/or that is above body temperature (such as hot water, for heat therapy). Housing 5050 also includes an access lid 5058 that covers liquid reservoir 5720—water (cold or hot) can be introduced into liquid reservoir 5720 by opening access lid 5058. Thermal source 5700 also includes a drain 5760 by which reservoir 5720 can be drained of thermal liquid (e.g., water) after a treatment session.

As also discussed above, in this embodiment pressure treatment component 5200 employs pressurized gas (e.g., air) supplied by pressure source 5600. Correspondingly, a pressure coupler 5650 is disposed on the front face of housing 5050, which includes a gas pump 5630 (not shown), to which pressure connector 5260 can be releasably coupled, establishing fluidic communication between pressure source 5600 and pressure applicator 5210 via pressure conduit 5250. FIG. 11L shows a close-up view of pressure coupler 5650 and pressure connector 5260 at the end of pressure conduit 5250. As shown in FIG. 11L, pressure connector 5260 terminates in a set of male connectors 5261, each of which is in fluid communication with a respective fluid passage 5252 and can be mated to a respective female receptacle 5651 on pressure coupler 5650.

Control until 5040 also includes a user interface 5950 that includes an integrated display and user input 5980 (corresponding to display 1960 and user input 1970 of user interface 1950 of treatment system 1000, described above) disposed on an upper surface of housing 5050. In this embodiment, display and user input 5980 includes a thermal panel 5981 (which provides inputs for control of the function of the liquid pump 5730 and displays information about operation of the thermal treatment component 5300) and a pressure panel 5982 (which provides inputs for control of the function of the gas pump 5630 and displays information about operation of the pressure treatment component 5200).

As shown in FIG. 11M, thermal panel 5981 includes a temperature display 5983 and time display 5984, on which processor 5910 can cause to be displayed, respectively, a temperature relevant to thermal treatment (such as the temperature of the thermal liquid in the liquid reservoir 5720) and a time relevant to thermal treatment (such as the remaining time for the thermal treatment session). Thermal panel 5981 can also include indicators 5985 for the status of the pump (on or off) and whether the thermal system is operating in a pulse mode. Thermal panel 5981 also includes user inputs including power button 5986A (to turn on or off the thermal source 5700 (e.g., liquid pump 5730)), pulse button 5986B (to turn on or off a pulse mode of delivery), increase/decrease buttons 5986C (to increase or decrease, for example, program time), and main power button 5987 (to turn on or off the entire control unit 5900). The pulse mode of delivery may include operating the liquid pump on a duty cycle of, for example, two minutes on (pumping) and 30 seconds off.

As shown in FIG. 11N, pressure panel 5982 includes numerous user inputs. These can include: a) a mode set button 5990A (by which the user can select different operating modes for control unit 5040), b) pressure/time selection button 5990B (by which the user can select a time/pressure for operation), c) increase/decrease time/pressure buttons 5990C (to change a time/pressure to be selected for operation), d) start/pause button 1990D (to start or pause the pressure treatment operation); e) lock button 5990E (to lock the user interface against user inputs), and f) channel selection buttons 5990F (by which a user can selectively enable or disable each of the pressure elements 5212 (or chambers) from being actuated during a pressure treatment session. As also shown in FIG. 11N, pressure panel 5982 includes several displays. These can include: a) mode display 5992A (which can show which pressure treatment mode has been selected, e.g., mode 1 through mode 5); b) battery level display 5992B (which can show the state of charge of a battery power supply for control unit 5040), c) pressure display 5993 (which can show the set, or target, pressure for pressure treatment, and the current actual pressure in the pressure element(s) 5212 of pressure applicator 5210, or the output pressure of pressure source 5600), d) time display 5994 (which can show the set, or target, time for pressure treatment, and the current elapsed, or remaining, time in the pressure treatment session, and e) pressure element working display 5995 (which can display which pressure element(s) 5212 are currently pressurized, as described below in more detail with references to FIGS. 11O to 11S).

As noted above, pressure treatment can be delivered in different pressure treatment modes, which may be selected by the user (with mode set button 5990A). In this embodiment, five modes are available, which are illustrated in FIGS. 11O to 11S. One mode is sequential compression, from bottom (foot) to top. As shown schematically in FIG. 11O, in this mode pressure elements (or chambers) 5212 can be pressurized sequentially, beginning with the element at the foot (CH−1), with each pressure element 5212 remaining pressurized as the next element (moving away from the foot) is pressurized. After the last of the pressure elements 5212 are pressurized, all of the elements are depressurized, and the cycle can repeat. As noted above, the progress of the treatment session, i.e., the state of each pressure element 5212 (pressurized or not pressurized) can be displayed on pressure element working display 5995. Another mode is uniform compression. As shown schematically in FIG. 11P, in this mode all of the pressure elements 5212 are pressurized concurrently, and all are depressurized concurrently. Another mode is sequential compression, from bottom to top. As shown schematically in FIG. 11Q, in this mode the pressure elements 5212 are pressurized sequentially, as in the first mode, but in reverse order. Another mode is a variation on the sequential compression of bottom to top, but each pressure element 5212 is pressurized in turn, and is depressurized when the next pressure element in the sequence is pressured. This mode is shown schematically in FIG. 11R. Another mode is similar to the preceding mode, except that pressure elements 5212 are pressurized sequentially in pairs, as shown schematically in FIG. 11S. Other pressure treatment modes are possible—the modes described above are only exemplary. The user may select the magnitude of the pressure to be delivered, such as, for example, between 20 and 150 mmHg (gauge pressure). The user may also select the duration of a therapy session, such as, for example, between 20 and 200 minutes.

Some of the main components of control unit 5040 is shown in an exploded view in FIG. 11T. As can be seen in FIG. 11T, housing 5050 of control unit 5040 can include a lower housing portion 5052 and an upper housing portion 5054. Most of the volume within control unit 5040, between lower housing portion 5052 and upper housing portion 5054, is occupied by liquid reservoir 5720, into which a user can pour thermal fluid via the opening in upper housing portion 5054 selectively covered by access lid 5058. Display/input 5980 is disposed on the upper surface of upper housing portion 5054, and covers a cavity within which other components of control unit 5040 can be disposed (e.g., pressure source 5650, liquid pump 5730).

Many of the components of control unit 5040 (including pressure source 1600, liquid pump 1730, controller 1900, and user interface 1950 may be operated using electrical power. Such power may be provided by an internal battery or an external power supply, such as a plug to a wall outlet.

Consistent with the process described above with reference to FIG. 8, a user may use treatment system 5000 by disposing a leg in treatment delivery component 5020, and then close outer shell 5100 with fastener portion 5120 (i.e., zip up the zipper), such as while seated on the floor or a couch, chair etc. The user can then power on controller 5020, select a treatment session duration, thermal treatment mode, pressure treatment mode, etc., to receive the selected treatment.

Although treatment delivery component 5020 is configured to treat essentially the entire leg of a user, all of the structures, components, and techniques described above could be used with a device that extends over a much more finite axial length, such as all or a portion of the thigh, or just a knee, ankle, etc. In some embodiments, a pressure applicator could extend over the entire leg (or other body part) and a thermal applicator or other treatment applicator could extend over only a portion of the leg, or vice versa. Thus, for example, in treatment delivery component 5020, pressure applicator 5210 extends over the entire leg (including the foot), but thermal application 5310 ends above the foot.

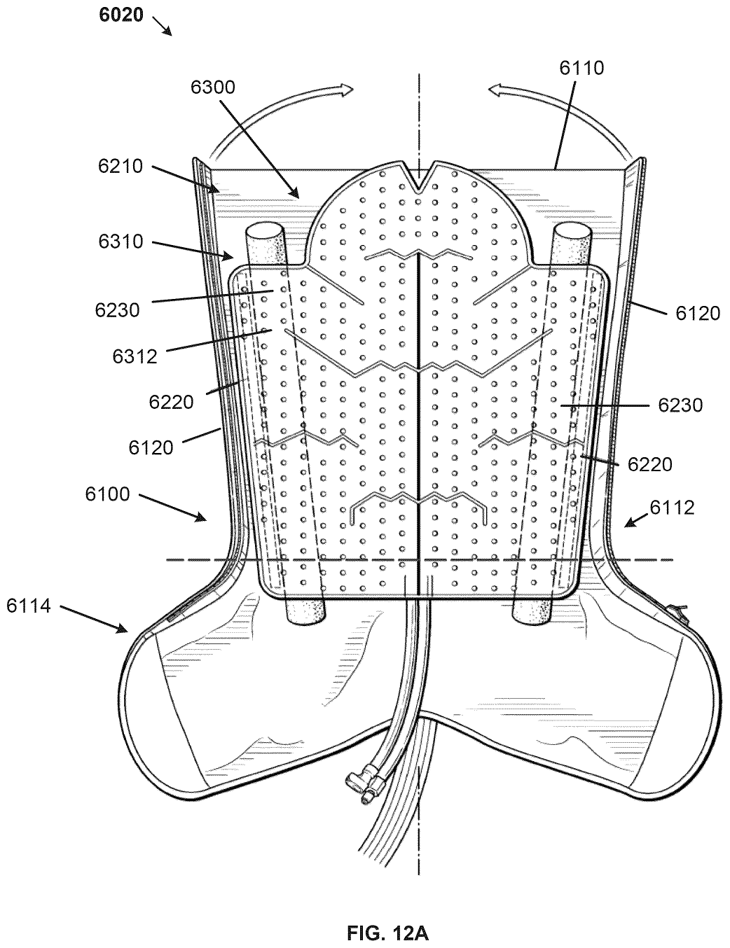

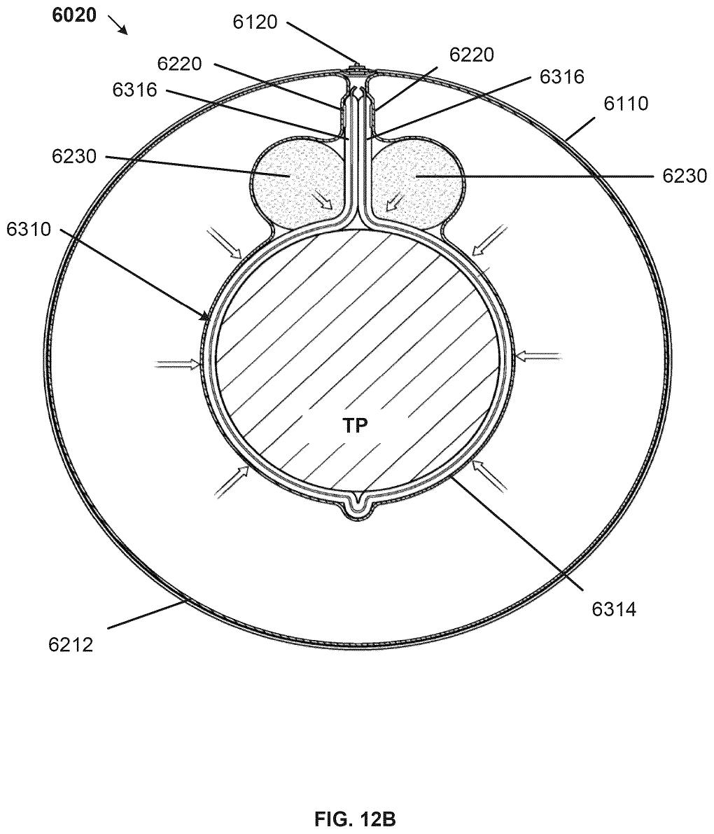

Although the size adaptability/pad “wasting” functionality is described above with respect to treatment delivery components 4020 and 5020 as being achieved only with pressure applicator 4210 and 5210, respectively, in other embodiments this functionality can be achieved in whole or in part with a mechanism that is separate from the pressure applicator. One such embodiment is shown in FIGS. 12A and 12B. In this embodiment, treatment delivery component 6020 is similar to treatment delivery component 5020, except that it also includes longitudinally oriented bolsters 6230. Elements that are the same as those in delivery component 5020 are not discussed in detail here.

As shown in FIG. 12A, treatment delivery component 6020 includes a thermal delivery component 6300, with a thermal applicator 6310 disposed on, and releasably secured to, pressure applicator 6210, coupled by thermal applicator couplers 6220. As with treatment delivery component 5020, outer shell 6100 and pressure applicator 6210 are fixedly connected to each other, and pressure applicator 6210 includes multiple pressure elements 6212. Outer shell 6100 also includes fastener portion 6120, which in this embodiment is also implemented as a zipper, with cooperating portions on each edge of body portion 6110. Bolsters 6230 are shown disposed between pressure applicator 6210 and thermal applicator 6310, with one disposed adjacent each side portion 6316. Bolsters 6230 thus fill some of the volume between outer shell 6100 and treatment portion TP that would otherwise need to be filled by pressure elements 6312 in their expanded configuration to adapt treatment delivery component 6020 to treatment portion TP to provide proper apposition of central portion 6314 of thermal applicator 6310 with treatment portion TP and to press side portions 6316 against each other, to “waste” those portions of thermal applicator 6310.

Bolsters 6230 are used in this embodiment to complement pressure elements 6212 to waste thermal applicator 6310, and accommodate a user with a relatively small treatment portion TP. For users with relatively larger treatment portions TP, bolsters 6230 may not be necessary, or may impede the adaptation of treatment delivery component 6020 to treatment portion TP (e.g., if the size of treatment portion TP is close to the maximum size capacity of treatment delivery component 6020). For very small users, it may be desirable to insert more than one bolsters 6230 (two, three, or more) adjacent each side portion 6316. It may thus be advantageous for bolsters 6230 to be separable from treatment delivery component, so that a user may insert one or more bolsters 6230 if treatment portion TP is relatively small, or dispense with their use if treatment portion TP is relatively large. In some embodiments, a single bolster 6230 may be used, i.e., adjacent to only one side portion 6316.

The dimensions of each bolster 6230 may vary depending on the desired volume for bolsters 6230 relative to the total volume within outer shell 6100. If two (or more) bolsters are used, they may be of different sizes, and a user may select from a range of sizes of bolsters for a given treatment portion, desired therapy session parameters, etc. Although shown in FIG. 12B as being circular in cross-section, bolsters 6230 may be of any desired cross-sectional geometry, e.g., rectangular, triangular, oval, etc. Although shown in FIG. 12A as being of constant diameter along their length, bolsters 6230 may have varying diameters (or size or perimeter of non-circular cross-section) along their length. For example, it may be desirable for the bolster to have a larger cross-sectional area near the foot (where treatment portion TP would have a smaller cross sectional area) and larger near the top of the leg. As shown in FIG. 12A, each bolster 6230 may extend essentially the entire length of pressure applicator 6210, i.e., between every pressure element 6212 and thermal applicator 6310. In other embodiments, bolsters 6230 may be between only one or some of pressure elements 6212 and thermal applicator 6310. In other embodiments, treatment delivery component 6020 may include two or more bolsters on each side of thermal applicator 6310, rather than a single bolster 6230.

The mechanical properties (e.g., compressibility, flexural stiffness) of bolsters 6230 may be selected to achieve desired functionality. For example, it may be preferable for bolster 6230 to be sufficiently stiff (in compression) to provide desired thermal applicator wasting for a small user, but sufficiently compressible to allow adaptation to a relatively larger user (and treatment portion TP). Bolster 6230 may therefore be formed of, for example, a foamed polymer having a suitable density to yield the desired stiffness/compressibility. In some embodiments, bolster 6230 may be hollow, or otherwise be heterogeneous in cross-section (e.g., with two or more layers of material with differing mechanical properties).

Bolsters 6230 may simply be inserted between pressure applicator 6210 and thermal applicator 6310 and retained in place by friction/pressure. In some embodiments, bolsters 6230 may be retained in a desired location by being fastened to one or both of pressure applicator 6210 and thermal applicator 6310 by fasteners, e.g., hook and loop fasteners. The position of bolster(s) 6230 relative to thermal applicator 6310 could also be adjusted so that pressure applicator 6310 can be used for different sizes of treatment portion TP. Indicia such as lines could be marked on the back of treatment applicator 6310 to indicate where to attach bolster 6230 to treatment applicator 6310 to aid the user in positioning bolster 6230.

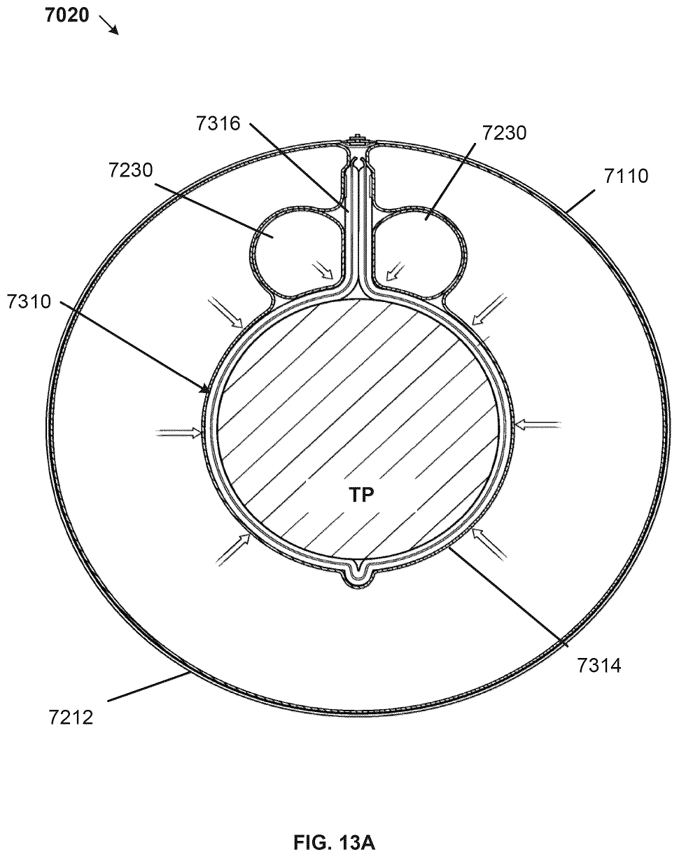

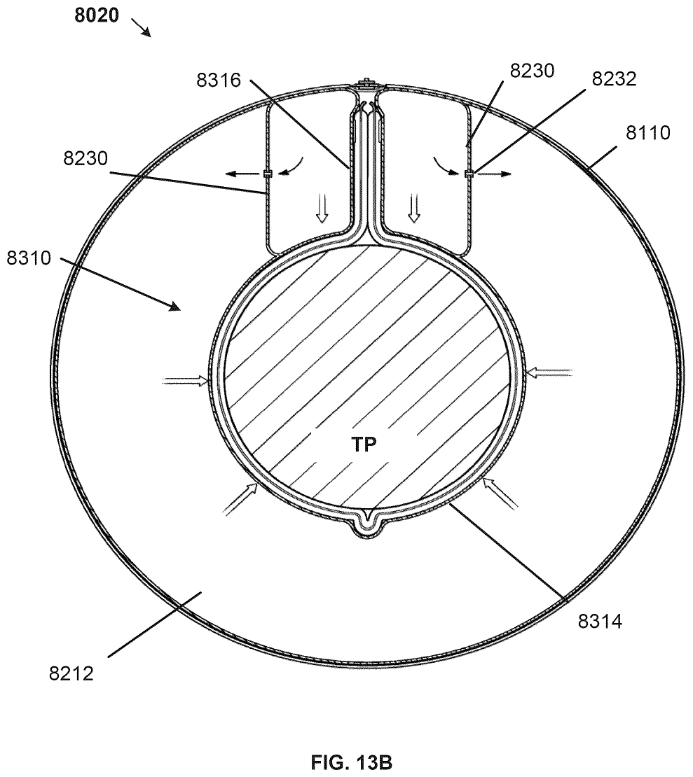

In some embodiments the bolsters can be inflatable structures that may be actuated by the same pressure source used to actuate the pressure elements, or by some other means. One such embodiment is shown in FIG. 13A. Treatment delivery component 7020 includes bolsters 7230, which are implemented as inflatable tubes or bladders. Pressurized gas to inflate or expand bolsters 7020 may be supplied by the same pressure source that supplies pressurized gas to pressure elements 7212, or may be supplied by a separate source. The controller may be operated to inflate or expand bolsters 7320 to a selected pressure, or a user my control their inflation until thermal applicator 7310 feels appropriately tight on treatment portion TP. Bolsters 7320 may be inflated or expanded before, after, or concurrently with initial inflation of pressure elements 7212 until proper adaptation of treatment delivery component 7020, and apposition of central portion 7314 of thermal applicator 7310 is achieved, before delivery of selected thermal and/or pressure treatment modalities. As with bolsters 6230, bolsters 7230 may have various cross sectional shapes, may vary in cross sectional shape and/or area along the length of bolsters 7320, may be continuous or segmented, may be of any desired number (one, two, or more), may extend the full length of thermal applicator 7310 or only part of its length, etc.

Although referred to in the preceding embodiments as bolsters, with a focus on the functionality of wasting the thermal applicator, each inflatable bolster can also be considered to be another pressure applicator, can thus in addition to wasting the thermal applicator, the bolster can deliver pressure treatment. Inflatable bolsters with an axially elongate configuration can provide pressure treatment to an elongated part of a treatment portion, e.g., to the full length of a user's thigh or calf, and in a circumferentially finite portion, e.g., only to the front of the thigh (such as the quadriceps), alone or in conjunction with circumferentially oriented and more axially finite pressure elements. As noted above, the inflatable or expandable bolsters, or axially elongate pressure elements, can be asymmetric with respect to the treatment portion or the other components of the treatment delivery component. Similarly, as shown in FIG. 11F, each pressure element can also be circumferentially asymmetric, e.g., to expand to a greater degree on one side of treatment portion TP and a lesser degree on the opposite side. Such asymmetry can be created by the geometry or dimensions of the bladder or envelop of material used to form the pressure element. In some embodiments, as described above with reference to FIGS. 3N and 3O.

One or more inflatable bolsters such as bolster 7230 could also be used independently of a pressure applicator such as pressure applicator 7210, e.g., to tension a thermal applicator or other treatment applicator circumferentially around a treatment portion.

Another embodiment of an inflatable bolster is shown in FIG. 13B. Treatment delivery component 8020 is very similar to treatment delivery component 7020 shown in FIG. 13A, so elements that are the same are not discussed in detail here. In this embodiment, bolsters 8230 are also inflatable, but have a generally rectangular, rather than circular, cross-section. Each bolster 8230 also includes a connecting port 8232 that provides fluidic communication between the interiors of bolsters 8230 and each pressure element 8212. Only one pressure element is shown in the view in FIG. 13B, but this view is a cross-section through one axial location of treatment delivery component 8020, which can have multiple, axially-distributed pressure elements 8212, in the same manner as treatment delivery element 5020, described above. Pressurized gas from the pressure source can be introduced first into bolsters 8230 to expand them and adapt treatment delivery element 8020 to treatment portion TP, and from bolsters 8230 can flow into pressure elements 8212.

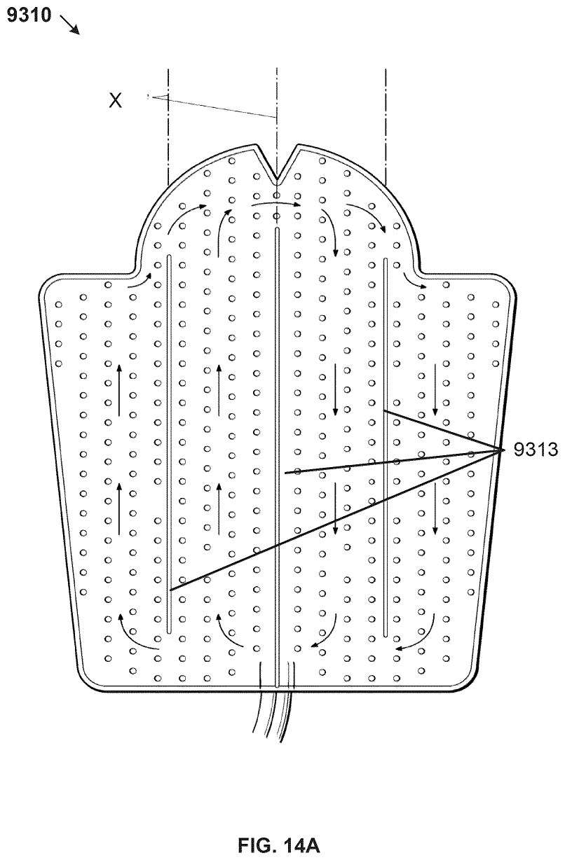

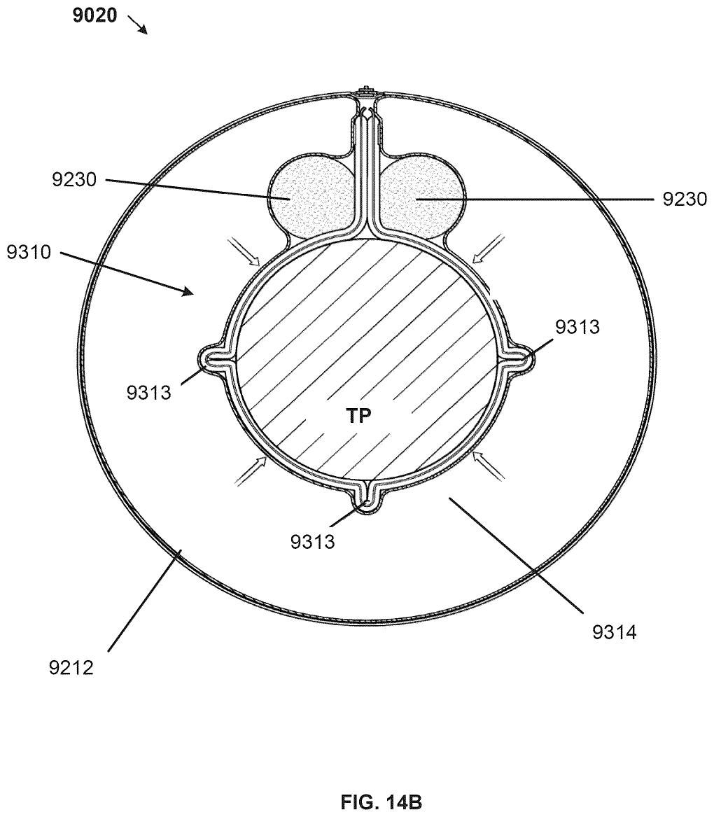

As discussed above, the thermal applicator can be formed with elongated fused portions that function both as flow diverters for the thermal fluid that can circulate through its interior, and also form a preferential folding location, the arrangement of which can aid in conformation or apposition of the thermal applicator with the treatment portion of the user body. This functionality can be combined with that of the bolsters, as is illustrated in FIGS. 14A and 14B. Thermal applicator 9310 includes three longitudinally-extending flow diverters 9313, which can create preferential fold lines indicated in FIG. 14A by the dashed lines labeled with an X. As can be seen in FIG. 14B, these fold lines can further facilitate or enhance the apposition of central portion 9314 of thermal applicator 9310 with treatment portion TP provide by bolsters 9230 (which may be the same as any of the bolster embodiments describe above). Many variations on this approach to the use of flow diverters 9313 are possible. There could be any number of seams or plications formed by flow diverters. Although shown as longitudinal in FIGS. 14A and 14B, flow diverters could also be arranged laterally, for horizontal folding or plication. The width of the fused portion defining the flow diverters can also vary in width—a wider fused seam will accommodate more plication. Moreover, the flow diverters 9313 may facilitate uniform distribution of the thermal fluid through the internal volume of the thermal applicator 9310 to provide heat treatment to substantially the entire surface of the treatment portion that is the target of the thermal treatment, as well as providing a preferential flow direction for the thermal fluid to enter and exit the thermal applicator 9310.

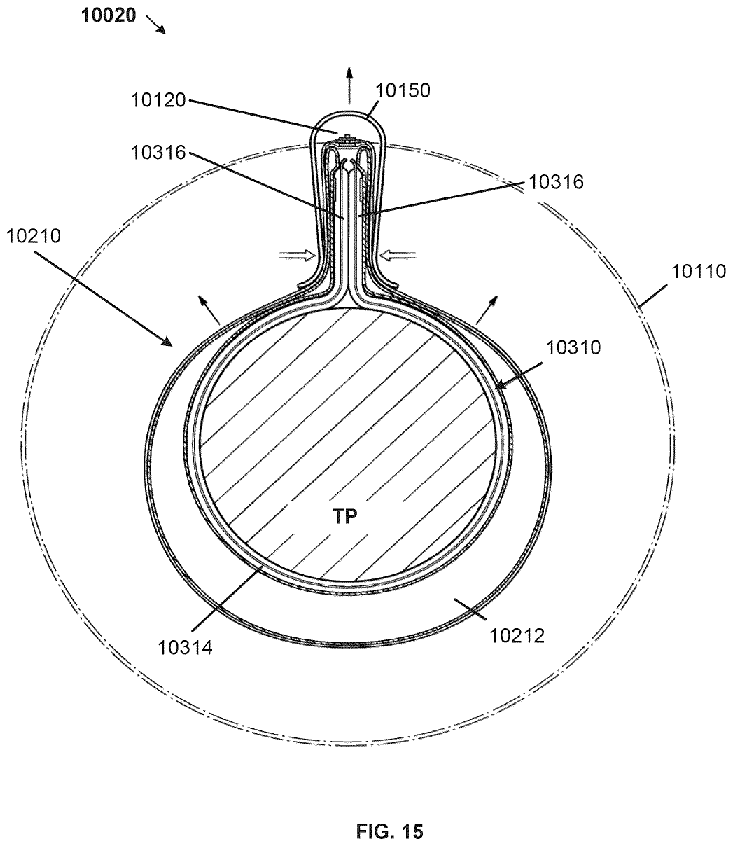

Mechanisms other than bolsters may be used to “waste” the thermal applicator and adapt the treatment delivery component to the treatment portion. One alternative mechanism is shown in FIG. 15. Treatment delivery component 10020 is very similar to treatment delivery component 5020 described above, so elements that are the same are not discussed in detail here. Treatment delivery component 10020 can include multiple waste clamps or clips 10150, which can be applied to treatment delivery component 10020 after it has been enclosed around treatment portion TP, across the edges of body portion 10110 where they are joined by fastener portion 10120 (e.g., zipper). The user can gather together the side portions 10316 into apposition with each other, and drawing central portion 10314 of thermal applicator 10310 into apposition with treatment portion TP, pinching together as well the overlying portions of body portion 10110 and pressure applicator 10210. Pressure elements 10212 can then be expanded by introduction of pressurized gas, and as their volume increases, waste clip 10150 can be urged away from treatment portion TP and ultimately off of treatment delivery component 10020. Waste clips 10150 can vary in size for application to different axial portions of treatment delivery components 10020 to accommodate different amounts of wasting required with different cross-sectional areas of treatment portion TP (e.g., more wasting at the ankle than at the thigh of a leg). Waste clips 10150 can be formed of any suitable material that is resilient, can provide the needed clamping force, slidably disengage from treatment delivery component 10020 as pressure elements 10212 expand, etc.

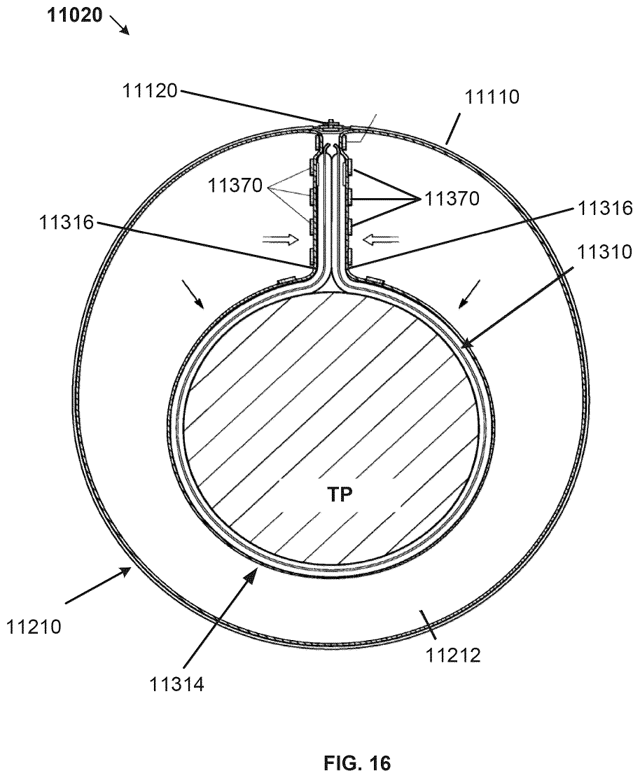

In another embodiment, shown in FIG. 16, the externally-applied clamping force provided by waste clips can be replaced by magnetic attraction force. In this embodiment, treatment delivery component 11020 includes a thermal applicator 11310 with side portions 11316 and central portion 11314. Thermal applicator 11310 also includes include a set of waste magnets arranged in mating, mutually magnetically attractive pairs on the laterally outer portions thereof. Each pair of waste magnets 11370 can be attracted towards each other (as indicated by the larger arrows in FIG. 16) with sufficient force to approximate the inner surfaces of side portions 11316, and aid in effective apposition of central portion 11314 with treatment portion TP (as indicated by the smaller arrows in FIG. 16). The number of pairs of waste magnets 11370 that are engaged to waste side portions 11316 depends on the size of treatment portion TP—the smaller the treatment portion TP, the more pairs of waste magnets 11370 are required to waste side portions 11316. Although waste magnets 11370 are shown in FIG. 16 as disposed on an outer (back) surface of thermal applicator 11310, in other embodiments they can be disposed in an inner (front) surface, or incorporated into, thermal applicator 11310. As will be apparent from the illustrations of other embodiments, FIG. 16 is a cross-section through one axial location of treatment delivery component 11020—multiple sets of waste magnets 11370 can be disposed at other axial locations, and each axial location may have more or fewer pairs of magnets (e.g., fewer at the top of a leg and more at a bottom of a leg). A user can adapt treatment delivery component 11020 to a treatment portion TP by approximating the side portions 11316 of thermal applicator 11310 sufficiently closely for the magnetic attraction of mating pairs of magnets to draw the side portions fully together. The user may then approximate the edges of body portion 11110 and fasten them together with fastener portion (e.g., zipper) 11120, and then initiate treatment via the control unit.

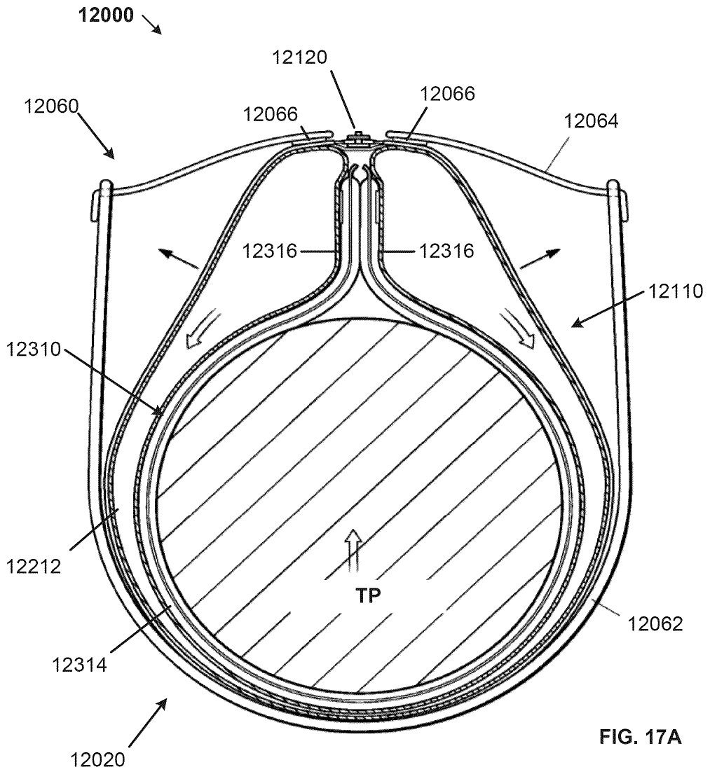

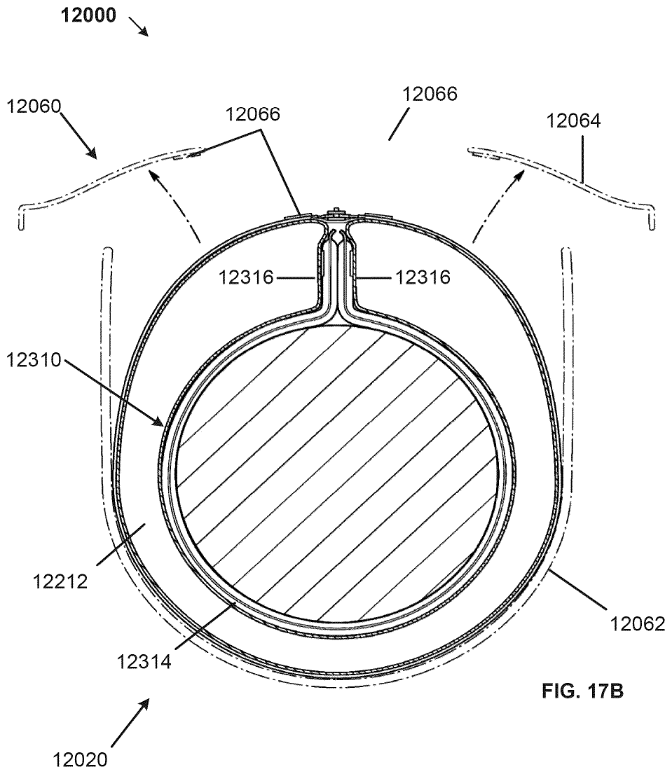

Other approaches besides the wasting described above can be employed to ensure good apposition of the central portion of the thermal applicator and avoid folds or creases that can compromise delivery of thermal treatment, e.g., by inhibiting of disrupting the flow of thermal fluid through the thermal applicator. One such approach is shown in FIGS. 17A and 17B. In this embodiment, treatment system 12000 includes treatment delivery component 12020 and a support frame 12060. Treatment delivery component 12020 is essentially the same as treatment delivery component 5020 described in more detail above. Both body portion 12110 and thermal applicator 12310 (as well as pressure applicator 12210) are relatively flexible, and therefore are not self-supporting, but tend to collapse or fall towards the ground when the user disposes treatment portion TP into treatment delivery component 12020. Support frame 12060 is configured to support treatment delivery component 12020, and in particular body portion 12110 and thermal applicator 12310 during the process of the user donning treatment delivery component 12020.

Support frame 12060 includes a U-shaped main frame 12062, and a pair of support arms 12064 releasably coupleable to the top or open end of main frame 12062. Support arms 12064 are also releasably connectable to body portion 12110 by support frame fasteners 12066 (e.g., hook-and-loop fastener). A user can dispose treatment delivery component 12020 into main frame 12062, attach support arms 12064 to main frame 12062, dispose treatment portion TP into the interior of treatment delivery component 12020 (i.e., on top of center portion 12314 of thermal delivery component 12310), lift up the edges of body portion 12110 and secure them together with fastener 12120, and engage them with support frame fasteners 12066. The edges of body portion 12110, and by extension the side portions 12316 of thermal delivery component 12310, are thus suspended from support frame, and central portion 12314 is free of any creases or folds. Pressure delivery component 12110 can then be actuated, and thus pressure element 12212 can be expanded, bringing center portion 12314 into good apposition with treatment portion TP and wasting side portions 12316, as shown in FIG. 17A. With treatment delivery portion 12020 properly adapted to treatment portion TP, support frame 12060 can then be removed from treatment delivery portion 12020, as shown in FIG. 17B, such as by releasing support frame fasteners 12066, removing support arms 12064 from main frame 12062 (as indicated by the dashed arrows), and removing main frame 12062 from around treatment delivery component 12020.

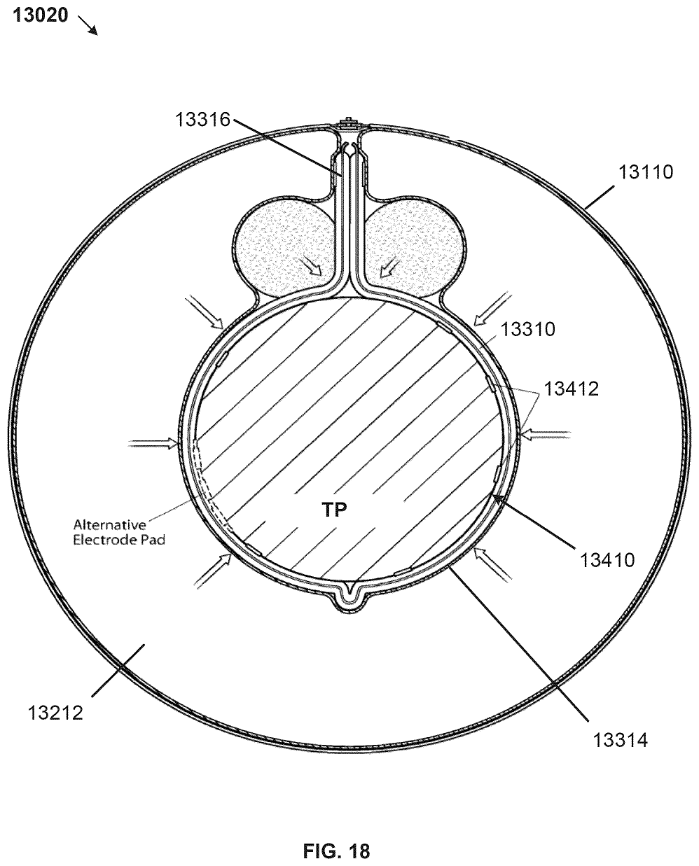

As described in detail above, treatment systems can be configured to deliver other treatment modalities (in addition to, or instead of, pressure and/or thermal treatment). One such treatment system is illustrated in cross-section in FIG. 18. Treatment delivery component 13020 is essentially the same as treatment delivery component 7020 described above, except for the addition of an other treatment delivery component, with an other treatment applicator 13410. In this embodiment, other treatment applicator 13410 is configured to deliver electrical stimulation, such as TENS, NEMS, PEMF. As described above, TENS treatment may be desirable for a variety of conditions, including for many painful conditions such as back pain, for muscle recovery, or to treat problems like phantom limb pain. NEMS can be used to increase strength and range of motion, and offset effects of muscle disuse (e.g., after surgery or coma to retrain or reeducate muscles to function normally and build strength). PEMF can be used to deliver electromagnetic or magnetic fields to treat, for example, chronic inflammation in joints or tissue, chronic fatigue symptoms or chronic fatigue syndrome, peripheral neuropathy, osteopenia or osteoporosis, poor wound healing, by enhancing body's natural recovery process, correcting cell dysfunction, and/or reducing inflammation. Other treatment applicator 13410 therefore includes individual electrodes 13412 that can deliver electrical stimulation to treatment portion TP when disposed in operative contact with the surface of treatment portion TP and receive electrical energy from a suitable source (as described above). To improve contact with the surface of treatment portion TP, electrodes 13412 could be located and spaced individually with wires or electrical leads (not shown in FIG. 18) passing from along the inside thermal applicator 13310 pad to its surface, or with wires attached to electrodes 13412 that pass through thermal applicator 13310 then to its outside. The wires or electrical leads could pass between the pressure applicator 13210 and the outer surface of other treatment applicator 13410 (or thermal treatment applicator 13310), and then through an opening in the outer shell of treatment delivery component 13020, as with pressure conduits and or thermal conduits, as described above.

In this embodiment, other treatment applicator 13410 is coupled to, or incorporated with, thermal applicator 13310, but in other embodiments (as described above), other treatment applicator 13410 can be separate from thermal applicator 13310, or used as part of a treatment delivery component that does not include a thermal applicator. Thus, electrodes 13412 could be disposed on the surface of a separate fabric or membrane. They could also be mounted on solid surfaces or on mesh structures which can separate the electrodes but allow for contact with the skin. The meshes could be constructed from fabric, elastic, metal or plastic or any other mounting structure. Pads or surfaces with electrodes could be compressed against the skin. The electrodes could be attached to wires that carry them to a controller device that would power and/or regulate the energy delivered. They could travel out of the boot from either end and may accompany the fluid tubes if these are used. The wires could also pass through a seam in the boot construction.

In this embodiment, other treatment applicator 13410 is coupled to, or incorporated with, thermal applicator 13310, in particular central portion 13314 thereof. No electrodes are shown in side portions 13316 of thermal applicator 13310, but electrodes could be disposed across the full width of thermal applicator 13310, and only electrodes that are in contact with treatment portion TP may receive electrical energy.

As with other embodiments illustrated above, FIG. 18 illustrates a cross section of treatment delivery component 13020 at one axial location, but treatment delivery component can have a similar configuration at other axial locations, e.g., include multiple rows of electrode 13412.

Any of the wasting techniques described above are beneficial not just for thermal applicators, but also for other treatment applicators such as the TENS, NEMS, and/or PEMF delivery device shown in FIG. 18. The benefits of good, uniform apposition with treatment portion TP, without creases, folds, or other disruptions to uniform application of the treatment applicator can be even more useful for treatment modalities such as TENS, NEMS, and/or PEMF in which the spacing of the electrodes (or magnetic field generators) may be optimized for the treatment, and the spacing is preferably maintained during adaptation of the treatment delivery component to the treatment portion.

Electrodes 13412 could be replaced by electrical heating elements, such as the elements commonly used in heating pads and blankets. This would allow treatment portion TP to be heated electrically, while being cooled with cold thermal fluid in thermal treatment applicator 13310. This would allow for a simpler control unit, by eliminating the need for supplying hot thermal fluid, reducing weight and cost.

As noted above, other treatment modalities can involve the use of magnets. Thus, in some embodiments, electrodes 13412 could be replaced by permanent magnets or by electromagnets powered by wires or electrical leads connected to a power source in the control unit of the treatment system.

As discussed above, a treatment delivery component can be configured to treat any one or more of different treatment portions of a user's body. The embodiments illustrated schematically in FIGS. 1 to 10F may be applicable to any treatment portion. And although the embodiment illustrated FIGS. 11A to 11T is described with reference to a leg as the treatment portion, the structures and functions described may be applied to, or adapted to be applied to, other treatment portions of a user's body. Other embodiments that are configured specifically for other treatment portions of a user's body are described below, but any of the illustrated structures and functions may be adapted to user with other treatment portions. These embodiments also illustrate a benefit of the modular construction of the treatment delivery component, e.g., that the thermal delivery component can be releasably coupled to the outer shell, pressure delivery component, and/or liner. With this approach to construction, the outer shell, pressure delivery component, and/or liner can be configured to interoperate with a thermal delivery component that may be sourced from a third party manufacturer, i.e., the manufacturer of the treatment delivery component may source the thermal delivery component separately, and/or may direct a user to secure the thermal delivery component directly from the third party. Relatedly, the control unit can be configured to operate with, or include adapters to enable it to operate with, third party thermal delivery components, e.g., with the thermal connector thereof. A user may thereby also gain increased usability and functionality from a system that includes a control unit that can operate with different outer shells, pressure delivery components, and liners, and with thermal delivery components obtained from the supplier of the other components, or directly from a third party. In some embodiments, the modularity and interoperability can extend to having the control unit control the operation of the pressure delivery component (and used with the outer shell and liner), while a third part control unit can control the operation of the thermal delivery component. This can be economically advantageous for a user who already owns a thermal treatment system, and wishes to add the functionality of the pressure delivery component, for pressure therapy and/or for the benefits of improved adaptation and operation of the thermal delivery component described above.

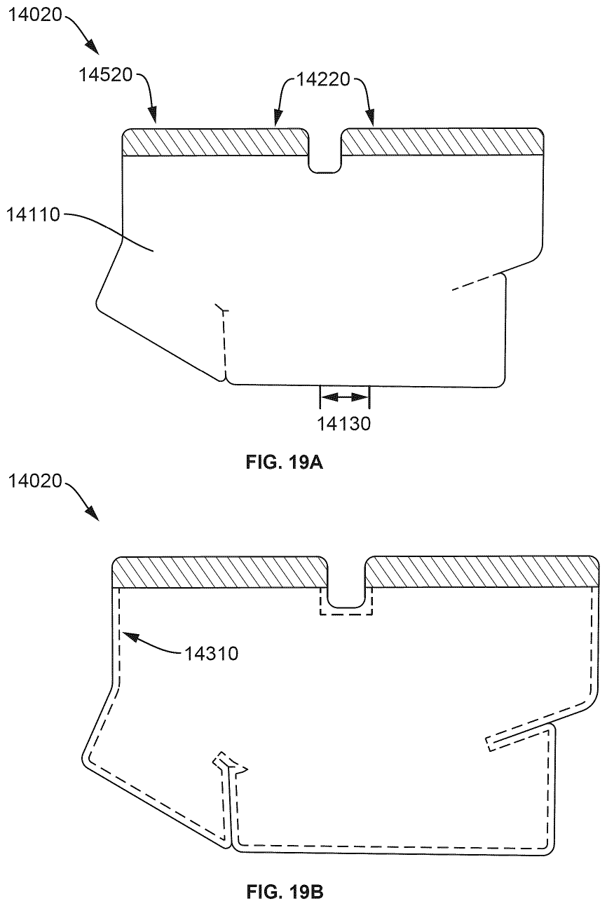

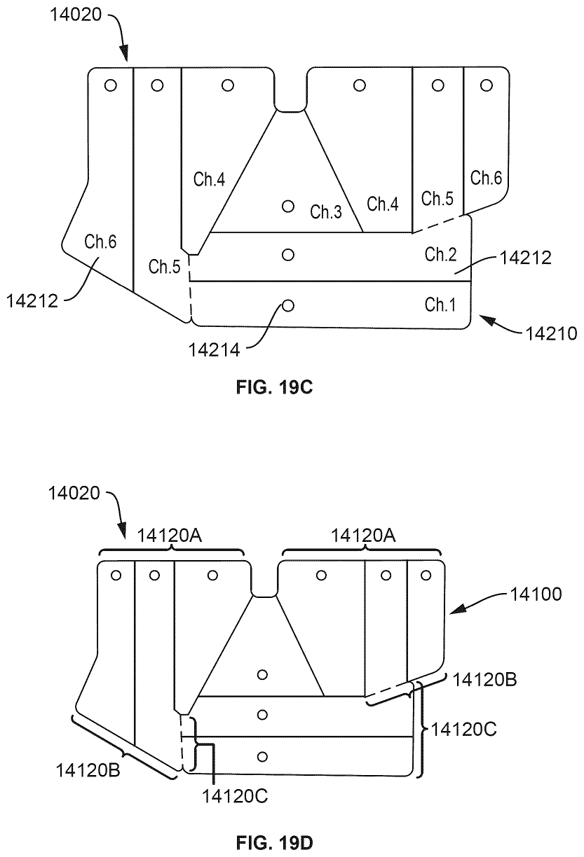

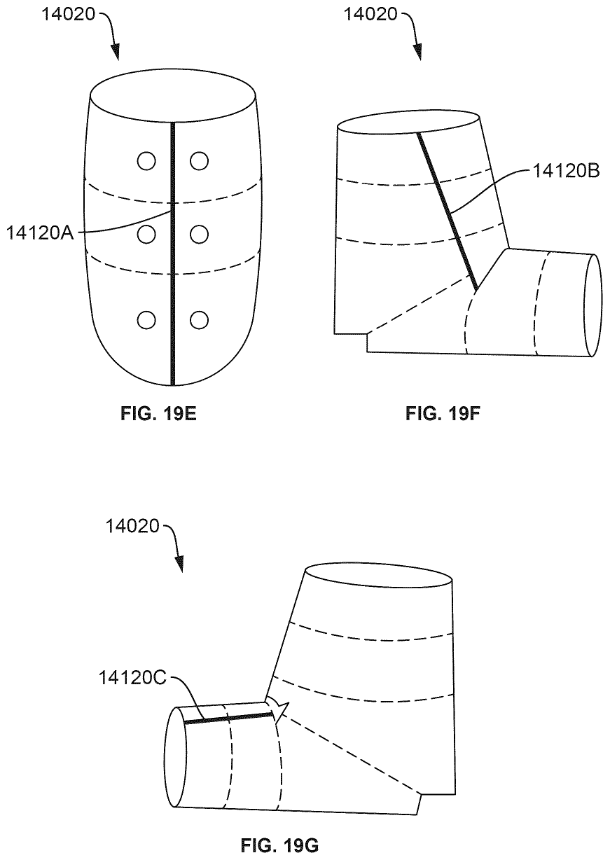

A treatment delivery component configured for application to an ankle of a user is shown in FIGS. 19A to 19G. Treatment delivery component 14020 is constructed with an integrated outer shell, pressure applicator, and liner, which can receive a thermal delivery component. For ease of illustration, not all elements of these components are specifically identified in the figures. Body portion 14110 defines with pressure applicator 14210 and/or liner (not separately shown) a liner pocket 14520, into which thermal applicator 14310 (shown in dashed lines in FIG. 19B, disposed in liner pocket 14520) can be disposed, and the thermal conduit (not shown) can be disposed through passage 14130. Thermal applicator 14310 can be retained in liner pocket 14520 by closing liner pocket 14520 with thermal applicator couplers 14220 (e.g., hook and loop fasteners).

As shown in FIGS. 19C and 19D, pressure applicator 14210 includes six pressure elements 14212 (also labeled as chambers, or Ch. 1 to Ch. 6), each of which includes a pressure port 14214 to each of which a fluid passage of a pressure conduit (not shown) can be coupled, as described above for other embodiments. As with other embodiments, each pressure element 14212 can be actuated (expanded or collapsed) by a control unit independently. As shown in FIG. 19D, outer shell 14100 can include three mating sets of fastener portions 14120A, 14120B, and 14102C. These mating sets of fastener portions can be fastened together to secure treatment delivery component 14020 around the ankle of the user, in the configuration shown in FIGS. 19E-G.

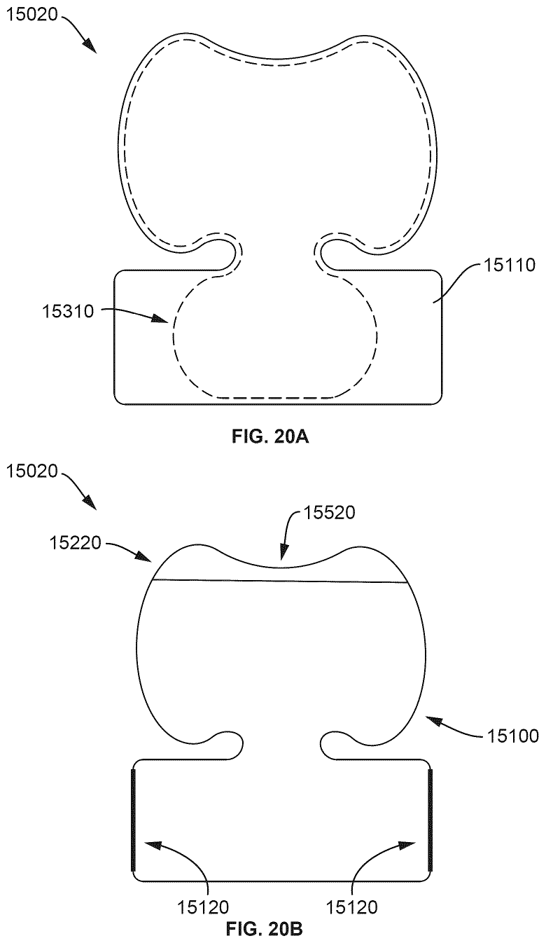

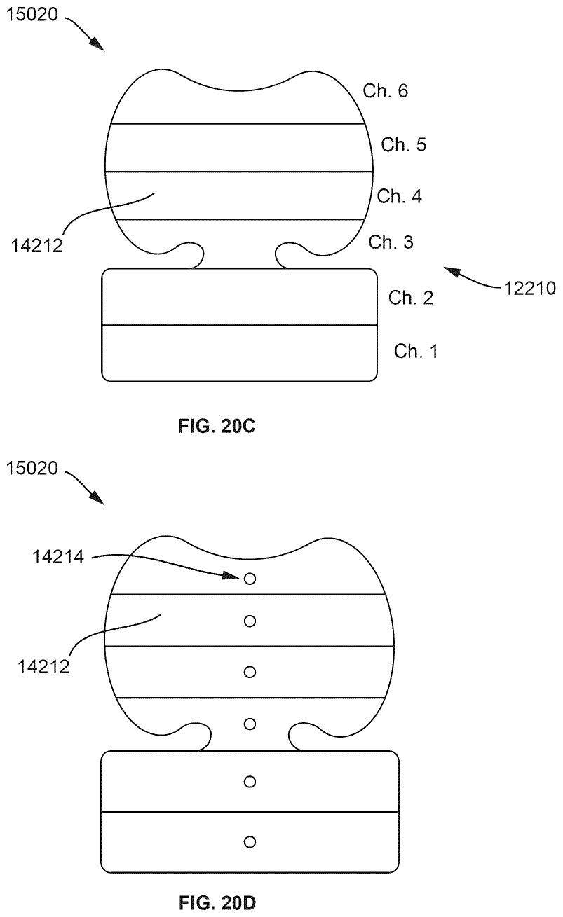

A treatment delivery component configured for application to a shoulder of a user is shown in FIGS. 20A to 20D. Treatment delivery component 15020 is constructed with an integrated outer shell, pressure applicator, and liner, which can receive a thermal delivery component. For ease of illustration, not all elements of these components are specifically identified in the figures. Body portion 15110 defines with pressure applicator 15210 and/or liner (not separately shown) a liner pocket 15520, into which thermal applicator 15310 (shown in dashed lines in FIG. 20A, disposed in liner pocket 15520) can be disposed. Thermal applicator 15310 can be retained in liner pocket 15520 by closing liner pocket 15520 with thermal applicator couplers 15220 (e.g., hook and loop fasteners).

As shown in FIGS. 20C and 20D, pressure applicator 15210 includes six pressure elements 15212 (also labeled as chambers, or Ch. 1 to Ch. 6), each of which includes a pressure port 15214 to each of which a fluid passage of a pressure conduit (not shown) can be coupled, as described above for other embodiments. As with other embodiments, each pressure element 15212 can be actuated (expanded or collapsed) by a control unit independently. As shown in FIG. 20B, outer shell 14100 can include a mating set of fastener portions 15120. This mating set of fastener portions can be fastened together to secure treatment delivery component 15020 around the shoulder of the user.

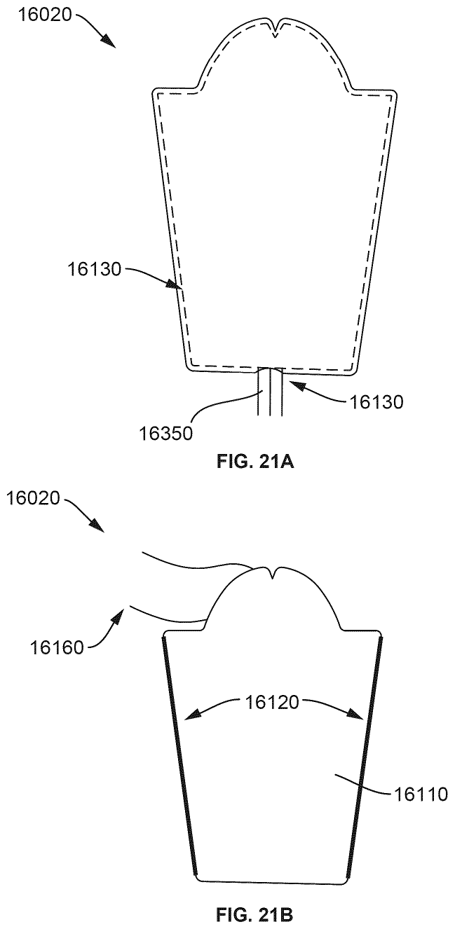

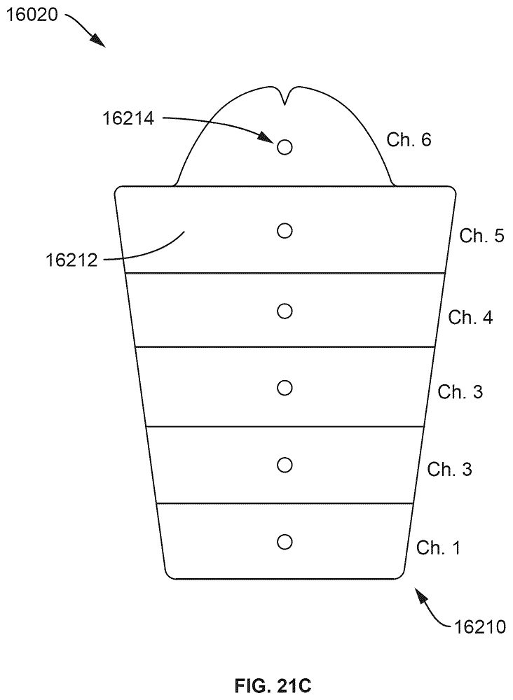

A treatment delivery component configured for application to an arm of a user is shown in FIGS. 21A to 21C. Treatment delivery component 16020 is constructed with an integrated outer shell, pressure applicator, and liner, which can receive a thermal delivery component. For ease of illustration, not all elements of these components are specifically identified in the figures. Body portion 16110 defines with pressure applicator 16210 and/or liner (not separately shown) a liner pocket into which thermal applicator 16310 (shown in dashed lines in FIG. 20A, disposed in liner pocket 15520) can be disposed, and thermal conduit 16350 can be disposed through passage 16130.

As shown in FIG. 21C, pressure applicator 16210 includes six pressure elements 16212 (also labeled as chambers, or Ch. 1 to Ch. 6), each of which includes a pressure port 16214 to each of which a fluid passage of a pressure conduit (not shown) can be coupled, as described above for other embodiments. As with other embodiments, each pressure element 16212 can be actuated (expanded or collapsed) by a control unit independently. As shown in FIG. 21B, outer shell 16100 can include a mating set of fastener portions 16120 (e.g., zippers). This mating set of fastener portions can be fastened together to secure treatment delivery component 16020 around the arm of the user. Treatment delivery component 16020 can further be secured to the user's body with straps 16160, which may be secured around the user's chest.

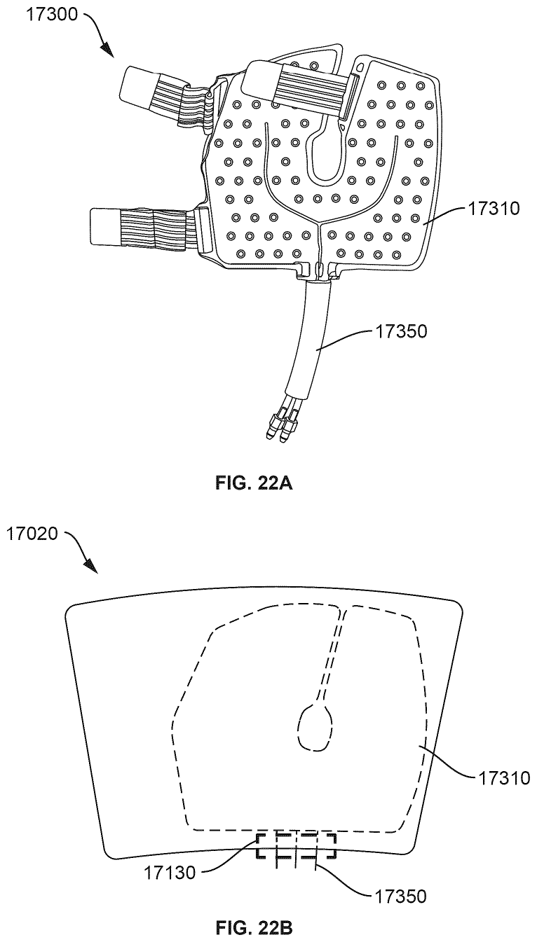

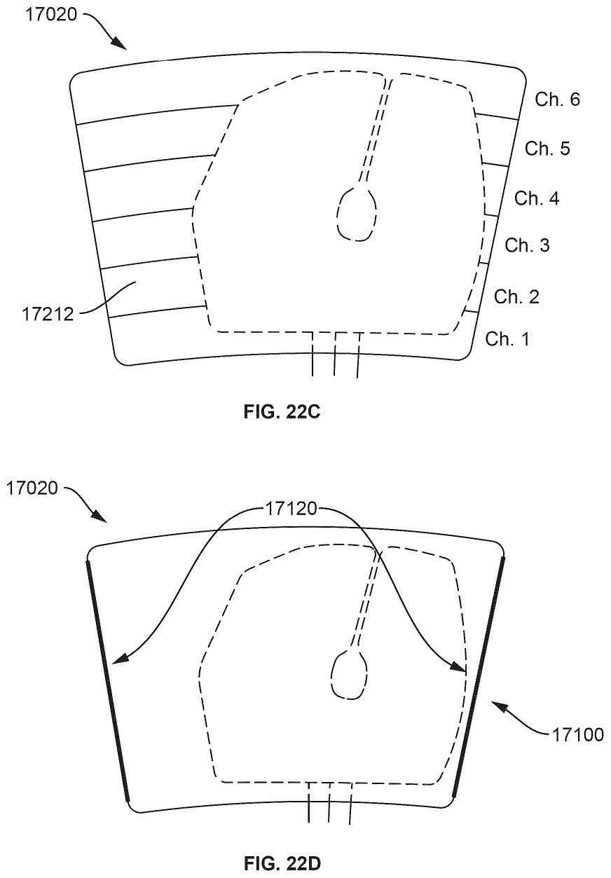

A treatment delivery component configured for application to a knee of a user is shown in FIGS. 22A to 22D. Treatment delivery component 17020 is constructed with an integrated outer shell, pressure applicator, and liner, which can receive a thermal delivery component. For ease of illustration, not all elements of these components are specifically identified in the figures. Body portion 17110 defines with pressure applicator 17210 and/or liner (not separately shown) a liner pocket into which thermal applicator 17310 (shown in FIG. 22A and dashed lines in FIG. 22B) can be disposed, and thermal conduit 17350 can be disposed through passage 17130.

As shown in FIGS. 22C and 22D, pressure applicator 17210 includes six pressure elements 17212 (also labeled as chambers, or Ch. 1 to Ch. 6). As with other embodiments, each pressure element 14212 can be actuated (expanded or collapsed) by a control unit independently. As shown in FIG. 22D, outer shell 14100 can include a mating set of fastener portions 17120, which can be fastened together to secure treatment delivery component 17020 around the knee of the user.

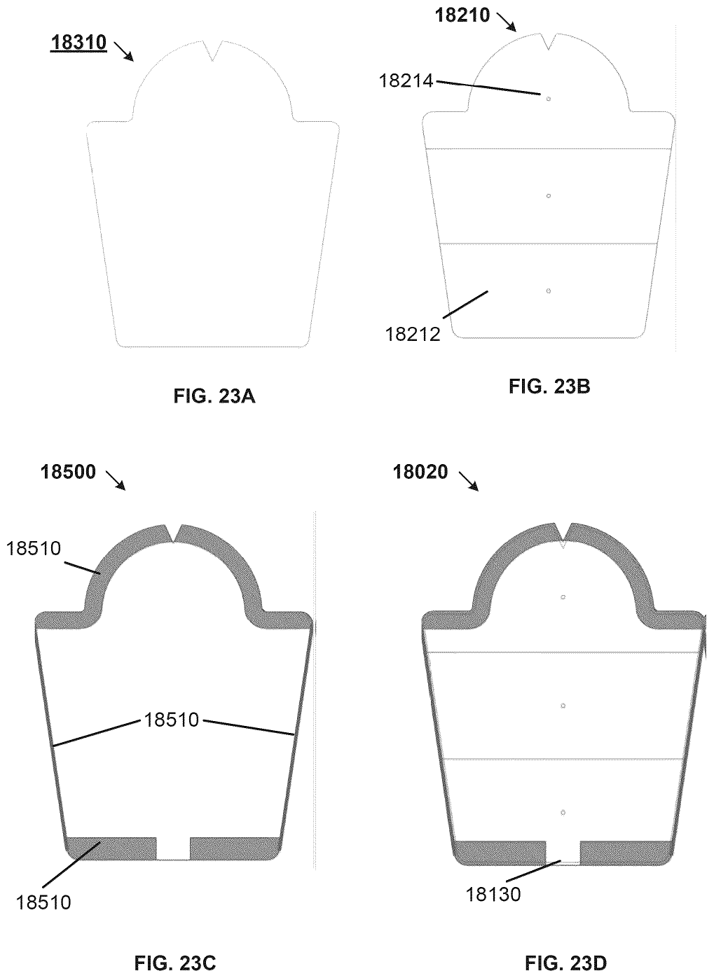

A treatment delivery component configured for application to an arm of a user is shown in FIGS. 23A to 23D. Treatment delivery component 18020 includes a thermal applicator 18310 (FIG. 23A), a pressure applicator 18210 (with three pressure elements 18212 and respective pressure ports 18214, and which also functions as the outer shell for treatment delivery component 18020) (FIG. 23B), and liner 18500 (with liner couplers 18510, e.g., zippers along the lateral edges, and hook and loop fasteners along the top and bottom, by which liner 18500 can be releasable attached to pressure applicator 18210 to form a liner pocket and retain thermal applicator 18310) (FIG. 23C). Treatment delivery component is shown assembled in FIG. 23D, ready to receive a liner. Passage 18130 is also shown in FIG. 23D.

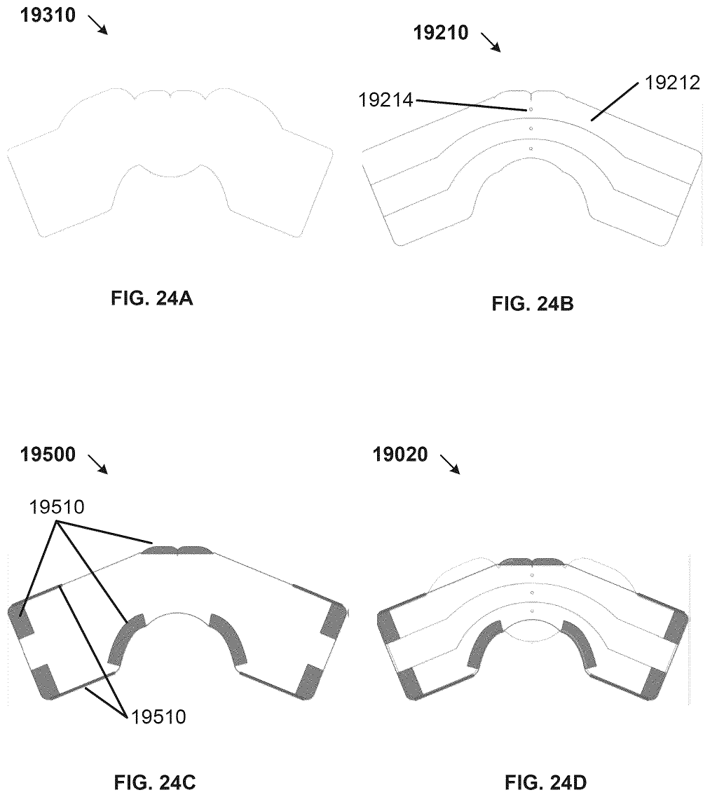

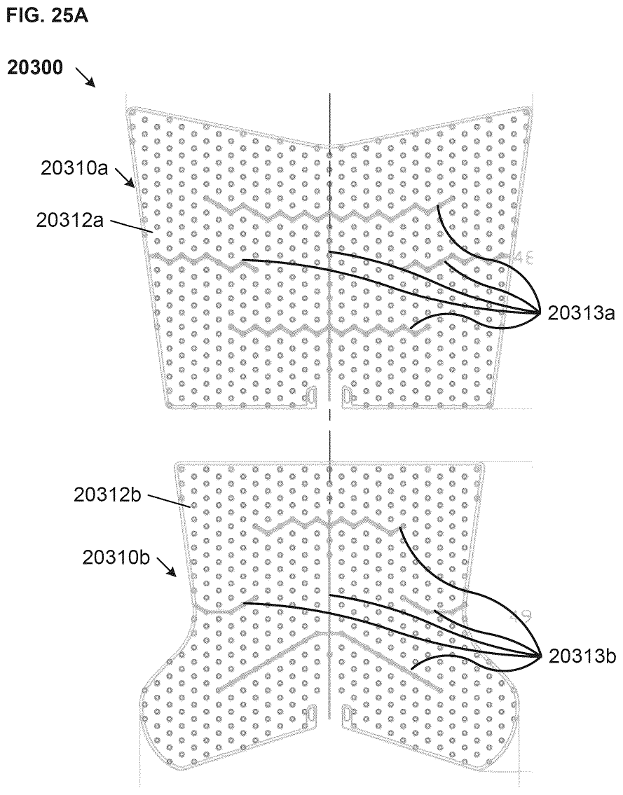

A treatment delivery component configured for application to a torso of a user is shown in FIGS. 24A to 24D. Treatment delivery component 19020 includes a thermal applicator 19310 (FIG. 24A), a pressure applicator 19210 (with three pressure elements 19212 and respective pressure ports 19214, and which also functions as the outer shell for treatment delivery component 19020) (FIG. 24B), and liner 19500 (with liner couplers 18910, e.g., zippers along the lateral edges, and hook and loop fasteners along the top and bottom, by which liner 19500 can be releasable attached to pressure applicator 19210 to form a liner pocket and retain thermal applicator 19310) (FIG. 24C). Treatment delivery component is shown assembled in FIG. 24D.

In other embodiments, a treatment delivery component could be configured for application to the head of a user. Such an embodiment could be a head cap (which could be circular or oval) with a thermal applicator and a pressure applicator, with a circumferential attachment of the thermal applicator pad to part of the head such as the forehead. The thermal applicator could curve upward and overlap the margin of the pressure applicator so that when the pressure applicator is actuated, the thermal applicator is stretched out and tightened against the head.

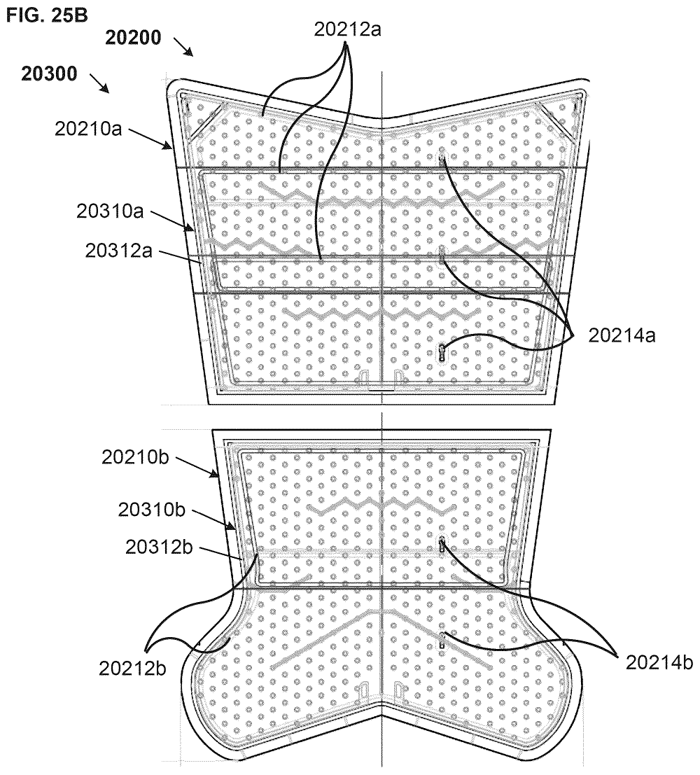

In some embodiments, a treatment delivery component can be configured or provided as two physically separate pieces, segments, portions, parts, or components for providing treatment to two adjacent portions of a user's body. For example, FIG. 25A is an illustration of a thermal delivery component 20300 that includes first thermal delivery applicator 20310a configured for use with an upper leg of a user such as a thigh of a user, and a second thermal delivery applicator 20310b configured for use with a lower leg and foot of the user, which may be included in a treatment delivery component, according to an embodiment. While not shown, the treatment delivery component that includes the thermal delivery applicators 20310a and 20310b can also include one or more pressure delivery components, outer shell(s), liner(s), thermal delivery conduits, other treatment delivery components, and/or any other component as previously described herein.

In this embodiment, the first thermal applicator 20310a and the second thermal applicator 20310b are implemented with a first thermal element 20312a and a second thermal element 20312b, respectively, each of which may include a flexible pad formed by fusing or otherwise securing two layers of polymer or other material together around their perimeter (defining the edges of thermal elements 20312a, 20312b, and enclosing its overall volume) with elongate fused portions defining flow diverters 20313a, 20313b that can direct the flow of fluid though thermal elements 20312a, 20312b. The two layers can also be fused together at numerous small diameter spots to keep the pad relatively thin, rather than ballooning up when fluid is forced into and through it, and to more uniformly distribute the flow of thermal fluid through the interior of thermal elements 20312a, 20312b. Thermal fluid can be introduced into, and withdrawn from, the interior of thermal elements 20312a, 20312b via corresponding thermal conduits (not shown), which can include one or more passages, for example, two fluid passages—one to introduce the thermal fluid and one to withdraw the thermal fluid.

The first thermal applicator 20310a is configured to be worn, secured, mounted, or otherwise used with an upper leg of a user's body, for example, a thigh (including quadriceps and/or hamstring muscles). The second thermal applicator 20310b is configured to be worn, secured, mounted, or otherwise used with a lower leg of the user's body, for example, a shin and/or calf, and a foot (ankle and foot) of the user's body. Different from the thermal applicator 5310 previously described herein, the second thermal applicator 20310b is shaped, sized, or contoured such that in an operating position of the second thermal applicator 20310b or in use when the second thermal applicator 20310b is disposed on lower leg of the user's body, a portion of the second thermal applicator 20310b is disposed on, wrapped around, or otherwise in contact with at least a portion of the foot of the user. In this manner, the second thermal applicator 20310b can provide thermal treatment to the foot of the user in addition to the calf and/or shin of the user.

One or more pressure delivery components can be included in the treatment delivery component including the thermal delivery component 20300. For example, FIG. 25B is an illustration of a pressure delivery component 20200 including a first pressure applicator 20210a with the first thermal applicator 20310a disposed thereon, and a second pressure applicator 20210b with the second thermal applicator 20310b disposed thereon, according to an embodiment. For example, the thermal applicators 20310a, 20310b, may be coupled the pressure applicators 20210a, 20120b, respectively via fasteners (e.g., buttons, pins, hook and loop fasteners, or any other fastener described herein), disposed in a liner pocket formed by a liner (e.g., any of the liners previously described herein), coupled to an outer shell, or otherwise secured proximate to the corresponding pressure applicator 20210a, 20210b.

In this embodiment, the first pressure applicator 20210a includes three pressure elements 20212a, and each implemented as an expandable bladder. The second pressure applicator 20210b includes two pressure elements 20212b also implemented as pressure bladders. The first pressure elements 20212a and the second pressure elements 20212b include first pressure ports 20214a and second pressure ports 20214b, respectively, through which pressurized fluid can be introduced into pressure elements 20212a, 20212b to change it from a collapsed configuration to an expanded configuration, and to increase its pressure, and from which pressurized fluid can be released or withdrawn to reduce its pressure and to change it from an expanded configuration to a collapsed configuration. As previously described, the pressurize fluid can be gas (e.g., air) or fluid. Although not shown in FIG. 25B, each pressure port 20214a, 20214b can be fluidically coupled to a respective fluid passage of a pressure conduit (e.g., the pressure conduit 5250), and thus to a pressure source (e.g., pressure source 1600). As shown in FIG. 25B, an edge portion of one pressure element 20212a, 20212b may overlap a corresponding edge of an adjacent pressure element 20212a, 20212b. This implementation may allow the pressure applicators 20210a, 20210b to deliver therapeutic pressure over the entire surface of the treatment portion of the user's body (e.g., the upper leg, or lower leg and foot) without any gaps that can occur when there is a seam or break between adjacent pressure elements 20212a, 20212b. Moreover, such an implementation may enable smoother transition between adjacent pressure elements 20212a, 20212b when pressure is delivered sequentially to the corresponding treatment portion, as well as provide better thermal apposition to the thermal elements 20312a, 20312b.

Having a treatment delivery components that includes two physically separate portions may facilitate coupling of the respective portions, for example, a first portion that include the first thermal applicator 20310a and first pressure applicator 20210a, and a second portion that includes the second thermal applicator 20310b and the second pressure applicator 20210b, to corresponding treatment portions. For example, the first portion can be facilely worn on the upper leg, and the second portion can be facilely worn on the lower leg and foot. Thus, a user who may find it difficult to wear a single piece treatment delivery component on an upper and lower leg that may require assistance of another person, the user can wear the two portions separately without assistance. Moreover, a portion of the user's body that may not be a target for the therapeutic regimen (e.g., the knee and/or back of the knee) can be excluded from the therapeutic regimen as the first portion and second portion may be sized such that a gap corresponding to the user's knee is present between the two portions when the two portions are properly worn, disposed, or otherwise engaged with the user's upper leg, and lower leg and foot.

In some embodiments, thermal conduits may be coupled to the first thermal applicator 20310a, and the second thermal applicator 20310b (e.g., on opposite sides of central flow diverter), for circulating heating fluid through the volume of the respective thermal applicators 20310a, 20310b. In some embodiments, the thermal conduit of each of thermal applicators 20310a, 20310b may be coupled together via a fluidic coupler (e.g., a t-connector or y-connector) into a single conduit that couples to a thermal connector (e.g., the thermal connector 5360). Similarly, the pressure connectors of each of the first pressure applicator 20210a and the second pressure applicator 20210b maybe coupled to a single pressure connector (e.g., the pressure connector 5260) In this manner, both the thermal delivery components 20310a, 20310b, and the pressure delivery components 20210a, 20210b can be coupled to the same controller (e.g., the control unit 5040). In other embodiments, each of the first and second pressure delivery components, may include separate pressure connectors that may shaped or sized such that each one of them can be coupled individually or simultaneously to the controller, thus providing a user flexibility in using one or both portions of the treatment delivery component as desired. In still other embodiments, each of the first and second pressure delivery components, may include separate pressure connectors that may shaped or sized such that each one of them can be coupled one at a time to the controller, for example, when the pressure applicators 20210a, 20210b, and thermal applicators 20310a, 20310b are included in separate treatment delivery components.

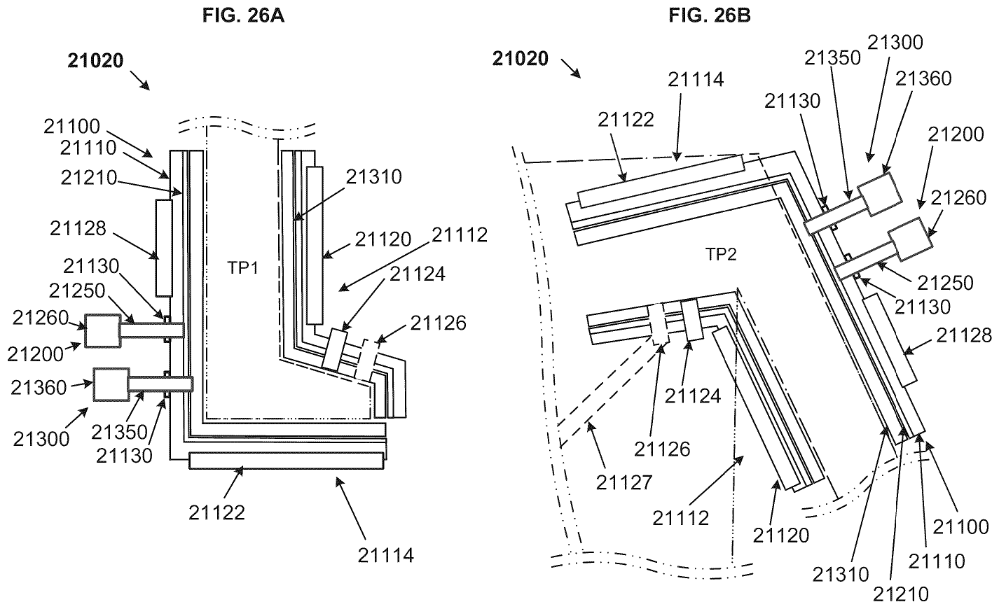

In some embodiments, a treatment delivery component may be reconfigurable for use on different treatment portions of a user's body. For example, FIG. 26A is an illustration of a treatment delivery component 21020 configured for use with a first treatment portion TP1 of a user's body, and FIG. 26B is an illustration of the treatment delivery component 21020 reconfigured for use with a second treatment portion TP2 of a user's body that is different from the first treatment portion TP1, according to an embodiment. In some embodiments, the first treatment portion TP1 includes a lower leg and foot of the user, and the second treatment portion TP2 includes an upper arm and deltoid or shoulder of the user. In such embodiments, the treatment delivery component 21020 may include a first portion 21112 and a second portion 21114 extending at a non-zero angle from the first portion 21112. The treatment delivery component 21020 may be reconfigurable between a first configuration and a second configuration. In the first configuration, the treatment portion is the first treatment portion TP1 that can include a lower leg of the user's body, the first portion 21112 can be disposed on a calf and shin of the user's body, and the second portion 21114 can be disposed on a foot of the user's body as shown in FIG. 26A. In the second configuration, the treatment portion is the second treatment portion TP2 that includes an upper arm and deltoid of the user's body, the first portion 21112 can be disposed on an upper arm of the user's body, and the second portion 21114 can be disposed on a deltoid of the user's body.

Treatment delivery component 21020 is configured to be releasably secured to the first treatment portion TP1 or a second treatment portion TP2 of the user's body to whom treatment is to be delivered by a treatment system in which treatment delivery component 21020 is included. Treatment delivery component 21020 may include an outer shell 21100 such that the first portion 21112 includes a first portion of the outer shell 21100, and the second portion 21114 includes a second portion of the outer shell 21100. The outer shell 21100 can enclose, cover, and/or support one or more of the other components or subsystems of treatment delivery component 21020, and maintain them in operative position with respect to a treatment portions TP1 or TP2 of a user body to which treatment is to be delivered. The components or subsystems can include one or more of a pressure delivery component 21200, and thermal delivery component 21300. While not shown, treatment delivery component 21020 may also include other treatment delivery components, a liner, and one or more sensors, as previously described. In some embodiments, the pressure delivery component 21200 may be coupled to the outer shell 21100, and the thermal delivery component 21300 may be releasably coupleable to one or more of the outer shell 21100 and the pressure delivery component 21200.

As noted above, outer shell 21100 can enclose, cover, and/or support one or more of the other components or subsystems of treatment delivery component 21020, and maintain them in operative position with respect to treatment portion TP1 or TP2 of the user body to which treatment is to be delivered. The outer shell 21100 can define one or more passages 21130 through which components of the treatment delivery component 21020 may be disposed (e.g., a pressure conduit 21250 and/or a thermal conductor 21350). The outer shell 21100 includes a first portion 21112 configured to a disposed on a first segment or region of the first treatment portion TP1 or second treatment portion TP2, and the second portion 21114 extending from the first portion and configured to be disposed on a second segment or region of the first treatment portion TP1 or the second treatment portion TP2, as described in detail. In some embodiments, the first portion 21112 can form a first tubular segment and the second portion 21114 can form a second tubular segment extending at the non-zero angle from the first tubular segment. In operation, the first portion 21112 can be closed edge to edge in the first configuration around a first segment of the first treatment portion TP1, for example, the calf and shin of the user's body as shown in FIG. 26A, and can be closed edge to edge in the second configuration around a first segment of the second treatment portion TP1, for example, the upper arm of the user's body. Moreover, the second portion 21114 can be closed edge to edge on a first and second side thereof in the first configuration around a second segment of the first treatment portion TP1, for example, the foot of the user's body, and can be open on at least one edge in the second configuration to be disposed on a second segment of the second treatment portion TP2, for example, a deltoid or shoulder of the user's body. In some embodiments, a section(s) of the second portion 21114 may also be disposed on at least a portion of a pectoral muscle and a trapezius of the user's body.

As shown schematically in FIGS. 26A and 26B, outer shell 21100 may have a body portion 21110, a first fastener portion 21120 coupled to and disposed on a first side of the first portion 21112 of the body portion 21110 (e.g., the side in front of a shin of the user in the first configuration), a second fastener portion 21122 coupled to and disposed on a first side of the second portion 21114 (e.g., the side in front of the sole of the user in the first configuration), a third fastener portion 21124 coupled to and disposed on second side of the second portion 21114 opposite the first side of the second portion 21114 (e.g., in front of the top side of the foot in the first configuration), and optionally a fourth fastener portion 21126 disposed on the second side of the second portion 21124, for example, adjacent the third fastener portion 21124.

The fastener portions 21120, 21122, 21124, and 21126 are operable to secure body portion 21110 to the user's body, for example, the first treatment portion TP1, or the second treatment portion TP2, as described in further detail herein. Body portion 21110 may be formed as a flexible sheet of material, such as fabric. Fastener portions 21120, 21122, 21124, or 21126 may be any suitable fastener that may be secured to one part of body portion 21110 and releasably coupled directly to another part of body portion 21110 (such as by a pin, clamp, hook, etc.) or via a corresponding second fastener portion(s) 21120, 21122, 21124, or 21126 or to a corresponding element of the same fastener portions 21120, 21122, 21124, or 21126 (e.g. fastener portions 21120, 21122, 21124, or 21126 may be a zipper, snap, buckle, hook and loop fastener, etc., with one half secured to one part of body portion 21110 and the mating half secured to another part of body portion 21110).

In some embodiments, the first fastener portion 21120 and the second fastener portion 21122 may include a zipper having zipper portions disposed on opposite edges of the corresponding side first portion 21112 or second portion 21114 of the body portion 21110. In some embodiments, the third fastener portion 21124 and the fourth portion 21126 may include a clip or clamp type fastener including mating portions disposed on opposite edges of the second side of the second portion 21114. In some embodiments, the third fastener portion 21124 and/or the fourth fastener portion 21126 may include also include an adjustable belt or strap coupled to a clip or clamp. In some embodiments, the third fastener portion 21124 may include a first belt or strap having a first length, and the fourth fastener portion 21126 may include a body engagement element 21127 (e.g., a second belt or strap) having a second length that is substantially longer than the first length. The length of the body engagement element 21127 of the fourth fastener portion 21126 may be adjustable to allow body engagement element 21127 to secure the body portion 21120 to a user's body when it's being used on the first treatment portion TP1 or the second treatment portion TP2, as described in further detail herein.

Body portion 21110 may have a geometry and dimensions that are appropriate to fit to the first treatment portion TP1 or the second treatment portion TP2. For example, in the first configuration shown in FIG. 26A, the first treatment portion TP1 includes a lower leg of the user with the first portion 21112 disposed on and wrapped around the calf and shin of the user, and the second portion 21114 secured to the foot of the user. In some embodiments, each of the first fastener portion 21120 and the second fastener portion 21124 may be engaged in the first configuration. For example, the first fastener portion 21120 may include a zipper (e.g., zipper portions disposed on corresponding opposing edges of the first portion 21112) which couples one part of the first portion 21112 to a second part of the first portion 21112. In this manner, the first portion 21112 can be secured around the user's calf and shin such that the first fastener portion 21120 is configured to be disposed in front of a shin of the user in the first configuration. In other words, in the first configuration, the first fastener portion 21120 can close edges of the first side of the first portion 21112 to cause the first portion 21112 to be wrapped around the calf and shin of the user's body. The second fastener portion 21122 may also include a zipper (e.g., zipper portions disposed on corresponding opposing edges) coupling one part of the first side of the second portion 21114 to a second part of the first side of the second portion 21114. The first side of the second portion 21114 may be located below the foot of the user in the first configuration, i.e., in front of a sole of the foot of the user, such that engaging the second fastener portion 21124 in the first configuration at least partially secures the second portion 21114 around the foot of the user. For example, the second fastener portion 21122 may close opposing edges of the first side of the second portion 21112 to facilitate wrapping of the second portion 21114 around the foot of the user's body.

The third fastener portion 21124 may be engaged in the first configuration to be able to at least partially close opposing edges of the second side of the second portion 21114 to facilitate wrapping of the second portion 21114 around the foot of the user's body in the first configuration. Moreover, the fourth fastener portion 21126 may be engaged in the first configuration to be able to at least partially close corresponding edges of the second side of the second portion 21114 to facilitate wrapping of the second portion 21114 around the foot of the user's body. In some embodiments, in which third and fourth fastener portions 21124 and 21126 include belts, or straps, such belt or straps may be adjustable to allow accommodation of various foot sizes in the second portion 21114 in the first configuration.

In embodiments, in which the fourth fastener portion 21126 includes the body engagement element 21127, or the body engagement element 21127 is coupled to opposing edges of the second portion or otherwise the body portion 21110, a significant portion of a length of the body engagement element 21127 (e.g., a belt or strap) may be unused in the first configuration. In such implementations, an exterior pocket 21128 may be disposed on an outer surface of the outer shell 21100. For example, the exterior pocket 21128 may be disposed on a portion of the outer shell 21100 that is offset from first side of the first portion 21112 on which the first fastener portion 21120 is disposed. At least a portion of the length of the body engagement element 21127 (e.g., portion that is extending away from the fourth fastener portion 21126) may be disposed in the exterior pocket 21128 during use, so as to prevent obstruction of treatment therapy or prevent tangling of the body engagement element 21127 during use in the first configuration. In some embodiments, edges of the exterior pocket 21128 may be permanently secured to the outer shell 21100, for example, stitched thereto or coupled thereto with an adhesive, and an opening may be provided to access the interior volume defined by the exterior pocket 21128. In some embodiments, a portion of the edges of the exterior pocket 21128 may be releasably coupled to the outer shell 21100 (e.g., via fasteners such as zippers, buttons, clips, clamps, etc.). This may facilitate removal or insertion of the body engagement element 21127 or other portions of the treatment delivery component 21020 in the exterior pocket 21128 by selectively opening or closing the exterior pocket 21128.

In the second configuration shown in FIG. 26B, the second treatment portion TP2 may include an upper arm and deltoid or shoulder of the user's body with the first portion 21112 disposed on and secured to the upper arm of the user, and the second portion 21114 secured to the deltoid or shoulder of the user. In the second configuration, the first fastener portion 21120 that may include a zipper, is engaged so that it can close edges of the first side of the first portion 21112 to wrap the first portion 21112 around the upper arm of the user's body such that the first fastener portion 21120 is disposed between the upper arm and torso of the user. However, the second fastener portion 21122 is disengaged in the second configuration, for example, the opposing portions of the zipper are disengaged. This can cause opposing edges of the second portion 21114 to be located distal from each other such that segments of the second portion 21114 can be disposed on the deltoid or shoulder, as well as on portions of the pectoral muscle and trapezius of the user's body.

In the second configuration, the third portion may be engaged to at least partially close edges of the second side of the second portion 21114 to facilitate wrapping of the first portion 21112 around the upper arm of the user's body. For example, the third fastener portion 21124 may be engaged to close edges of a portion of the second side of the second portion 21114 that is located below an arm pit of the user. This portion of the second portion 21114 may be proximate to the first side of the first portion 21112 where the first fastener portion 21120 is located, and engaging the third fastener portion 21124 may facilitate maintaining the first fastener portion 21120 in the engaged position in the second configuration, for example, by preventing a stretch force from acting on the first fastener portion 21120 due to the portion of the second portion 21114 being mainly open around the user's torso.

In some embodiments, the fourth fastener portion 21126 is either disengaged or engaged in the second configuration such that corresponding edges of second side of the second portion 21114 are open to enable the second portion 21114 to be disposed on the deltoid of the user's body. Expanding further, in some embodiments, the body engagement element 21127 (e.g., a belt or strap) may be disposed around the user's torso to secure the second portion 21114 on the deltoid of the user. In some implementations, the body engagement element 21127 is separate from the fourth fastener portion 21126 and is coupled to the body portion 21110. In such implementations, the fourth fastener portion 21126 may remain disengaged in the second configuration. In some implementations, the body engagement element 21127 is included in the fourth fastener portion 21126. In such implementations, the fourth fastener portion 21126 is engaged by coupling the body engagement element 21127 to opposing edge segments of the fourth fastener portion 21126 and disposing a portion of the body engagement element 21127 around the user's torso. The length of the body engagement element 21127 may be adjustable to allow the user to tighten the body engagement element 21127 around the user's torso for securing the second portion 21114 on the user's deltoid in the second configuration.

As described with respect to the treatment delivery component 21020 and other treatment delivery components described herein, outer shell 21100 is configured to enclose and/or support the other subsystems of treatment delivery component 21020 and to hold them in position around and/or against the first or second treatment portion TP1 or TP2 of user body.

In addition, outer shell 21100 may include one or more openings or passages 21130 through which one or more components of the other subsystems may pass, e.g., from the interior of the outer shell 21100 in its closed configuration to the exterior of outer shell 21100, e.g., to enable the component(s) of the other subsystem(s) to couple with a control unit (e.g., 1040, or 5040) and/or to be accessed by the user.

Pressure delivery component 21200 may be operated to provide either or both of two functions: a) it may be operated to selectively deliver pressure treatment or therapy to the treatment portions TP1 or TP2 of user's body; and/or b) it may be operated to interface with outer shell 21100 and one or both of thermal delivery component 21300 and other treatment delivery component to enhance the effectiveness of those components. Pressure delivery component 21200, also illustrated schematically in FIGS. 26A and 26B, may include a pressure applicator 21210, pressure connector 21260 configured to be releasably coupleable to a pressure source, and pressure conduit 21250 coupled between pressure connector 21260 and pressure applicator 21210. Thus, pressure applicator 21210 may apply to first or second treatment portions TP1 or TP2 of user body pressure supplied by pressure source via pressure connector 21260 and pressure conduit 21250.

As shown schematically in FIGS. 26A and 26B, as with outer shell 21100, pressure applicator 21210 may have a geometry and dimensions that are appropriate to fit to the first or second treatment portions TP1 or TP2 to which treatment delivery component 21020 is to be applied, for example, may have a length dimension L sufficient to extend over an appropriate length of user lower leg from below know to the phalanges of the foot, as well disposed around upper arm such that second portion 21114 is disposed on the user's deltoid. Correspondingly, pressure applicator 21210 may have a width or circumferential dimension W sufficient to extend around the user's lower leg and foot, or upper arm. In various embodiments, pressure (i.e., positive gauge pressure, higher than ambient, atmospheric pressure) may be provided in the form of pressurized fluid, e.g., pneumatic pressure, from pressurized gas or hydraulic pressure from pressurized liquid, supplied by pressure source, as previously described herein.

Pressure applicator 21210 may include one or more pressure elements, which may be volumes, cavities, spaces, or other enclosed portions that may receive the pressurized fluid. In some embodiments, the pressure applicator 21210 may be substantially similar to the pressure applicator 20210b and therefore, not described in further detail herein.

The pressurized fluid may be conducted from pressure source via pressure conduit 21250, which may be implemented as one or more tubes or pipes of suitable internal diameter to convey the requisite volumetric flow rate of pressurized fluid to cause the pressure applicator 21210 to change from its unpressurized configuration to its pressurized configuration within a desired amount of time, and of appropriate construction to withstand or contain the maximum pressure at which pressurized fluid is to be provided by pressure source.

In some embodiments, pressure applicator 21210 may be disposed inside outer shell 21100, and with pressure conduit 21250 extending from pressure applicator 21210 through a passage 21130. While passage 21130 is shown as provided in a back side of the first portion 21112 opposite the first side of the first portion 21112, in other embodiments, the passage 21130 may be provided elsewhere, for example, at a base of second portion 21114 that is faces the heel the of user's foot in the first configuration. Pressure applicator 21210 is shown in FIGS. 26A and 26B in its unpressurized configuration, with a relatively small thickness, but can be pressurized to have a relatively larger thickness, and be constrained by outer shell 21100, as previously described with respect to various embodiments of pressure applicators herein.

In some embodiments pressure applicator 21210 can be releasably coupled to outer shell 21110 (by any suitable mechanism, such as buckles, zippers, hook and loop fasteners, etc.) or may be fixedly coupled to outer shell 21100 (such as by stitching, stapling, welding, gluing, etc.). The pressure applicator 21210 may encompass substantially the entire circumference of first or second treatment portion TP1 or TP2, or conversely, may cover only a portion of the circumference of first or second treatment portions TP1 or TP2, as previously described (e.g., only a calf, only sole of the foot, or only a bicep or a triceps of the user).

Thermal applicator 21310 may be operated to exchange thermal energy with the first or second treatment portions TP1 or TP2 in either or both of two thermal treatment modes—heating and/or cooling. Thermal applicator 21312 may have one or more thermal elements, thermal connector 21360 releasably coupleable to thermal source (e.g., thermal source 1700), and thermal conduit 21350 coupled between thermal connector 21360 and thermal applicator 21310. Thus, thermal applicator 21310 may deliver to, or receive from, first or second treatment portion TP1 or TP2, thermal energy supplied by, or withdrawn by, thermal source via thermal connector 21360 and thermal conduit 21350. As shown schematically in FIG. 26A, as with outer shell 21100 and pressure applicator 21210, thermal applicator 21310 may have a geometry and dimensions that are appropriate to fit the first treatment portion TP1 as well as the second treatment portion TP2, for example, may have a length dimension L sufficient to extend over an appropriate length of user lower leg from below know to the phalanges of the foot, as well disposed around upper arm such that second portion 21114 is disposed on the user's deltoid. Correspondingly, thermal applicator 21310 may have a width or circumferential dimension W sufficient to extend around the user's lower leg and foot, or upper arm. In some embodiments, the thermal applicator 21310 may be substantially similar to the thermal applicator 20310b described with respect to FIGS. 25A and 25B.

Thermal energy may be delivered to, and/or withdrawn from, treatment portions TP1 or TP2 by thermal applicator 21310 through any of a variety of mechanisms, as previously described herein.

Thermal conduit 21350 can also be implemented in many different ways, appropriate to the corresponding implementations of thermal source and thermal applicator 21310, to provide a path for energy to move between thermal source and thermal applicator 21310, in a single direction or bi-directionally (depending on whether the particular implementation of thermal source is as a source, sink, or both source and sink for thermal energy), as previously described.

For ease of illustration, treatment delivery component 21020 is shown only with thermal applicator 21310, pressure applicator 21210, and outer shell 21100, but can also include any other subsystem as previously described. Outer shell 21100 is shown disposed about a first treatment portion TP1 (FIG. 26A) or second treatment portion TP2 (FIG. 26B) in a closed configuration. Pressure applicator 21210 is disposed inside outer shell 21100, and with pressure conduit 21250 extending from pressure applicator 21210 through a passage 21130, and thermal delivery component 21300 is disposed inside outer shell 21100 and pressure applicator 21210, and with thermal conduit 21350 extending from thermal applicator 21310 through another passage 21130. The interaction between thermal conduit 21350 and passage 21130 can aid in maintaining the position of thermal applicator 21310 relative to outer shell 21100, for example, as described with respect to FIGS. 4B and 4C and therefore, not described in further detail. Pressure applicator 21210 may be integrally formed with, or fixedly secured to, body portion 21110, and passage 21130 may therefore be a single opening formed through both structures.

In some embodiments, thermal applicator 21310 can be releasably coupled to outer shell 21110 and/or pressure applicator 21210 (by any suitable mechanism, such as buckles, zippers, hook and loop fasteners, clips, etc.) or may be fixedly coupled to outer shell 21110 and/or pressure applicator 21210 (such as by stitching, stapling, welding, gluing, etc.).

While not shown, treatment delivery component 21020 can also include a liner (e.g., the liner 1500 or any other liner described herein). Treatment delivery component 21020 can be configured so that liner is the only, or substantially the only, portion of treatment delivery component 21020 that contacts the skin of the user, e.g., the skin on the first or second treatment portion TP1 or TP2 of the user, which may be desirable, as previously described. Liner may thus be configured to be releasably coupleable to outer shell 21100, pressure applicator 21210, thermal applicator 21310, and/or other treatment applicator 21410. In other embodiments, liner may be fixedly coupled to one or more of the other components of treatment delivery component 21020.

In some embodiments, liner may be coupled to outer shell 21100, pressure applicator 21210, thermal applicator 21310, and/or other treatment applicator 21410 so as to enclose, support, or otherwise aid in retaining or maintaining in a desired position any one or more of the applicators. For example, liner may be coupled to outer shell 21100 to form a pocket in which thermal applicator 21310 may be releasably disposed, as previously described with respect to liner 1500 or any other liner described herein. In some embodiments, treatment delivery component 21020 can also include one or more sensors (e.g., the sensors 1550) that may be disposed in operative relationship with the first or second treatment portion TP1 or TP2 of the user, or some other portion of the user's body as previously described. Moreover, the treatment delivery component 21020 may also be coupled to a controller (e.g., the controller 1900 or control unit 5040) configured to control operations of the treatment delivery component 21040, as previously described.

The treatment delivery component 21020 may be configured to have the “wasting” functionality as described with respect to treatment delivery component 4020 and FIGS. 10A-10F. For example, when pressure applicator 21210 is in an unpressurized configuration, thermal applicator 21310 may be substantially spaced from the surface of (relatively small) first or second treatment portions TP1 or TP2, and thus not in good thermal apposition to permit effective delivery of thermal treatment. However, when pressure applicator 21210 is in a pressurized configuration, pressure applicator 21210 urges thermal applicator 21310 into a configuration in which at least a portion of the thermal applicator in good apposition with the full circumference of the first treatment portion TP1 in the first configuration, and at least the first portion 21112 is in good apposition with upper arm of user in second configuration, while side portions are approximated or urged together (or towards each other, if there is other structure, such as a liner, between them), and extend radially approximately from the outer surface of treatment portion TP1 or TP2 to their connections to the edges of body portion 21110. Thus, side portions face each other, i.e., the inner surfaces of side portions are adjacent or in contact, and do not overlap each other. The side portions may be considered to be “wasted,” in that they are not in apposition with the surface of treatment portion TP1 or TP2, and thus cannot deliver thermal treatment thereto. However, the remaining portion is in good apposition with treatment portion TP1 or TP2 and can deliver thermal treatment thereto. Thus, the treatment delivery component 21020 may provide the same benefit or advantage associated with wasting as described in detail with respect to treatment delivery component 21020.

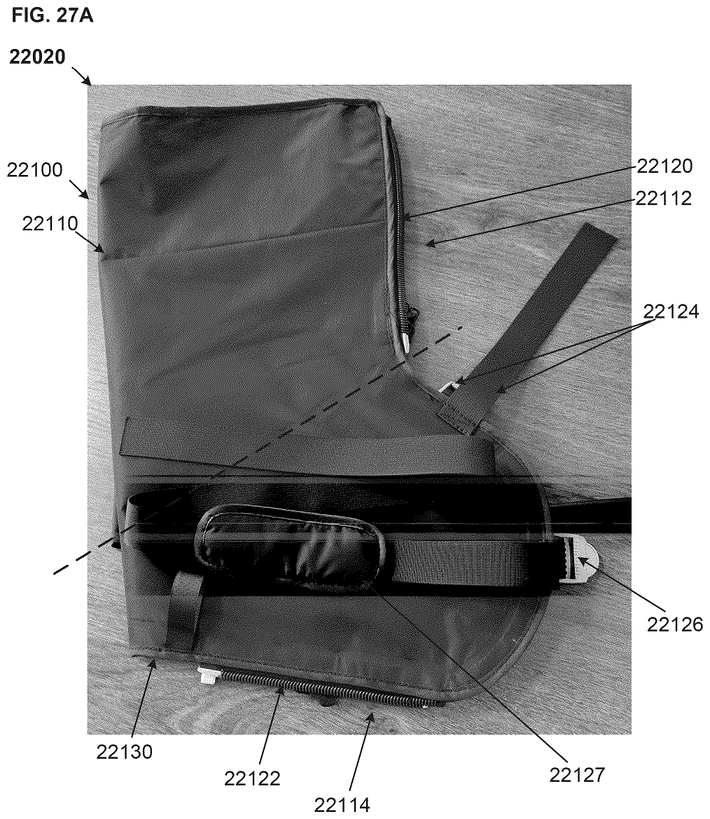

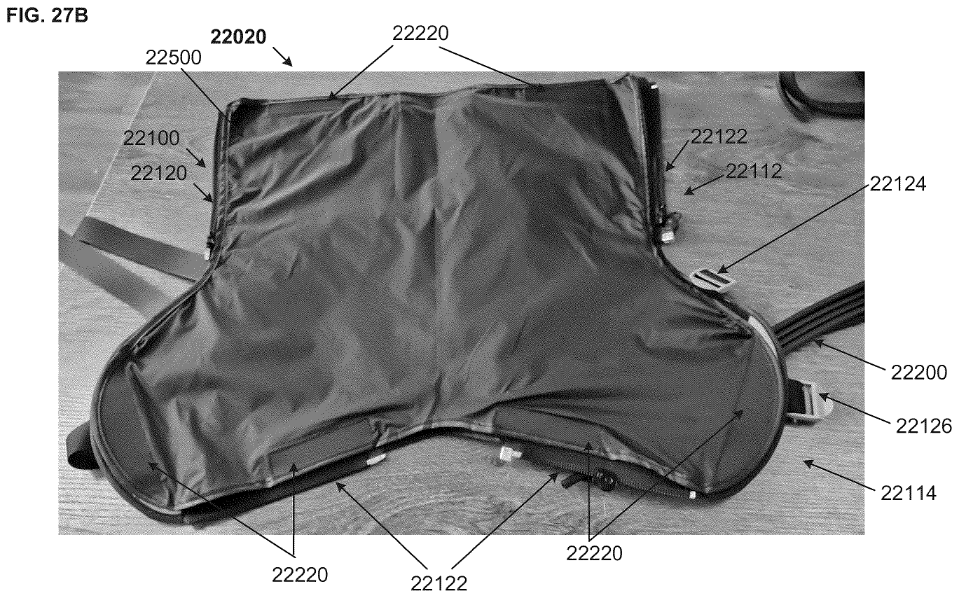

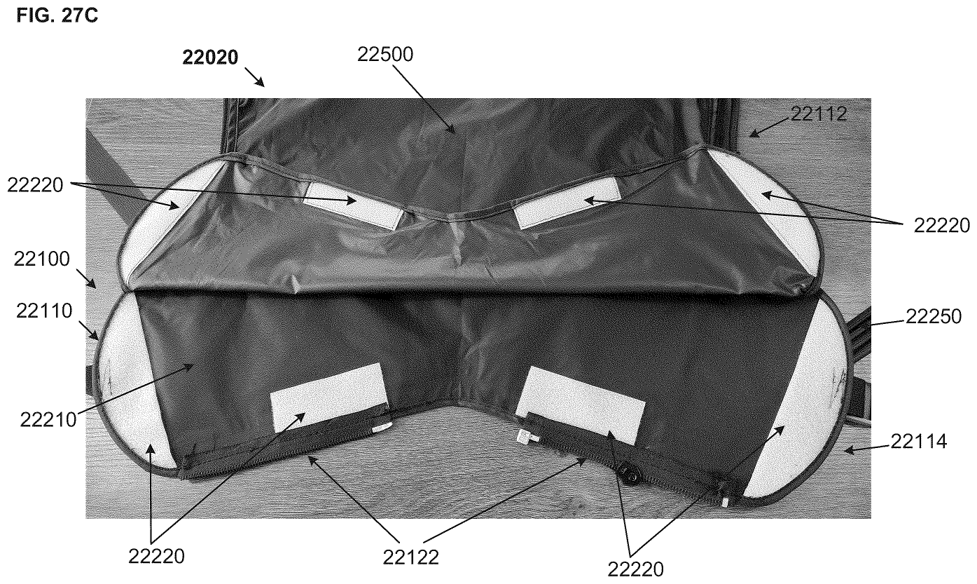

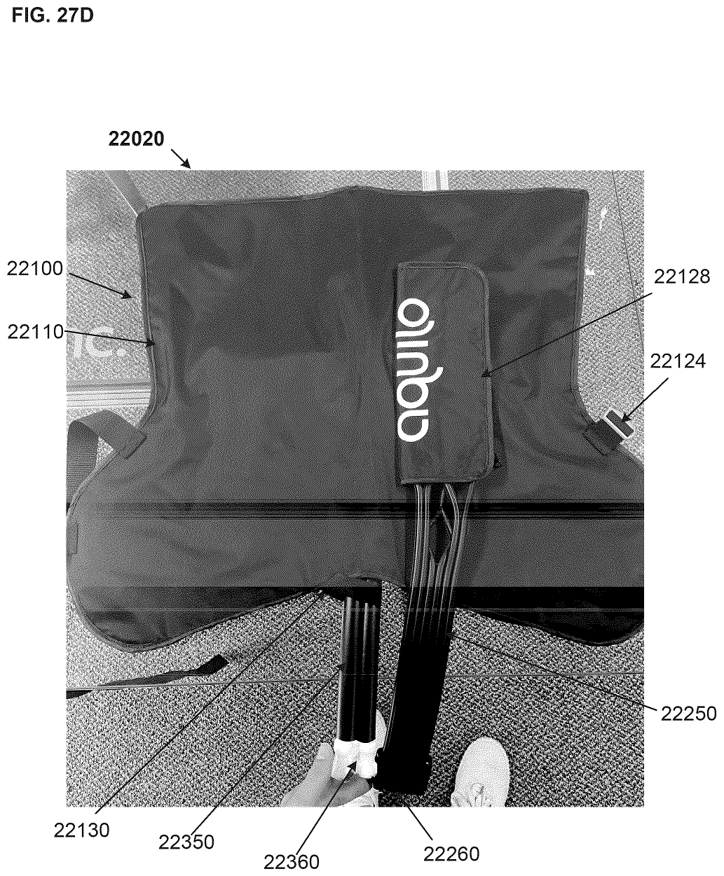

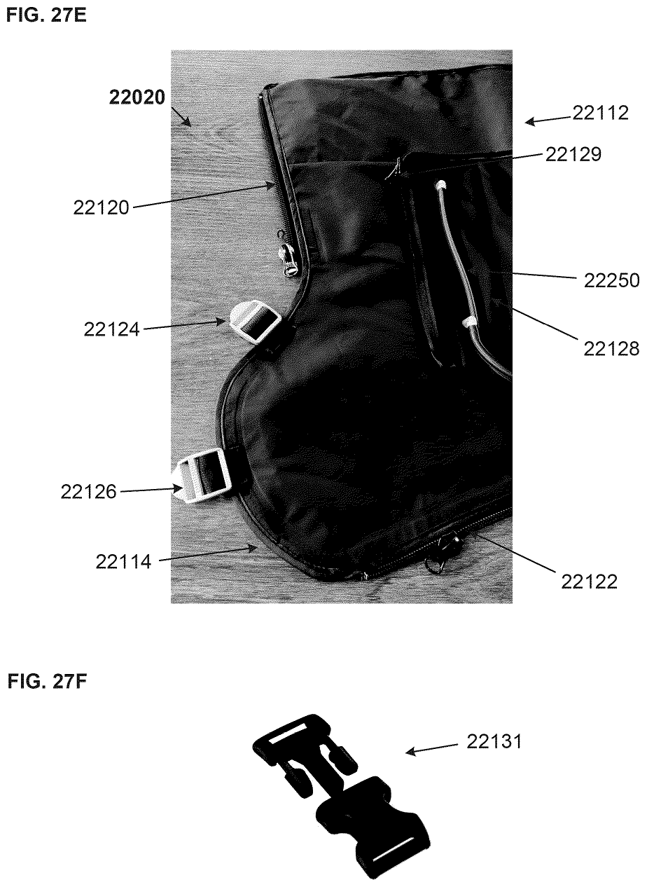

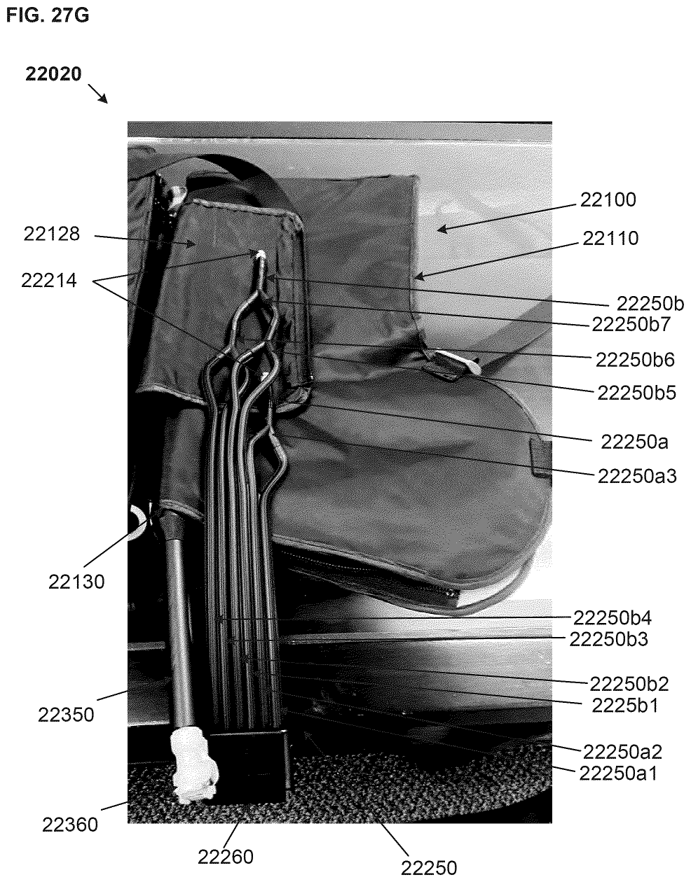

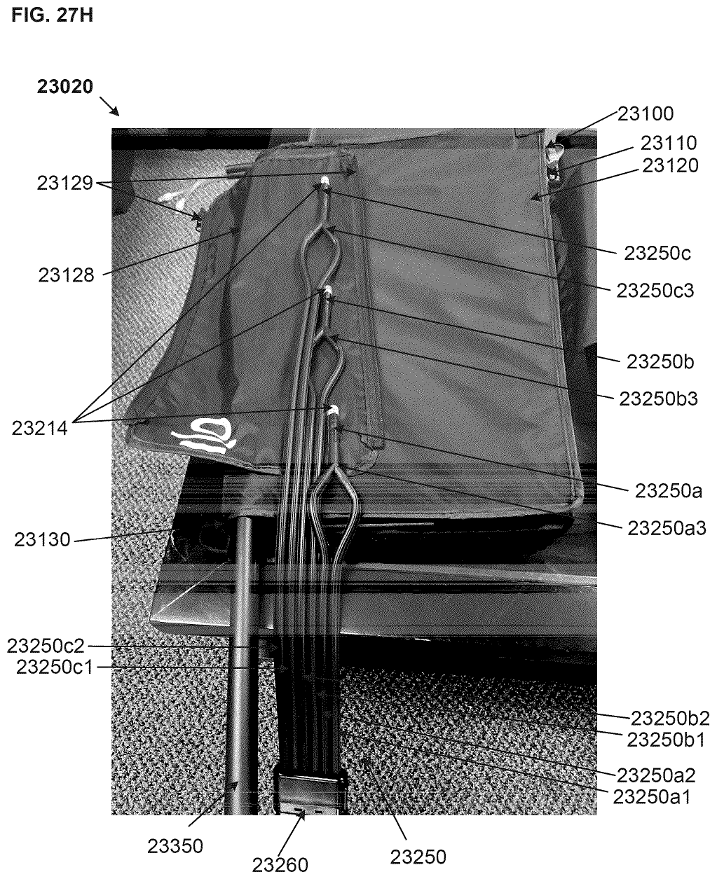

An embodiment of a treatment delivery component 22020 is shown in FIGS. 27A to 27G. In this embodiment, the treatment delivery component 22020 includes a first portion 22112 that is formed as a tube or tubular segment when the first portion 22112 is closed. A second portion 22114 extends at a non-zero angle from the first portion 22112 and is also formed as a tubular segment when the second portion 22113 is closed. The treatment delivery component 22020 is reconfigurable between a first configuration and a second configuration. In the first configuration, the treatment delivery component 22020 is configured treat a lower leg (calf and/or shin) and foot of the user, with the first portion 22112 configured to treat the lower leg and the second portion 22114 configured to treat the foot of the user. In the second configuration, the treatment delivery component 22020 is configured to treat an upper arm (bicep and/or triceps) and deltoid or shoulder (and optionally a portion of the trapezius and/or pectoral muscle) of the user, with the first portion 22112 configured treat the upper arm and the second portion 22124 configured to treat the deltoid of the user.

The boundary between the first portion 22112 and the second portion 22114 is shown with a dashed line in FIG. 27A, but is shown only for ease of reference, and is not a precise boundary.

FIGS. 27A, 27E, and 27G show the treatment delivery component 22020 in a closed configuration in which it can be used with the lower leg and foot of a user. FIGS. 27B-27E show the treatment delivery component 22020 disposed in an open and flat configuration for ease of illustration to display some of components of the treatment delivery component 22020. The treatment delivery component 22020 includes an outer shell 22100, a pressure applicator 22210, a thermal applicator (not shown) that can include, for example, the thermal applicator 20310b, a first fastener portion 22120, a second fastener portion 22122, third fastener portion 22124, a fourth fastener portion 22126, a body engagement element 22127, a liner 22500 a thermal connector 22360, a thermal conduit 22350, a pressure connector 22260, and a pressure conduit 22250.

FIGS. 27A, 27E and 27G show outer shell 22100 that includes a body portion 22110, which includes the first portion 22112 and second portion 22114. Outer shell 22100 also includes first fastener portion 22120 disposed on a first side of first portion 22120, which in this embodiment, is implemented as a zipper, with cooperating portions on each edge of body portion 22110. The first fastener portion 22120 extends from an end of the first portion 22112 that is distal from the second portion 22114 to an approximate boundary between the first portion 22112 and the second portion 22114. The first fastener portion 22120 is configured to be engaged or closed in each of the first and second configurations and to face a shin of the user in the first configuration, and to be disposed between upper arm and torso of user in the second configuration.

Outer shell 22100 also includes second fastener portion 22122 disposed on a first side of the second portion 22114, which in this embodiment, is also implemented as a zipper, with cooperating portions on each edge of body portion 22110. The second fastener portion 22122 extends from proximate to a heel end of the second portion 22114 to an opposing end of the second portion 22114 that is located proximate to the phalanges of the user's foot in the first configuration. The first fastener portion 22120 is configured to be engaged (or closed) in the first configuration and to face a sole of the user's foot, and configured to disengaged or open in the second configuration to be disposed on a deltoid of a user, and may also be disposed on portions of a pectoral muscle and trapezius of a user. For example, the second portion 22114 can be open in the second configuration with segments thereof disposed over the deltoid or shoulder, the pectoral muscle, and trapezius of the user. In some embodiments, the second fastener portion 22122 may be closed in the first configuration before receiving the foot so that the second portion receives the foot of the user by having the foot slid into it, rather than receiving the foot and then being closed around the foot. The first fastener portion 22122 do not extend all the way to the heel end of the first side of the second portion 22122, i.e., where the heel of the user's foot would be disposed, leaving a gap that defines a passage 22130 for the thermal conduit 22350 to be disposed therethrough, as shown in FIGS. 27D and 27G.

Outer shell 22100 includes third fastener portion 22124 disposed on a second side of the second portion 22114 opposite the first side thereof, which in this embodiment, is implemented as an adjustable belt and ladder lock buckle fastener, with cooperating portions on each edge of body portion 22110. As best shown in FIGS. 27A and 27G, the third fastener portion 22124 is disposed proximate to the first fastener portion 22120 so as to close edges of the second side of the second portion 22114 that are proximate to first side of the first portion 22112. In other implementations, the third fastener portion 22131 may include an adjustable belt and snap fit fastener, for example, a side release buckle 22131 shown in FIG. 27F. The third fastener portion 22124 is configured to be engaged (or closed) in the first configuration and to face a top of the user's foot, and may also be configured to be engaged or closed in the second configuration to be disposed proximate to an arm pit of the user. The adjustable belt of the third fastener portion has a first length that may be loosened or tightened as desired to at least partially wrap the second portion 22114 over the user's foot in the first configuration, as well as to facilitate retainment of the first portion 22112 around the user's upper arm in the second configuration.

Outer shell 22100 includes fourth fastener portion 22126 disposed on a second side of the second portion 22114 adjacent to the third fastener portion 22124 and distal from the first fastener portion 22120. In this embodiment, fourth fastener portion 22126 is implemented as an adjustable belt and ladder lock buckle fastener, with cooperating portions on each edge of body portion 22110 similar to the third fastener portion 22124, but may include an adjustable belt and snap fit fastener, for example, the side release buckle 22131. The fourth fastener portion 22126 is configured to close edges of the second side of the second portion 22114 that are distal from the first portion 22112. The fourth fastener portion 22126 is configured to be engaged (or closed) in the first configuration and to face a top of the user's foot, and a length of the belt or strap may be adjusted (loosened or tightened) as needed. In this implementation and best shown in FIG. 27A, the fourth fastener portion 22126 includes a body engagement element 22127 which includes a belt that has a substantially longer length than a length of the belt of the third fastener portion. In the second configuration, the fourth fastener portion 22126 is engaged by the body engagement element 22127 such that the body engagement element 22127 is disposed around a portion of a torso of a user. In this configuration, corresponding edges of the body portion 22110 on which elements of the fourth fastener portion 22126 are disposed are located distal from each other such that one edge is disposed on an anterior portion while the other corresponding edge is disposed on posterior portion of torso of user.

The body engagement element 22127 may facilitate retention of the second portion 22114 and thereby, the treatment delivery component 22022 around the user's deltoid. In other implementations, the body engagement element 22127 may be separate from the fourth fastener portion 22126, for example, include an adjustable belt or strap coupled to the outer shell 22100. In such implementations, the fourth fastener portion 22126 may be disengaged in the second configuration. A significant length of the body engagement element 22127 may remain unused in the first configuration. To prevent entanglement or interference with use of the treatment delivery component 22020 in the first configuration, an exterior pocket 22128 is provided in this implementation on an outer surface of the outer shell 22100 as illustrated in the back view of the treatment delivery component 22020 shown in FIG. 27D. The unused portion of the body engagement element 22127, or the entire body engagement element 22127 may be disposed, tucked, or stowed in the interior volume defined by the exterior pocket 22128 in the first configuration. As shown in FIG. 27E, the exterior pocket 22128 may include exterior pocket fastener 22129 that, in this implementation, is illustrated as a zipper to couple corresponding edges of the exterior pocket 22128, but may include other fasteners (e.g., buttons, clips, hook and loop type fasteners, etc.). The exterior pocket fastener 22129 may facilitate opening or closing of the exterior pocket 22128 for disposing or removing the body engagement element 22127 inside the exterior pocket 22128. In some implementations, portions of the pressure conduit 22250 may also be disposed within the exterior pocket 22128 as shown in FIG. 27E.

FIGS. 27B-27C show outer shell 22100 and pressure applicator 22210. In this embodiment, these two components are fixedly connected to each other. For example, a multi-layer construction, such as two layers of a material, each having fabric on the outside and plastic (airtight) on the inside may be inside (airtight), may be fused together to define the pressure applicator's 22210 pressure elements between the insides of each layer. In other embodiments, the pressure elements may be formed as discrete bladders, e.g., formed of elastomeric material, and the bladders may be disposed within pockets or sleeves formed of fabric material.

In some embodiments, the pressure applicator 22210 may include the pressure applicator 20210b previously described with respect to FIG. 25B, i.e., include two pressure elements 20212b having the two pressure ports 22214 (FIG. 27G). FIGS. 27D and 27G show the outer shell 22100 in the closed configuration and the pressure conduit 22250. The exterior pocket 22128 is shown in an open configuration in FIG. 27G to show how the pressure conduit 22250 is coupled to the pressure ports 22214 that are fluidically coupled to pressure elements of the pressure application 22210. In this implementation, the pressure connector 22260 is substantially similar to the pressure connector 5260, i.e., includes 6 male connectors configured to be coupled to pressure coupling 22650 that includes 6 pressure outlets. Six pressure tubes 22250a1, 22250a2, 22250b1, 22250b2, 22250b3, and 22250b4 are coupled to the pressure connector 22260, each configured to receive the pressure fluid (e.g., air) connector. However, the pressure applicator 22210 (FIG. 27C) has only has the two ports 22214. To interface the larger number of conduits 22250 to the smaller number of ports 22214, in this implementation, pressure conduits 22250a1 and 22250a1 are coupled via a Y connector 22250a3 to a single pressure conduit 22250a, which is coupled to one of the pressure ports 22214. The pressure conduits 22250b1 and 22250b2 are coupled to Y connector 22250b5, and pressure conduits 22250b3 and 22250b4 are coupled to Y connector 22250b6, and Y connectors 22250b5 and 22250b6 are coupled via another Y connector 22250b7 to a single pressure conduit 22250b that is coupled to the other pressure port 22214.

While not shown, treatment delivery component 22020 also includes a thermal applicator (e.g., the thermal applicator 20310b). In some embodiments, fasteners (e.g., hook and loop fasteners) may be used to releasably couple the thermal applicator to the pressure applicator 22210. As shown in FIGS. 27E and 27G, thermal conduit 22350 through which thermal fluid can be introduced into, and withdrawn from, the interior of thermal applicator, and which in this embodiment includes two fluid passages—one to introduce the thermal fluid and one to withdraw the thermal fluid. Thermal conduit 22350 terminates at thermal connector 22360.

As shown in FIGS. 27B and 27C, treatment delivery component 22020 a liner 22500 is coupled to the body portion 22210 coupled via fasteners 22220 that, in this implementation, include hook and loop fasteners. The liner 22500 may be define a liner pocket between and inner surface of the liner 22500 and the pressure applicator 22210 in which the thermal applicator can be disposed and retained, as described with respect to other embodiments. In some embodiments, the treatment delivery component 22020 may include other mechanisms (e.g., bolsters) to increase size adaptability via wasting, as previously described.

FIG. 27H is an illustration of a treatment delivery component 23020 configured for use with an upper leg (thigh, including quadriceps and/or hamstring muscles) of a user, according to an embodiment. The treatment delivery component 23020 is shown in a closed configuration in FIG. 27H, and includes an outer shell 23100 including a body portion 23110 to which a pressure applicator (e.g., the pressure applicator 20210a) and/or a thermal applicator (e.g., the thermal applicator 20310a) are coupled, for example, releasably coupled. Outer shell 23100 includes a fastener portion 23120 disposed on a first side of the outer shell 23100, which in this embodiment, is implemented as a zipper, with cooperating portions on each edge of body portion 23110, extending from proximate to a hip end of the body portion 23110 to knee end of the body portion 23110. The fastener portion 23120 is configured to be engaged (or closed) in use to wrap body portion 23110 around the upper leg of the user.

A thermal conduit 22350 is configured to communicate thermal fluid therethrough to, or from the thermal applicator and disposed through a passage 23130 defined in the outer shell 23100 for fluidically coupling with the thermal applicator. The pressure applicator includes three pressure ports 23214 which are disposed with an exterior pocket 23128 coupled to the outer shell 23100, which is shown in an open configuration in FIG. 27H. Exterior pocket fastener 23129, which in this embodiment, is implemented as a zipper with opposing portions on opposing edges of the exterior pocket, is configured to be engaged or disengaged to close or open the exterior pocket 23128 such that the exterior pocket 23128 defines an inner volume in which the ports 23214 and portions of pressure conduits 23250 can be disposed.

The pressure conduit 23250 is coupled to a pressure connector 23260 that, in this implementation, is substantially similar to the pressure connector 5260 and 22260, as previously described. Six pressure tubes 23250a1, 23250a2, 23250b1, 22250b2, 22250c1, and 22250c2 are coupled to the pressure connector 23260, each configured to receive the pressure fluid (e.g., air) connector. However, the pressure applicator 22210 only has the three ports 23214. To interface the larger number of conduits 23250 to the smaller number of ports 23214, pressure conduits 23250a1 and 23250a2 are coupled via a Y connector 23250a3 to a single pressure conduit 23250a, which is coupled to one of the pressure ports 23214. Similarly, pressure conduits 23250b1 and 23250b2 are coupled via a Y connector 23250b3 to a single pressure conduit 23250b, which is coupled to a second one of the pressure ports 23214, and pressure conduits 23250c1 and 23250c2 are coupled via a Y connector 23250c3 to a single pressure conduit 23250c, which is coupled to a third one of the pressure ports 23214. Thus the pressure connector 23260 can interface with the controller 5040 whose pressure coupling 5650 has six pressure outlets to provide pressure to the pressure applicator of the treatment delivery component 23020 which has only three ports 23214. In this manner, the same controller 5040 or any other controller describes herein can be interface with the treatment delivery component 23020, 22020 5020, or any other treatment delivery component described herein.

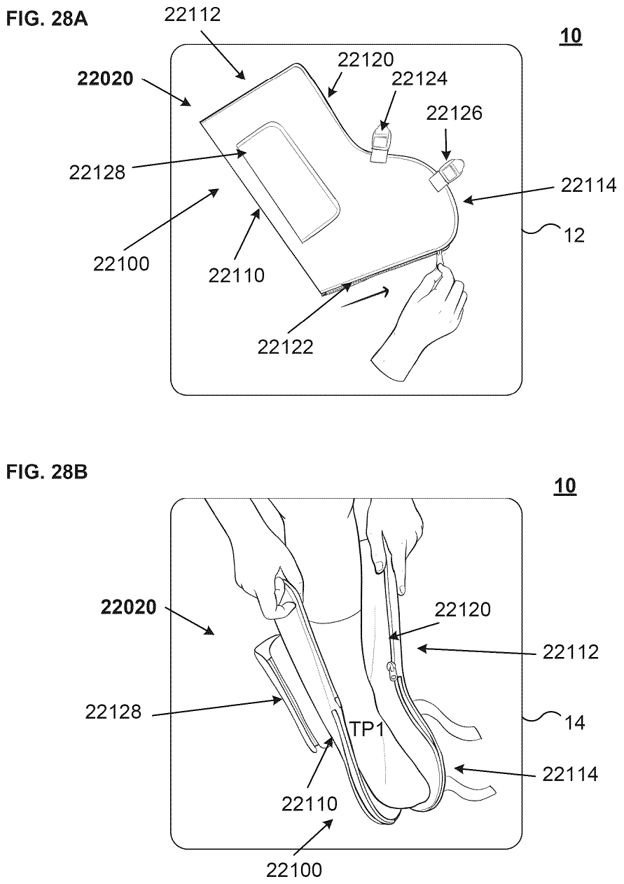

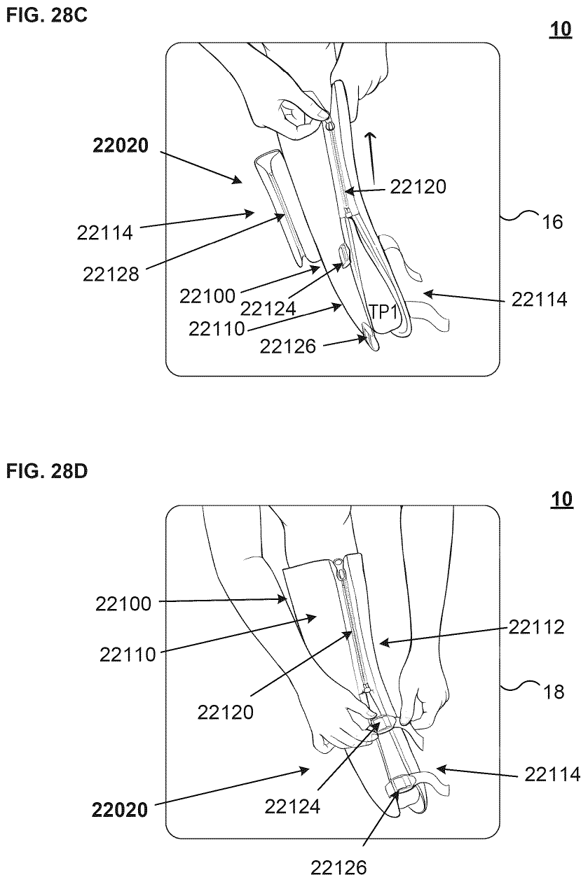

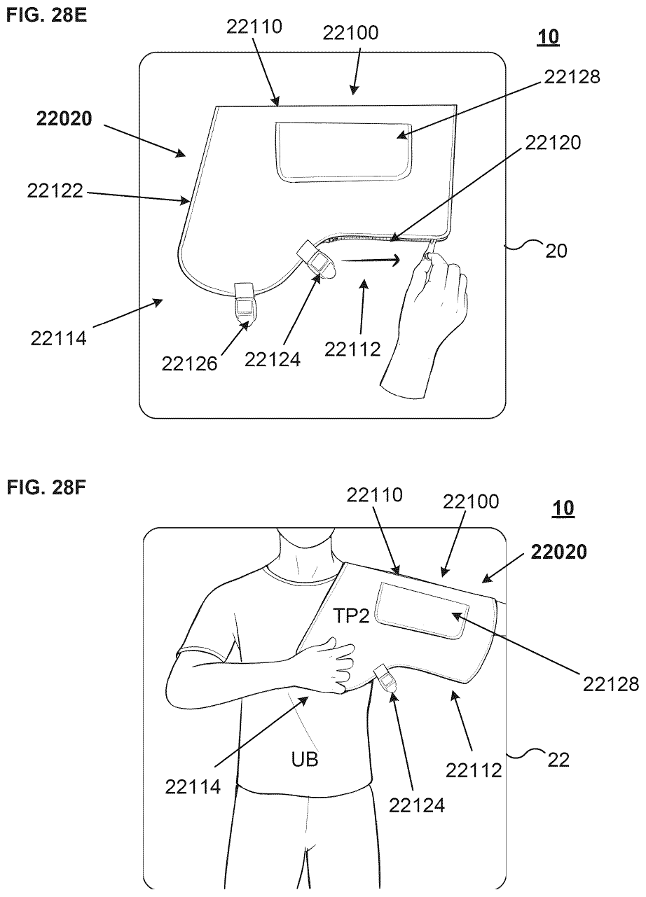

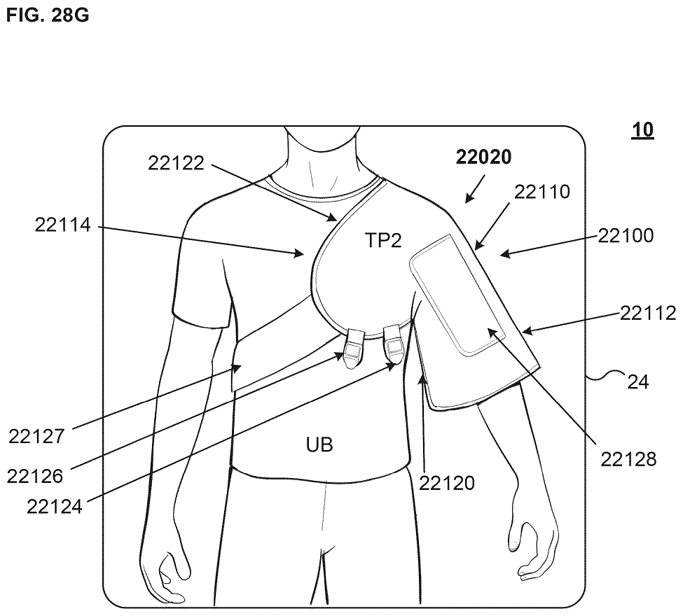

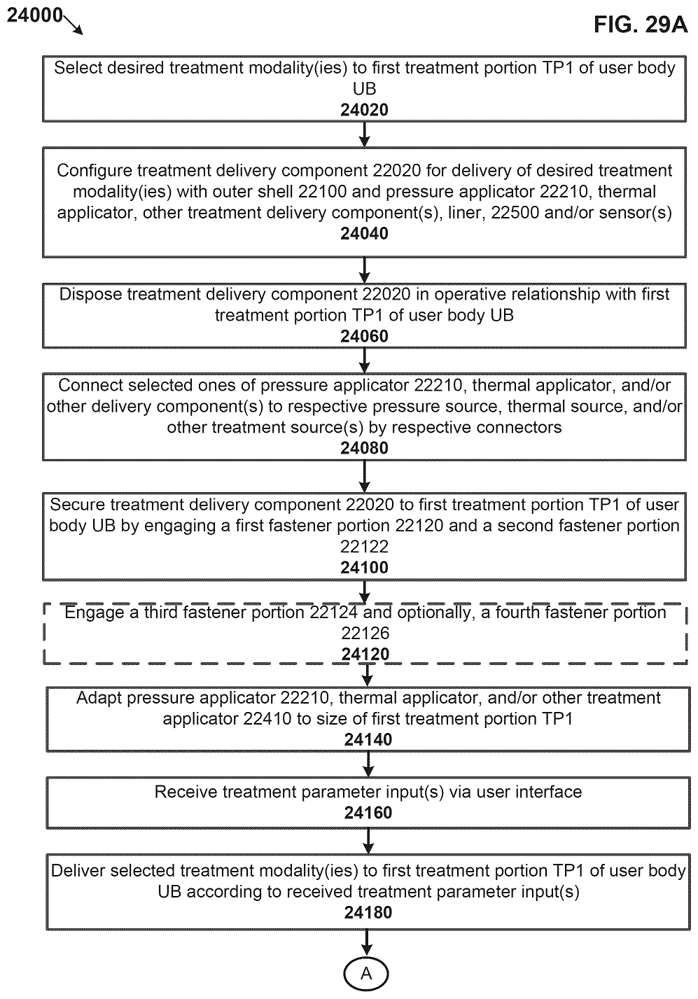

FIGS. 28A to 28G are illustrations of various operations of a process 10 for reconfiguring the treatment delivery component 22020 of FIGS. 27A to 27G for use with either a first treatment portion TP1 that includes lower leg and foot of a user body UB, or a second treatment portion TP2 that may include an upper arm and shoulder of the user body UB. While the method 10 shows particular operations performed in a particular order, the order is for illustrative purposes only and the operations of the method 10 can be performed in any suitable sequence or order to reconfigure the 22020 for use on the first or second treatment portion TP1 or TP2.

The process 10 may start at operation 12 corresponding to FIG. 28A in which the second fastener portion 22122, which includes a zipper, is engaged to close the first side of the second portion 22114. The second, third, and fast fastener portions 22122, 22124, and 22126 may be disengaged at operation 12.

At operation 14 corresponding to FIG. 28B, a user inserts the first treatment portion TP1 of the user body UB by inserting the user's foot into the second portion 22114, for example, by pulling on opposing edges of the first portion 22112, until the user's lower leg is disposed in the first portion 22112, for example, at least partially wrapped by the first portion 22112. At operation 16 corresponding to FIG. 28C, the user engages the first fastener portion 22120, which includes a zipper, to close the first fastener portion 22120 thus, wrapping the first portion 22112 around the user's calf and shin.

At operation 18 corresponding to FIG. 28D, the user engages the third and fourth fastener portions 22124 and 222126 to join, or at least bring close together, opposing edges of the second side of the second portion 22114. The user may tighten belts of the first and second fastener portions 22124 and 22126 as previously described herein, so as to retain or secure the treatment delivery component on the lower leg and foot of the user body UB, and increase compliance during treatment delivery. After the desired treatment delivery is complete, the user may remove the treatment delivery component 22020 from the user's foot by disengaging or uncoupling at least the first, third, and fourth fastener portions 22120, 22124, and 22126, and in some implementations, may also disengage the second fastener portion 22122.

To reconfigure the treatment delivery component 22020 for mounting on the upper arm and shoulder of the user body UB, the user may engage the first fastener portion 22120 at operation 20 corresponding to FIG. 28E, for example, by closing the zipper. At operation 22 corresponding to FIG. 28F, the user disposes the treatment delivery component 22020 on the second treatment portion TP2 of the user body UB by inserting the user's upper arm through the second portion 22114 and through the tubular segment formed by the first treatment portion 22112 until the first portion 22112 is disposed around the user's upper arm and the second portion 22114 is disposed on the user's deltoid and on portions of the user's pectoral muscle and trapezius. While the implementation shown in FIG. 28F shows the second treatment portion TP2 as including the user's left arm and left deltoid, this is for illustrative purposes only and can instead be the user's right arm and right deltoid. The third fastener portion 22124 may also be engaged at operation 22, and may facilitate retainment of the first portion 22112 on the user's upper arm. At operation 24 corresponding to FIG. 28G, the user may secure the body engagement element 22127 around a portion of a torso of the user's body to secure the second portion 22114 on the user's deltoid and facilitate securement of the treatment delivery component 22020 on the second treatment portion TP2.

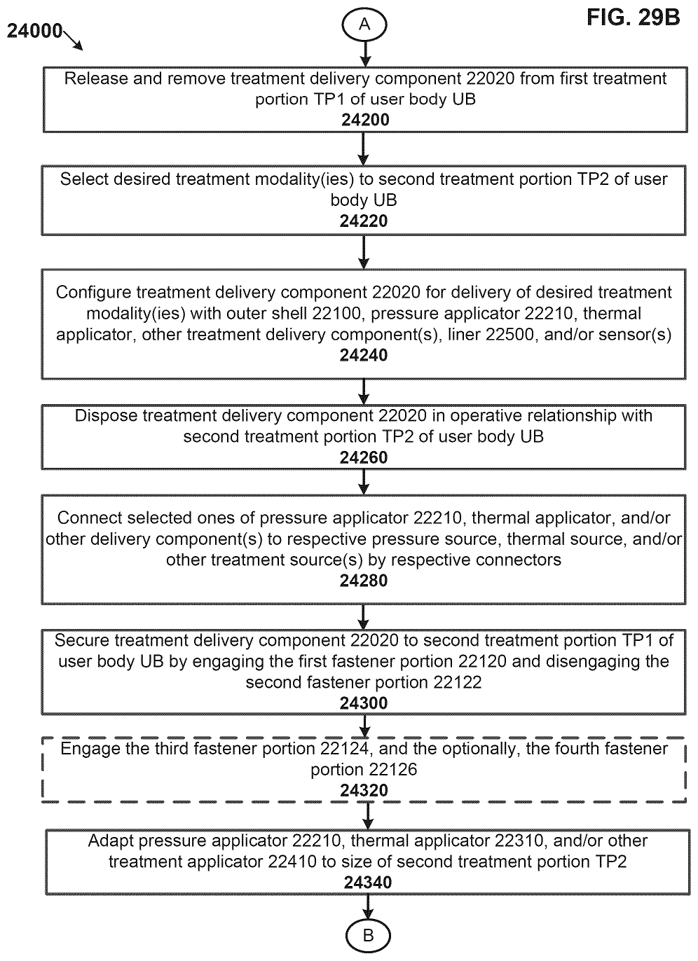

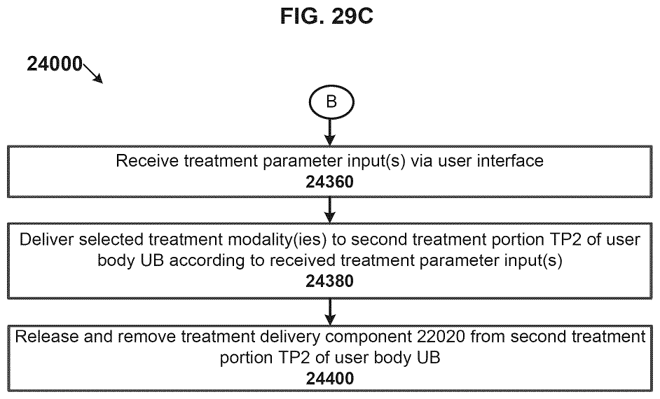

FIGS. 29A to 29C are flow charts of a method 24000 of treatment of a lower leg and foot, or an upper arm and shoulder of a user with the treatment delivery component 22020 of FIGS. 27A to 27G, accordingly to an embodiment. While operations of the method 24000 are described with respect to the treatment delivery component 22020, the method 22020 may be performed with any treatment delivery component described herein capable of performing the operations of the method 24000 described herein.

At 24020, a desired treatment modality or modalities to treat a first treatment portion TP1 of the user's body is selected. The desired treatment modality may include a first treatment modality(ies). At 24040, the treatment delivery component 22020 may be configured for delivery of desired treatment modality(ies) with outer shell 22100, pressure applicator 22210, thermal applicator, liner 22500, and may also include other treatment delivery components and/or sensors, as previously described.

At 24060, the treatment delivery component 22020 is disposed in operative relationship with first treatment portion TP1 of user body UB, which includes a lower leg and foot of the user body UB as described with respect to process 10. At 24080, selected ones of the pressure applicator 22210, thermal applicator, and/or other delivery component(s) are connected or coupled to respective pressure source, thermal source, and/or other treatment sources by respective connectors (e.g., provided in the controller 5040), as previously described. At 24100, the treatment delivery component 22020 is secured to the first treatment portion TP1 of the user body UB, which includes the lower leg and foot of the user body UB, by engaging the first fastener portion 22120 and the second fastener portion 22122, as previously described. In some embodiments, the third fastener portion 22124 and the fourth fastener portion 22126 may also be engaged to secure the treatment delivery component 22020 to the first treatment portion TP1 at 24120, as previously described.

At 24140, the pressure applicator 22210, thermal applicator, and/or other treatment applicators 22410 of the treatment delivery component 22020 are adapted to the size of the first treatment portion TP1. At 24160, the treatment delivery component 22020 may receive treatment parameter(s) via a user interface, for example, the user interface 5950 of the control unit 5040. At 24180, the treatment delivery component 22020 may deliver the selected treatment modality(ies) (e.g., the first treatment modality) to first treatment portion TP1 of user body UB according to received treatment parameter input(s). At operation 24200, the treatment delivery component 22020 is released and removed from first treatment portion TP1 of user body UB.

At 24220, a desired treatment modality or modalities to treat a second treatment portion TP2 of the user body UB is selected. The selected treatment modality(ies) may be the same or different from the treatment modality(ies) selected at operation 24020, for example, include a second treatment modality. At 24240, the treatment delivery component 22020 may be configured for delivery of desired treatment modality(ies) with outer shell 22100, pressure applicator 22210, thermal applicator, liner 22500, and may also include other treatment delivery components and/or sensors, as previously described.

At 24260, the treatment delivery component is disposed in operative relationship with second treatment portion TP2 of user body UB, which includes an upper arm and deltoid or shoulder of user body UB as described with respect to process 10. At 24280, selected ones of the pressure applicator 22210, thermal applicator, and/or other delivery component(s) are connected or coupled to respective pressure source, thermal source, and/or other treatment sources by respective connectors (e.g., provided in the controller 5040), as previously described. At 24300, the treatment delivery component 22020 is secured to the second treatment portion TP2 of the user body UB, which includes upper arm and deltoid or shoulder of the user body UB, by engaging the first fastener portion 22120 and the disengaging the second fastener portion 22122, as previously described. In some embodiments, the third fastener portion 22124 is engaged and, optionally, the fourth fastener portion 22126 may also be engaged to secure the treatment delivery component 22020 to the second treatment portion TP2 at operation 24320, as previously described. For example, the body engagement element 22127 that may be coupled to the fourth fastener portion 22126, may be adjusted to have a usable length that is sufficient for the body engagement element 22127 to disposed around a portion of the user's torso, thereby securing the treatment delivery component 22020 on the second treatment portion TP2. In some implementations in which the body engagement element 22127 is coupled directly to the outer shell 22100 and not included with the fourth fastener portion 22126, the fourth fastener portion 22126 may be disengaged at operation 24320.

At 24340, the pressure applicator 22210, thermal applicator, and/or other treatment applicators 22410 of the treatment delivery component 22020 are adapted to size of the second treatment portion TP2. At 24360, the treatment delivery component 22020 may receive treatment parameter(s) via user interface, for example, user interface 5950 of control unit 5040. At 24380, the treatment delivery component 22020 may deliver selected treatment modality(ies) to second treatment portion TP2 of user body UB according to received treatment parameter input(s). At operation 24400, the treatment delivery component 22020 is released and removed from second treatment portion TP2 of user body UB.

While various embodiments have been described herein, textually and/or graphically, it should be understood that they have been presented by way of example only, and not limitation. Likewise, it should be understood that the specific terminology used herein is for the purpose of describing particular embodiments and/or features or components thereof and is not intended to be limiting. Various modifications, changes, enhancements, and/or variations in form and/or detail may be made without departing from the scope of the disclosure and/or without altering the function and/or advantages thereof unless expressly stated otherwise. Functionally equivalent embodiments, implementations, and/or methods, in addition to those enumerated herein, will be apparent to those skilled in the art from the foregoing descriptions and are intended to fall within the scope of the disclosure.

For example, while numerous embodiments of treatment systems are described herein as being used with particular devices and/or in particular situations, it should be understood that they have been presented by way of example only and not limitation. The embodiments and/or devices described herein are not intended to be limited to any specific implementation unless expressly stated otherwise. For example, in some implementations, treatment systems 1000, 3000, 4000, 5000, 6000, 7000, 8000, 9000, 10000, 11000, 12000, 13000, 14000, 15000, 16000, 17000, 18000, and 19000, may be used with or without a programmable controller, or used to provide any other treatment not described herein.

Where schematics, embodiments, and/or implementations described above indicate certain components arranged and/or configured in certain orientations or positions, the arrangement of components may be modified, adjusted, optimized, etc. The specific size and/or specific shape of the various components can be different from the embodiments shown and/or can be otherwise modified, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Although various embodiments have been described as having particular characteristics, functions, components, elements, and/or features, other embodiments are possible having any combination and/or sub-combination of the characteristics, functions, components, elements, and/or features from any of the embodiments described herein, except mutually exclusive combinations or when clearly stated otherwise.

Where methods described above indicate certain events occurring in certain order, the ordering of certain events may be modified. Additionally, certain of the events may be performed concurrently in a parallel process when possible, as well as performed sequentially as described above. While methods have been described as having particular steps and/or combinations of steps, other methods are possible having a combination of any steps from any of methods described herein, except mutually exclusive combinations and/or unless the context clearly states otherwise.

What is claimed:

1. An apparatus, comprising:
a treatment delivery component configured to be releasably secured around a treatment portion of a user's body, the treatment delivery component including:
a pressure delivery component coupled to the outer shell and including a pressure applicator having a plurality of pressure elements, each pressure element being in fluid communication with a respective fluid passage in a pressure conduit releasably coupleable to a source of pressurized fluid and changeable, in response to receiving the pressurized fluid, from a collapsed configuration to an expanded configuration having a greater volume than the collapsed configuration; and
a thermal delivery component having a thermal applicator removably disposed proximate to the pressure applicator, the thermal applicator being in fluid communication with a thermal conduit releasably coupleable to a thermal source and configured to conduct therethrough a liquid from the thermal source and to exchange thermal energy between the treatment portion and the liquid;
the treatment delivery component including a first portion and a second portion extending from the second portion, the treatment delivery component being reconfigurable between: (a) a first configuration in which the treatment portion is a first treatment portion that includes a lower leg of the user's body, the first portion can be disposed on a calf and shin of the user's body, and the second portion can be disposed on a foot of the user's body; and (b) a second configuration in which the treatment portion is a second treatment portion that includes an upper arm and deltoid of the user's body, the first portion can be disposed on an upper arm of the user's body, and the second portion can be disposed on a deltoid of the user's body.

2. The apparatus of claim 1, wherein:
the first portion can form a first tubular segment and the second portion can form a second tubular segment extending at a non-zero angle from the first tubular segment,
the first tubular segment can be closed edge to edge in the first configuration around the calf and shin of the user's body and can be closed edge to edge in the second configuration around the upper arm of the user's body, and
the second tubular segment can be closed edge to edge in the first configuration around the foot of the user's body, and can be open on at least one edge in the second configuration to be disposed on at least the deltoid of the user's body.

3. The apparatus of claim 1, wherein the second portion can also be disposed on at least a portion of a pectoral muscle and a trapezius muscle of the user's body.

4. The apparatus of claim 1, wherein the treatment delivery component further includes an outer shell, the first portion including a first portion of the outer shell and the second portion including a second portion of the outer shell.

5. The apparatus of claim 4, wherein the pressure applicator is coupled to the outer shell, and the thermal applicator is releasably coupleable to one or more of the outer shell and the pressure applicator.

6. The apparatus of claim 4, wherein:
the outer shell includes a first fastener portion disposed on a first side of the first portion, and a second fastener portion disposed on a side of the second portion,
in the first configuration each of the first fastener portion and the second fastener portion are engaged, and
in the second configuration, the first fastener portion is engaged and the second fastener portion is disengaged.

7. The apparatus of claim 6, wherein each of the first fastener portion and the second fastener portion include a zipper, the first fastener portion configured to be disposed in front of a shin of the user in the first configuration and between the upper arm and torso of the user in the second configuration, and the second fastener portion configured to be disposed in front of a sole of the foot of the user in the first configuration.

8. The apparatus of claim 6, wherein:
in the first configuration, the first fastener portion can close edges of the first side of the first portion to cause the first portion to be wrapped around the calf and shin of the user's body, and the second fastener portion closes edges of the first side of the second portion to facilitate wrapping of the second portion around the foot of the user's body, and
in the second configuration, the first fastener portion can close edges of the first side of the first portion to wrap the first portion around the upper arm of the user's body.

9. The apparatus of claim 8, wherein the outer shell further includes a third fastener portion disposed on a second side of the second portion opposite the first side, the third fastener portion is engaged in the first configuration to be able to at least partially close edges of the second side of the second portion to facilitate wrapping of the second portion around the foot of the user's body, and is engaged in the second configuration to be able to at least partially close edges of the second side of the second portion to facilitate wrapping of the first portion around the upper arm of the user's body.

10. The apparatus of claim 9, further including a fourth fastener portion disposed on the second side of the second portion, the fourth fastener is engaged in the first configuration to be able to at least partially close corresponding edges of the second side of the second portion to facilitate wrapping of the second portion around the foot of the user's body, and in the second configuration, the fourth fastener portion is either disengaged or engaged such that corresponding edges of second side of the second portion are open to enable the second portion to be disposed on the deltoid of the user's body.

11. The apparatus of claim 10, further comprising a body engagement element, the body engagement element configured to be disposed around at least a portion of a torso of a user to secure the second portion to the deltoid of the user's body.

12. The apparatus of claim 11, wherein the body engagement element is coupled to the fourth fastener portion in the second configuration.

13. An apparatus, comprising:
a treatment delivery component configured to be releasably secured around a treatment portion of a user's body, the treatment delivery component including:
a first portion forming a first tubular segment, a first fastener portion being coupled to a first side of the first portion and configured to close the first side of the first portion edge to edge; and
a second portion forming a second tubular segment extending at a non-zero angle from the first tubular segment, the second portion including a second fastener portion disposed on a first side of the second portion and configured to couple the first side of the second tubular segment edge to edge, and a third fastener portion disposed on a second side of the second portion opposite the first side of the second portion, the third fastener portion configured to at least partially close the second side of the second portion edge to edge; and
the treatment delivery component being reconfigurable between: (a) a first configuration in which the treatment portion is a first treatment portion that includes a lower leg of the user's body, the first portion can be disposed on a calf and shin of the user's body, and the second portion can be disposed on a foot of the user's body; and (b) a second configuration in which the treatment portion is a second treatment portion that includes an upper arm and deltoid of the user's body, the first portion can be disposed on an upper arm of the user's body, and the second portion can be disposed on a deltoid of the user's body.

14. The apparatus of claim 13, wherein:
the first portion can be closed edge to edge in the first configuration around the calf and shin of the user's body by engaging the first fastener portion, and closed edge to edge in the second configuration around the upper arm of the user's body by engaging the first fastener portion, and
the second portion can be closed edge to edge in the first configuration around the foot of the user's body by engaging each of the second and third fastener portions, and is open on at least one edge in the second configuration to be disposed on at least the deltoid of the user's body by disengaging at least the second fastener portion.

15. The apparatus of claim 14, wherein the second portion can also be disposed on at least a portion of a pectoral muscle and a trapezius muscle of the user's body.

16. The apparatus of claim 13, wherein the treatment delivery component further includes:
an outer shell;
a pressure delivery component coupled to the outer shell and including a pressure applicator having a plurality of pressure elements, each pressure element being in fluidic communication with a respective fluid passage in a pressure conduit releasably coupleable to a source of pressurized fluid and changeable, in response to receiving the pressurized fluid, from a collapsed configuration to an expanded configuration having a greater volume than the collapsed configuration; and
a thermal delivery component having a thermal applicator removably disposed proximate to the pressure applicator, the thermal applicator being in fluidic communication with a thermal conduit releasably coupleable to a thermal source and configured to conduct therethrough a liquid from the thermal source and to exchange thermal energy between the treatment portion and the liquid.

17. The apparatus of claim 16, wherein the first portion includes a first portion of the outer shell, and the second portion includes a second portion of the outer shell.

18. The apparatus of claim 16, wherein the pressure applicator is coupled to the outer shell, and the thermal applicator is releasably coupled to one or more of the outer shell and the pressure applicator.

19. The apparatus of claim 16, wherein the thermal applicator has a central portion having a first width and a first side portion and a second side portion that, together with the central portion, have a second width, the thermal applicator being releasably couplable to the outer shell near the opposed edges by the first side portion and the second side portion,
the pressure applicator operable to apply pressure to the thermal applicator to enhance apposition of the central portion of the thermal applicator to the first or second treatment portions and, for the first or second treatment portions having a circumference or lateral extent less than the second width of the thermal applicator, to urge at least a portion of the inner surfaces of each of the first side portion and the second side portion towards and into contact with each other.

20. The apparatus of claim 13, wherein each of the first fastener portion and the second fastener portion includes a zipper, the first fastener portion configured to be disposed in front of a shin of the user in the first configuration and between the upper arm and torso of the user in the second configuration, and the second fastener portion configured to be disposed in front of a sole of the foot of the user in the first configuration.

21. The apparatus of claim 13, further including a fourth fastener portion disposed on the second side of the second portion, the fourth fastener is engaged in the first configuration to be able to at least partially close corresponding edges of the second side of the second portion to facilitate wrapping of the second portion around the foot of the user's body, and in the second configuration, the fourth fastener portion is either disengaged or engaged such that corresponding edges of second side of the second portion are open to enable the second portion to be disposed on the deltoid of the user's body.

22. The apparatus of claim 21, further comprising a body engagement element, the body engagement element configured to be disposed around at least a portion of a torso of a user to secure the second portion to the deltoid of the user's body.

23. The apparatus of claim 22, wherein the body engagement element is coupled to the fourth fastener portion in the second configuration.

24. A method, comprising:
configuring a treatment delivery component for delivery of a first pressure treatment modality by a pressure delivery component having a pressure applicator and a first thermal treatment modality by a thermal delivery component having a thermal applicator to a first treatment portion of a user's body that includes a lower leg of the user's body, the treatment delivery component including an outer shell coupled to the pressure applicator;
disposing the treatment delivery component in operative relationship with the first treatment portion with the thermal applicator adjacent to a surface of the first treatment portion;
coupling the treatment delivery component to a control unit, the control unit having a pressure source and a thermal source, the coupling including coupling to the pressure source a pressure conduit coupled to the pressure applicator and coupling to the thermal source a thermal conduit coupled to the thermal applicator;
delivering the first pressure treatment modality to the first treatment portion by the pressure delivery component;
delivering the first thermal treatment modality to the first treatment portion by the thermal delivery component;
removing the treatment delivery component from the first treatment portion;
configuring the treatment delivery component for delivery of a second pressure treatment modality by the pressure delivery component and a second thermal treatment modality by the thermal delivery component to a second treatment portion of the user's body that includes an upper arm and deltoid of the user's body, the configuring including releasably coupling the thermal applicator to one or more of the outer shell and the pressure applicator;
disposing the treatment delivery component in operative relationship with the second treatment portion with the thermal applicator adjacent to a surface of the second treatment portion;
coupling the treatment delivery component to the control unit;
delivering the second pressure treatment modality to the second treatment portion by the pressure delivery component;
delivering the second thermal treatment modality to the second treatment portion by the thermal delivery component; and
removing the treatment delivery component from the second treatment portion.

25. The method of claim 24, wherein configuring the treatment delivery component for delivery of the desired pressure treatment modality and the desired thermal treatment modality via the first treatment portion or the second treatment portion includes releasably coupling the thermal applicator to one or more of the outer shell and the pressure applicator.

26. The method of claim 24, wherein:
the treatment delivery component includes a first portion and a second portion extending at a non-zero angle from the first portion,
configuring the treatment delivery component for delivery of the first pressure treatment modality to the first treatment portion includes disposing the first portion on a calf and shin of the user's body, and disposing the second portion on a foot of the user's body, and
configuring the treatment delivery component for delivery of the second pressure treatment modality to the second treatment portion includes disposing the first portion on an upper arm of the user's body, and disposing the second portion on a deltoid of the user's body.

27. The method of claim 24, wherein:
the treatment delivery component includes a first portion forming a first tubular segment, and the second portion forming a second tubular segment extending at a non-zero angle from the first tubular component,
configuring the treatment delivery component for delivery of the first pressure treatment modality to the first treatment portion can include closing the first tubular segment edge to edge around the calf and shin of the user's body and closing the second tubular segment edge to edge around the foot of the user's body, and
configuring the treatment delivery component for delivery of the second pressure treatment modality to the second treatment portion can include closing the first tubular segment edge to edge around the upper arm of the user's body, and the second tubular segment can be open on at least one edge to be disposed on at least the deltoid of the user's body.

28. The method of claim 27, wherein configuring the treatment delivery component for delivery of the second pressure treatment modality to the second treatment portion can include disposing the second tubular segment on a portion of a pectoral muscle and a trapezius muscle of the user's body.

29. The method of claim 24, wherein:
the outer shell forms a first portion and the second portion extending at a non-zero angle from the first portion, a first fastener portion disposed on a first side of the first portion, and a second fastener portion disposed on a side of the second portion;
configuring the treatment delivery component for delivery of the first pressure treatment modality to the first treatment portion can include engaging each of the first portion and the second portion, and
configuring the treatment delivery component for delivery of the second pressure treatment modality to the second treatment portion can include engaging the first fastener portion and disengaging the second fastener portion.

30. The method of claim 29, wherein:
the outer shell further includes a third fastener portion disposed on a second side of the second portion opposite the first side,
configuring the treatment delivery component for delivery of the first pressure treatment modality to the first treatment portion can further includes engaging the third fastener portion to at least partially close corresponding edges of the second side of the second portion to facilitate wrapping of the second portion around the foot of the user's body, and
configuring the treatment delivery component for delivery of the second pressure treatment modality to the second treatment portion can further include engaging the third fastener to at least partially close edges of the second side of the second portion to facilitate wrapping of the first portion around the upper arm of the user's body.
